(19) United States
(12) Patent Application Publication
(10) Pub. No.: US 2026/0252852 A1
(43) Pub. Date: Aug. 27, 2026

(54) Neuronal Classification from Electrophysiological Recordings Based on Multimodal Deep Learning

(71) Applicant: The Regents of the University of California, Oakland, CA (US)

(72) Inventors: Jesus Gonzalez-Ferrer, Santa Cruz, CA (US); Julian Lehrer, Santa Cruz, CA (US); Mohammed A. Mostajo-Radji, Santa Cruz, CA (US)

(73) Assignee: The Regents of The University of California, Oakland, CA (US)

(21) Appl. No.: 19/548,232

(22) Filed: Feb. 24, 2026

Related U.S. Application Data
(60) Provisional application No. 63/762,271, filed on Feb. 24, 2025.

(51) Int. Cl. G06N 3/0455; G06F 18/213; G06F 18/2413; G06F 18/25; G06N 3/0895; G06N 3/09

(52) U.S. Cl. CPC G06N 3/0455; G06F 18/213; G06F 18/24147; G06F 18/253; G06N 3/0895; G06N 3/09; G06F 2218/08

(57) ABSTRACT

The present disclosure relates to systems and methods for analyzing extracellular electrophysiological recordings are disclosed. Extracellular electrophysiological recordings captured by at least one recording device are received, and for each of a plurality of neurons, a waveform feature representing a shape of an extracellular action potential and an interspike-interval feature representing a temporal distribution of intervals between successive action potentials are extracted. One or more conditional variational autoencoders, conditioned on a recording source descriptor associated with the recording device, generate a waveform latent code and a timing latent code from the respective features. The waveform latent code and the timing latent code are fused to produce a multimodal latent embedding for each neuron. One or more analysis operations are performed on the multimodal latent embeddings to generate an analysis result characterizing the plurality of neurons, including batch harmonization to reduce source-dependent variation and classification of neurons into neuronal categories.

### PRIORITY DATA

This application claims the benefit of U.S. Patent Application No. 63/762,271, entitled “Neuronal Classification from Electrophysiological Recordings Based on Multimodal Deep Learning,” filed on Feb. 24, 2025 (Attorney Docket No. UCSC1003USP01). The provisional patent application is incorporated by reference for all purposes.

### FIELD OF THE TECHNOLOGY DISCLOSED

The present disclosure relates generally to computational analysis of extracellular electrophysiological recordings.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

A detailed understanding of neuronal cell types, their spatial organization within the brain, and their patterns of connectivity is fundamental to the study of neural circuits and their role in generating behavior. Advances in experimental neuroscience have enabled increasingly precise measurements of cellular properties, allowing researchers to examine neuronal diversity at multiple levels. In particular, high-throughput molecular profiling techniques have made it possible to collect large-scale gene expression data from individual cells, providing insight into cellular identity and heterogeneity at the transcriptional level. While such molecular data have contributed substantially to cell-type classification efforts, they do not fully describe functional characteristics of neurons, such as electrophysiological behavior and morphological properties, which are important for understanding neuronal function in physiological contexts.

Electrophysiological measurements provide direct information about neuronal activity and functional state. Historically, detailed electrophysiological characterization has relied on intracellular recording techniques, such as whole-cell patch clamp, which offer high signal fidelity but are limited in throughput and scalability. More recently, a variety of high-throughput extracellular recording technologies have been developed, including planar high-density microelectrode arrays, flexible three-dimensional electrode systems, and high-density neural probes. These technologies enable simultaneous recording from large populations of neurons across multiple brain regions or experimental preparations and support investigation of population-level and network-level dynamics.

Extracellular electrophysiological recordings capture characteristic electrical signals associated with neuronal action potentials. These signals can be described using features related to spike waveform shape as well as features derived from the temporal structure of spike trains. Waveform characteristics may reflect biophysical properties of neurons and their local recording environment, while spike timing patterns provide information about firing dynamics and interactions within neural networks. As extracellular recording technologies have scaled, computational methods have been increasingly employed to analyze such data and to derive representations useful for neuronal characterization.

Computational analysis of extracellular electrophysiological data has been approached using a variety of paradigms, including supervised and unsupervised techniques. Supervised approaches typically rely on labeled datasets to associate electrophysiological patterns with predefined neuronal categories, while unsupervised approaches seek to identify structure in unlabeled data through clustering or dimensionality reduction. In parallel, representation learning methods have been applied to electrophysiological signals to extract compact descriptions of neuronal activity. These methods may operate on waveform features, spike timing features, or combinations thereof.

In addition, recent developments in machine learning have introduced self-supervised and conditional modeling techniques that can incorporate auxiliary information into representation learning. Such techniques have been explored in multiple biological domains to account for experimental context, reduce unwanted sources of variation, and improve the interpretability of learned representations. In electrophysiology, contextual variables such as recording technology, experimental preparation, or biological source may influence measured signals and are often available as metadata associated with recordings.

As extracellular electrophysiological datasets continue to grow in size and diversity, the ability to analyze neuronal activity across different experimental conditions, recording platforms, and biological systems remains an important consideration. Ongoing research efforts continue to explore methods for integrating multiple signal modalities, incorporating contextual information, and producing representations that support meaningful comparison and characterization of neuronal activity across heterogeneous datasets and experimental settings.

### SUMMARY

In an exemplary embodiment, a system for classifying neurons from extracellular electrophysiological recordings is described. The system comprises a data interface configured to receive a plurality of extracellular electrophysiological recordings captured by at least one recording device, each recording representing extracellular neuronal activity of a plurality of neurons. The system further comprises one or more processors coupled to a memory storing instructions that, when executed by the one or more processors, cause the one or more processors to extract, from at least one electrophysiological recording, for each of a plurality of neurons, (i) a waveform feature representing a shape of an extracellular action potential of the neuron, and (ii) an interspike-interval feature representing a temporal distribution of intervals between successive action potentials of each of the plurality of neurons. The one or more processors further generate, using one or more conditional variational autoencoders conditioned on an recording source descriptor associated with the at least one recording device, (i) a waveform latent code determined from the waveform feature vector and (ii) a timing latent code determined from the spike-timing distribution feature vector. The one or more processors further fuse the waveform latent code and the timing latent code to produce a multimodal latent embedding for the neuron unit. The one or more processors further perform one or more analysis operations on the multimodal latent representations to generate an analysis result characterizing the plurality of neurons.

In another embodiment, a computer-implemented method for classifying neurons from extracellular electrophysiological recordings is described. The method comprises (a) receiving a plurality of extracellular electrophysiological recordings captured by at least one recording device, each recording representing extracellular neuronal activity of a plurality of neurons. The method further comprises (b) extracting, from at least one of the extracellular electrophysiological recordings, for each of a plurality of neurons, (i) a waveform feature representing a shape of an extracellular action potential of the neuron, and (ii) an interspike-interval feature representing a temporal distribution of intervals between successive action potentials of the neuron. The method further comprises (c) generating, using one or more conditional variational autoencoders conditioned on a recording source descriptor associated with the at least one recording device, (i) a waveform latent code determined from the waveform feature and (ii) a timing latent code determined from the interspike-interval feature. The method further comprises (d) fusing the waveform latent code and the timing latent code to produce a multimodal latent embedding for each neuron. The method further comprises (e) performing one or more analysis operations on the multimodal latent embeddings to generate an analysis result characterizing the plurality of neurons.

The foregoing general description of the illustrative embodiments and the following detailed description thereof are merely exemplary aspects of the teachings of this disclosure and are not restrictive.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

FIG. 1 is a schematic representation of an overall environment for analyzing extracellular electrophysiological recordings obtained from biological preparations using one or more recording devices and computing resources.

FIG. 2A illustrates a data acquisition and feature extraction pipeline for extracellular electrophysiological recordings.

FIG. 2B illustrates a neuronal classification system implementing parallel conditional variational autoencoders for generating multimodal latent representations from extracellular electrophysiological features.

FIG. 2C illustrates a system for classifying neurons from extracellular electrophysiological recordings, including data acquisition, feature extraction, representation learning, harmonization, classification, and training components.

FIG. 3A illustrates average feature distributions per neuronal category and neuronal category proportions for the CellExplorer Cell Type Dataset and the Lisberger Dataset

FIG. 3B illustrates grid plots for hyperparameter tuning of the hyperparameter β and the latent space dimensionality Z for the CellExplorer Cell Type Dataset and the Lisberger Dataset.

FIG. 3C illustrates an ablation analysis comparing classification performance of different architecture choices for the system for classifying neurons from extracellular electrophysiological recordings.

FIG. 3D illustrates a comparison of K nearest neighbors classifier and multilayer perceptron classifier performance across latent space dimensionalities for the CellExplorer Cell Type Dataset and the Lisberger Dataset.

FIG. 4A illustrates a diagram comparing transductive and inductive evaluation paradigms for classifying neurons from extracellular electrophysiological recordings.

FIG. 4B illustrates the proportion of neurons per brain structure and per brain region in the Allen Brain Institute Visual Coding dataset.

FIG. 4C illustrates balanced accuracy and F1 scores per experiment comparing classification performance of different dimensionality reduction and classification methods under both transductive and inductive benchmark evaluations.

FIG. 4D illustrates confusion matrices comparing neuronal category classification performance of PhysMAP, a standalone variational autoencoder (VAE), and the system for classifying neurons using conditional variational autoencoders (HIPPIE) under both transductive and inductive benchmark evaluations.

FIG. 5A illustrates feature distributions per neuronal category, neuronal category proportions, classification benchmark comparisons, and confusion matrices for the Extracellular Mouse A1 Dataset.

FIG. 5B illustrates feature distributions per neuronal category, neuronal category proportions, classification benchmark comparisons, and confusion matrices for the Juxtacellular Mouse S1 Cell Type Dataset.

FIG. 6A illustrates accuracy and F1 score benchmark comparisons for the Hull Dataset.

FIG. 6B illustrates confusion matrices comparing neuronal category classification performance of PhysMAP, the standalone variational autoencoder (VAE), NEMO, and the system for classifying neurons using conditional variational autoencoders (HIPPIE) for the Hull Dataset.

FIG. 6C illustrates accuracy and F1 score benchmark comparisons for the Lisberger Dataset.

FIG. 6D illustrates confusion matrices comparing neuronal category classification performance of PhysMAP, the standalone variational autoencoder (VAE), NEMO, and the system for classifying neurons using conditional variational autoencoders (HIPPIE) for the Lisberger Dataset.

FIG. 7A illustrates accuracy, precision, recall, and F1 score benchmark comparisons for the cross species comparison benchmark.

FIG. 7B illustrates confusion matrices comparing neuronal category classification performance of PhysMAP, the standalone variational autoencoder (VAE), NEMO, and the system for classifying neurons using conditional variational autoencoders (HIPPIE) for the cross species comparison benchmark.

FIG. 7C illustrates t distributed stochastic neighbor embedding (t SNE) representations of the latent embeddings generated by PhysMAP, NEMO, and the system for classifying neurons using conditional variational autoencoders (HIPPIE) for the cross species comparison benchmark.

FIG. 7D illustrates the t SNE representation of the multimodal latent embedding generated by the system for classifying neurons using conditional variational autoencoders, distinguished by HDBSCAN clusters, with mean feature representations plotted alongside each cluster.

FIG. 8A illustrates a pipeline diagram depicting the sequential steps executed by the web application during runtime.

FIG. 8B illustrates screenshots of the web application graphical user interface implementing the pipeline described in the pipeline diagram of FIG. 8A.

FIG. 9 is illustrates a computing system for implementing one or more computational aspects of the present disclosure.

FIG. 10 is a schematic representation of an encoder-decoder architecture.

FIG. 11 shows an overview of an attention mechanism added onto a Recurrent Neural Network (RNN) encoder-decoder architecture.

FIG. 12 is a schematic representation of the calculation of self-attention showing one attention head.

FIG. 13 is a depiction of several attention heads in a Transformer block.

FIG. 14 is an illustration that shows how one can use multiple workers to compute the multi-head attention in parallel, as the respective heads compute their outputs independently of one another.

FIG. 15 is a portrayal of one encoder layer of a Transformer network.

FIG. 16 shows a schematic overview of a Transformer model.

FIG. 17 is a depiction of a Vision Transformer (ViT).

FIG. 18 illustrates a processing flow of the Vision Transformer (ViT).

FIG. 19 shows example software code that implements a Transformer block.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

### Indicia of Novelty, Inventiveness, Non-Obviousness, and Subject-Matter Eligibility

### Overview

The implementations described herein introduce systems and methods for classifying neurons from extracellular electrophysiological recordings obtained across heterogeneous recording platforms. In some implementations, a neuronal classification system receives spike-sorted extracellular electrophysiological recordings captured by one or more recording devices. Each recording represents extracellular neuronal activity of a plurality of neurons. The system extracts two complementary features for each neuron. A waveform feature represents the shape of an extracellular action potential. An interspike-interval (ISI) feature represents the temporal distribution of intervals between successive action potentials. Each feature is represented as a one-dimensional vector.

The system processes these features through paired conditional variational autoencoders (cVAEs) trained in parallel. A first cVAE module processes the waveform feature. A second cVAE module processes the ISI feature. Each cVAE module is conditioned on a recording-source descriptor associated with the recording device. The conditioning causes each encoder to produce a latent embedding in which recording-platform-dependent variation is reduced relative to biological neuronal variation. A mixture module combines the latent embeddings produced by the encoders of the first and second cVAE modules to produce a multimodal latent representation for each neuron.

The disclosed approach treats recording-source conditioning as a core mechanism for achieving technology-invariant neuronal representations. This conditioning enables deployment across diverse electrophysiology platforms including high-density microelectrode arrays (HD-MEAs), Neuropixels probes, silicon probes, and juxtacellular recording pipettes. The system achieves classification accuracy exceeding 91% on cross-platform inductive benchmarks. Baseline methods including PhysMAP and principal component analysis (PCA) based dimensionality reduction achieve less than 15% accuracy on the same benchmarks. This performance improvement results from the conditioning mechanism that reduces recording-platform-dependent variation while preserving biologically meaningful neuronal variation in the latent representations.

### Technical Problem

Extracellular electrophysiological recordings present unique computational challenges for neuronal classification due to noise, technical variability, and batch effects across experimental systems. High-throughput recording technologies have emerged for characterizing neuronal activity at scale. These technologies include planar HD-MEAs, flexible three-dimensional microelectrode array baskets, and high-density probes such as Neuropixels. Each technology captures extracellular action potentials with different electrode geometries, sampling rates, signal-to-noise characteristics, and spatial resolutions. When researchers attempt to pool neuronal data recorded from different platforms, the technical differences between recording devices introduce batch effects that corrupt classification performance.

Conventional classification approaches rely on single-modality analysis or modality-agnostic dimensionality reduction techniques. PhysMAP adapts single-cell genomics strategies to electrophysiology by combining Uniform Manifold Approximation and Projection (UMAP) with weighted nearest neighbors. UMAP cannot model sequential dependencies in spike-timing data. Alternative variational autoencoder (VAE) based frameworks unify modalities through separate encoders but prioritize reconstruction over discrimination. These frameworks also require spatial metadata absent in in vitro systems such as organoids. Self-supervised approaches such as NEMO employ contrastive learning to align waveform and autocorrelogram embeddings. NEMO assumes modality-invariant neuronal signatures that may not hold for dynamically coupled features such as spike timing versus waveform.

The batch-effect problem becomes acute when analyzing data from multiple experimental preparations, multiple laboratories, or multiple recording technologies. Conventional classifiers in electrophysiology often employ transductive splits. Transductive splits pool neurons from all experimental samples before partitioning into training and testing sets. This approach inflates performance metrics by allowing models to exploit sample-specific artifacts such as electrode drift and session-specific noise rather than biologically generalizable features. When forced to generalize to entirely unseen experimental preparations through inductive splits, baseline methods fail catastrophically. On the Allen Brain Institute Visual Coding dataset comprising 16,564 units across 40 brain areas from 47 mice, PhysMAP and PCA-based methods achieve less than 15% accuracy under inductive evaluation. This performance approximates chance-level classification across 40 brain regions.

The failure of existing methods prevents critical applications in neuroscience and neurotechnology. Brain-computer interfaces require identification of brain regions and cell types generating neural signals to interpret user intent. Brain-region classification enables targeting of regions challenging to access via probe insertion. Reproducibility assessment of engineered neuronal systems such as cortical organoids requires cross-platform harmonization of electrophysiological recordings. Existing methods cannot provide these capabilities because they fail to disentangle invariant neuronal properties from experimental noise introduced by different recording technologies.

### Technical Solution

The technology disclosed introduces a system that receives spike-sorted extracellular electrophysiological recordings from one or more recording devices and classifies neurons into neuronal categories. A data interface receives recordings representing extracellular neuronal activity of a plurality of neurons. One or more processors extract two complementary features for each neuron. The first feature comprises a waveform feature representing the shape of an extracellular action potential. The waveform feature comprises a normalized mean extracellular waveform computed by averaging spike-triggered voltage traces across a plurality of detected action potentials of the neuron. The second feature comprises an ISI feature representing the temporal distribution of intervals between successive action potentials. The ISI feature comprises an interspike-interval histogram computed from intervals between consecutive detected action potentials of the neuron. The waveform feature correlates most strongly with neuronal cell type. The ISI feature correlates most strongly with anatomical brain region. Each feature is represented as a respective one-dimensional vector.

The system processes these features through paired cVAE modules trained in parallel. A first c VAE module processes the waveform feature. A second cVAE module processes the ISI feature. Each cVAE module is conditioned on a recording-source descriptor associated with the recording device. The recording-source descriptor identifies at least one of the following: a recording-technology type identifying the type of recording device used to capture the electrophysiological recording, a brain-region identifier identifying an anatomical region from which the recording was obtained, or an organoid-line identifier identifying a pluripotent stem cell line from which an organoid source of the recording was derived. The conditioning causes each encoder to learn which variation in the input data arises from the recording technology rather than from biological neuronal properties. Each encoder produces a latent embedding in which recording-platform-dependent variation is reduced relative to biological neuronal variation.

A mixture module combines the latent embeddings produced by the encoders of the first and second cVAE modules to produce a multimodal latent representation for each neuron. In some implementations, the mixture module combines the latent embeddings by concatenation. The multimodal latent representation captures complementary information from both input modalities. The system then performs one or more analysis operations on the multimodal latent representations to generate an analysis result characterizing the plurality of neurons.

In some implementations, the analysis operations include classification using a K-nearest-neighbors (KNN) classifier. The KNN classifier classifies each neuron into a neuronal category based on proximity to labeled reference representations in the multimodal latent representations. The KNN classifier determines the neuronal category by majority vote of labels of training samples closest to the test sample as measured by Euclidean distance. The KNN classifier generates a confidence score for each classification. The confidence score represents the proportion of neighboring representations that share the assigned neuronal category. An output interface outputs the neuronal category for each classified neuron.

The system architecture enables a self-supervised pretraining strategy that leverages large unlabeled datasets. The processors pretrain the cVAE modules using self-supervised learning on multiple electrophysiology datasets with neuronal category labels masked while conditioning on the recording-source descriptor. The pretraining employs a leave-one-dataset-out strategy. The labeled target dataset remains excluded from the plurality of electrophysiology datasets used during pretraining. Following pretraining, the processors fine-tune the cVAE modules using supervised learning on the labeled target dataset with neuronal category labels provided. During fine-tuning, each mini-batch of training data contains an equal proportion of each class label. The learning rate for fine-tuning equals a fraction of the learning rate used during pretraining.

The KNN classifier produces superior classification performance compared to multilayer perceptron (MLP) classifiers on the multimodal latent representations. The multimodal latent representations exhibit tight local neighborhood structure. Samples belonging to the same neuronal category cluster together in the multimodal latent representations. This geometric property makes distance-based classification methods more effective than parametric classifiers that learn global decision boundaries. The KNN classifier achieves about 75% accuracy on some benchmarks. The MLP classifier achieves about 55% accuracy on the same benchmarks. This 20-percentage-point performance gap demonstrates that the multimodal latent representations are better suited for local neighborhood-based classification using KNN rather than global boundary-based learning with MLP.

### Technical Benefits and Results

The system achieves classification accuracy exceeding about 45% on the Allen Visual Coding inductive benchmark. Baseline methods including PhysMAP and PCA achieve less than 15% accuracy on the same benchmark. This 30-percentage-point improvement represents a qualitative difference between a system that does not work and a system that does. The system generalizes across distinct experimental preparations while maintaining high anatomical resolution across 40 brain areas.

The system accurately classifies neuronal subtypes using waveform features. On cell-type classification tasks involving optotagged interneuron subtypes, the system achieves accuracy ranging from 65% to 95% across multiple datasets and recording technologies. The system classifies parvalbumin-positive, somatostatin-positive, and vasoactive intestinal peptide-positive interneurons from putative excitatory neurons. The system maintains this performance across juxtacellular recordings, silicon probe recordings, and Neuropixels recordings.

The system identifies reproducible electrophysiological clusters in cortical organoids derived from distinct pluripotent stem cell (PSC) lines. Unsupervised clustering on the multimodal latent representations reveals six electrophysiological clusters in both waveform and ISI modalities. All clusters exhibit balanced representation across three independent PSC lines. This balanced representation demonstrates robust cross-line reproducibility of electrophysiological phenotypes. The system enables direct comparison of neuronal phenotypes across organoid preparations derived from different cell lines.

### Patent-Eligible Subject Matter

The system receives spike-sorted extracellular electrophysiological recordings captured by one or more recording devices. These recordings represent physical electrical signals generated by neurons. The waveform feature represents the shape of an extracellular action potential. The ISI feature represents the temporal distribution of intervals between successive action potentials. These features constitute domain-specific physical measurements derived from neuronal electrical activity captured by physical recording hardware.

The system employs a particular machine architecture. The paired cVAE modules conditioned on a recording-source descriptor constitute a specific neural network architecture distinct from generic dimensionality reduction methods. The recording-source conditioning mechanism produces a specific technical improvement. The conditioning reduces recording-platform-dependent variation in the latent embeddings while preserving biological neuronal variation. This technical improvement enables cross-platform neuronal classification that prior systems could not achieve.

The ordered combination of elements produces an unconventional result. The specific combination comprises extracting waveform and ISI features as one-dimensional vectors, processing the features through paired cVAE modules conditioned on recording-source descriptors with each module trained in parallel, combining the encoder outputs via a mixture module, and classifying using a KNN classifier. This combination produces technology-invariant neuronal classification at greater than 45% accuracy. Baseline methods achieve less than 15% accuracy. This ordered combination is not routine or well understood in the art.

The system produces concrete outputs tied to the specific technological domain. The output interface outputs neuronal categories for classified neurons. These categories comprise neuronal subtype classifications identifying each neuron as belonging to a genetically defined cell type or anatomical region classifications mapping each neuron to a brain region. The confidence score provides a probabilistic measure of classification certainty ranging from zero to one. These outputs enable downstream applications in brain-computer interfaces, probe targeting, and organoid reproducibility assessment.

### Electrophysiological Recording and Analysis Environment:

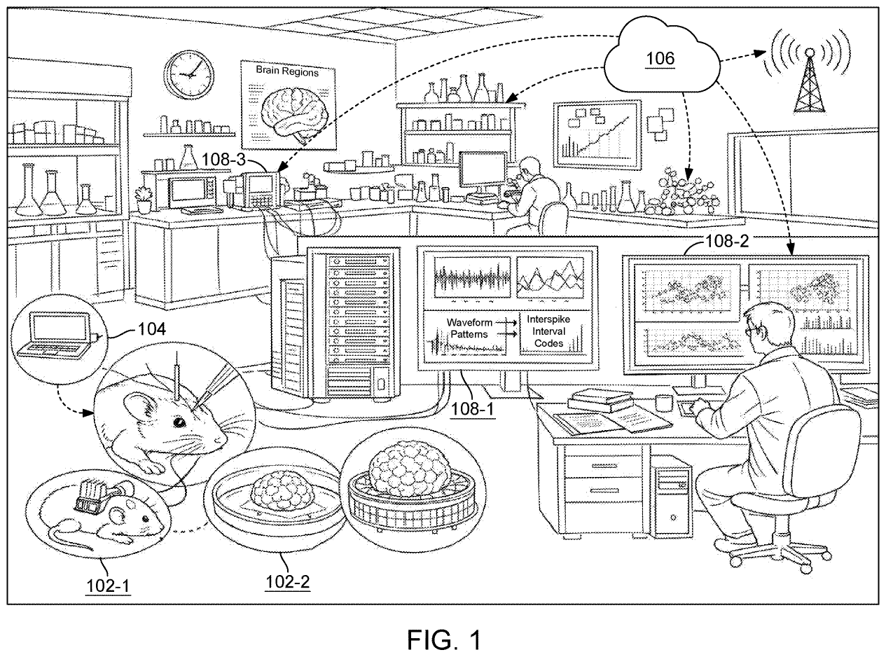

FIG. 1 illustrates an extracellular electrophysiological recording and analysis environment. The environment includes one or more recording devices 102-1 and one or more recording devices 102-2 configured to capture extracellular neuronal activity from biological preparations including in vivo sources and in vitro sources. Recording device(s) 102-1 and recording device(s) 102-2 generate extracellular electrophysiological recordings that include spike events associated with a plurality of neurons. A data interface 104 is configured to receive the extracellular electrophysiological recordings captured by recording device(s) 102-1 and recording device(s) 102-2.

The environment further includes computing resources 108-1, 108-2, and 108-3 operatively coupled to the data interface 104. The computing resources 108-1, 108-2, and 108-3 are configured to process the extracellular electrophysiological recordings. The computing resources 108-1, 108-2, and 108-3 extract, from the extracellular electrophysiological recordings, for each of the plurality of neurons, a waveform feature representing a shape of an extracellular action potential of the neuron and an interspike interval feature representing a temporal distribution of intervals between successive action potentials of the neuron.

The computing resources 108-1, 108-2, and 108-3 generate, for each neuron, a waveform latent code determined from the waveform feature and a timing latent code determined from the interspike interval feature using one or more conditional variational autoencoders. The one or more conditional variational autoencoders are conditioned on a recording source descriptor associated with at least one of recording device(s) 102-1 and recording device(s) 102-2. The computing resources 108-1, 108-2, and 108-3 further fuse the waveform latent code and the timing latent code to produce, for each neuron, a multimodal latent embedding.

The computing resources 108-1, 108-2, and 108-3 perform one or more analysis operations on the multimodal latent embeddings corresponding to the plurality of neurons to generate an analysis result characterizing the plurality of neurons. The one or more analysis operations include batch harmonization by applying batch effect correction to the multimodal latent embeddings to produce, for each neuron, a harmonized latent representation with reduced variation attributable to differences in recording source. The one or more analysis operations further include classification of each neuron into a neuronal category by applying a k-nearest neighbors classifier to the harmonized latent representations based on proximity to labeled reference representations in the harmonized latent representations. The computing resources 108-1, 108-2, and 108-3 output the neuronal category for each classified neuron.

The environment further includes networked communication resources 106 configured to communicate the extracellular electrophysiological recordings and the analysis results between the data interface 104 and the computing resources 108-1, 108-2, and 108-3.

### Data Acquisition and Feature Extraction Pipeline:

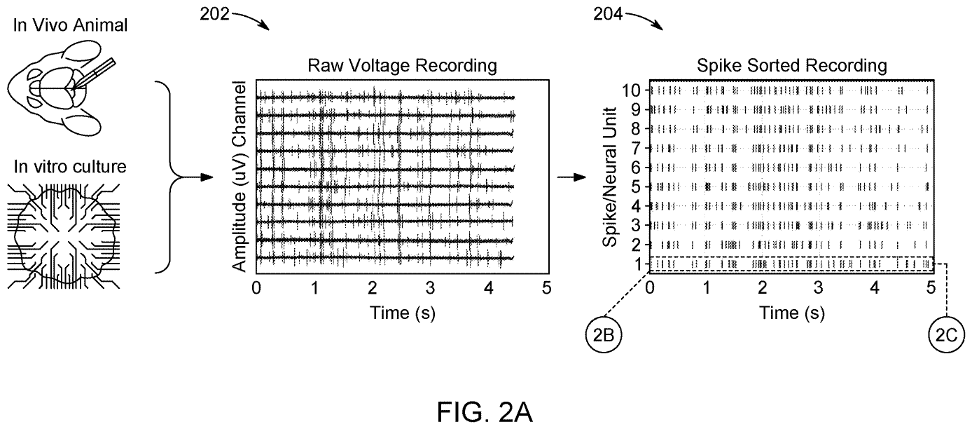

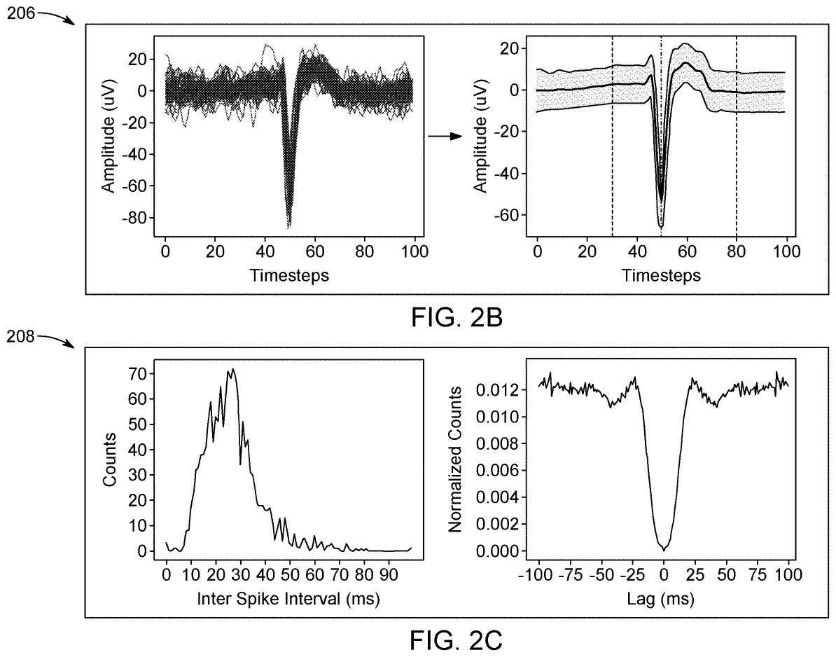

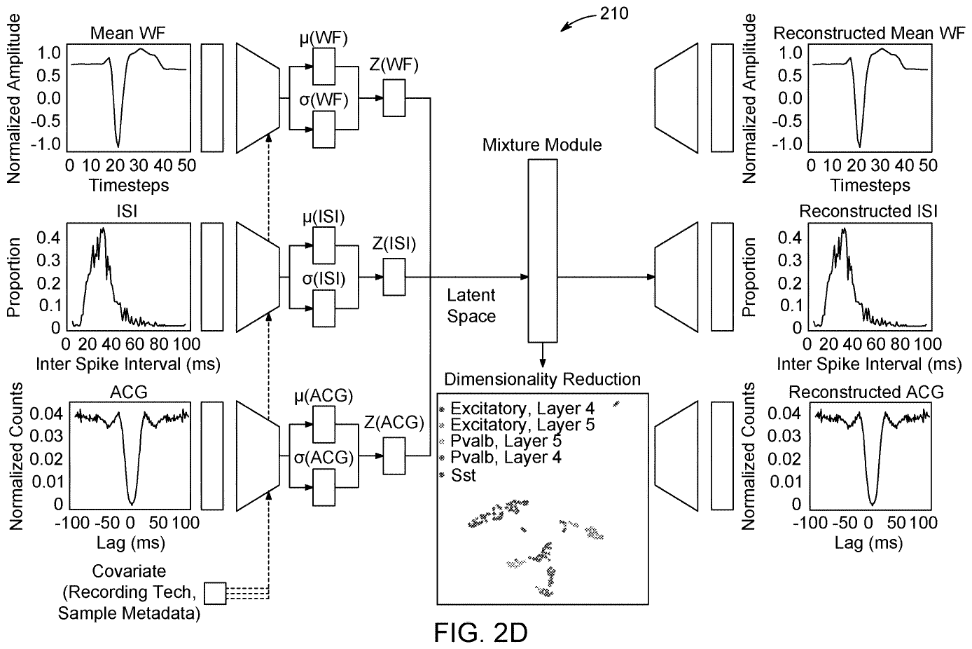

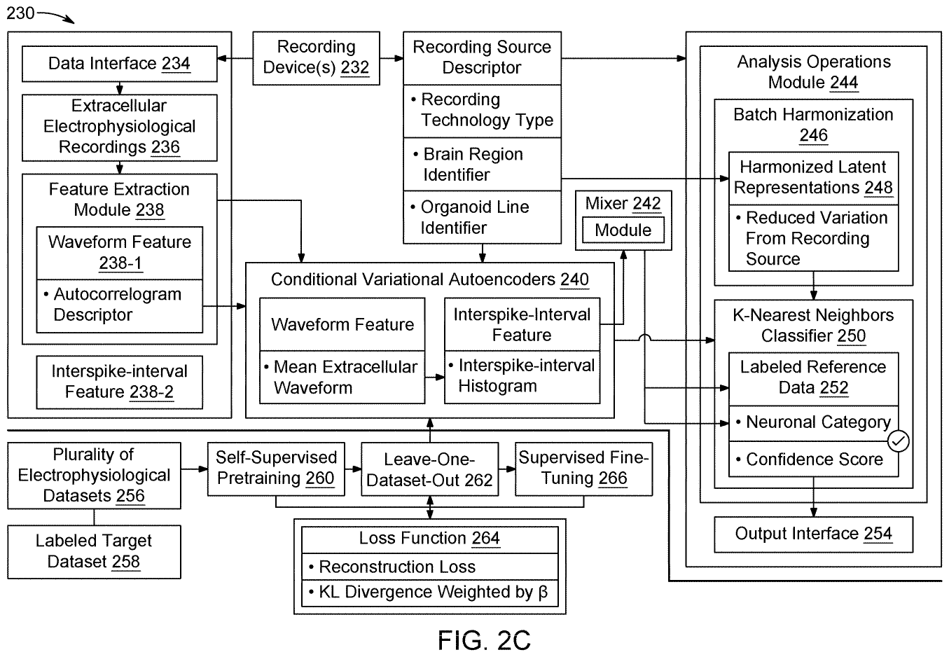

FIG. 2A illustrates a data acquisition and feature extraction pipeline for extracellular electrophysiological recordings. The data acquisition and feature extraction pipeline processes neural recordings obtained from biological sources to extract processed features suitable for neuronal classification.

An in vivo animal and an in vitro culture are depicted as biological sources of extracellular electrophysiological recordings. The in vivo animal represents a living organism from which extracellular neuronal activity is recorded using one or more recording devices. The one or more recording devices include microelectrode arrays, Neuropixels probes, NeuroNexus silicon probes, custom tetrodes, and juxtacellular recording pipettes. The in vitro culture represents engineered neuronal systems including cortical organoids or brain tissue slices cultured on recording platforms. The recording platforms include high density microelectrode arrays manufactured by MaxWell Biosystems and similar devices.

A raw voltage recording 202 receives the extracellular electrophysiological recordings from the in vivo animal or the in vitro culture. The raw voltage recording 202 is depicted as a multichannel voltage trace in which amplitude in microvolts per channel is plotted along a vertical axis and time in seconds is plotted along a horizontal axis. The raw voltage recording 202 captures electrical activity across multiple recording channels simultaneously.

A spike sorted recording 204 is produced from the raw voltage recording 202 by a spike sorting process. Spike sorting is a computational process that identifies and separates action potentials originating from individual neurons within the recorded electrical signals. The spike sorted recording 204 is depicted as a raster plot in which a spike or neural unit identifier is plotted along a vertical axis and time in seconds is plotted along a horizontal axis. Vertical marks in the spike sorted recording 204 represent detected action potentials associated with particular neuron units at particular times.

A waveform feature extraction 206 derives waveform features from the spike sorted recording 204. The spike timings identified during spike sorting are used to retrieve corresponding segments of the raw voltage recording 202. A 2.5 millisecond window centered on the action potential peak is extracted from the retrieved voltage segments. A left panel of the waveform feature extraction 206 depicts a plurality of individual spike waveforms overlaid on a common axis with amplitude in microvolts plotted along a vertical axis and timesteps plotted along a horizontal axis. A right panel of the waveform feature extraction 206 depicts a mean waveform computed by averaging the individual spike waveforms, with a shaded confidence region surrounding the mean waveform trace. Vertical dashed lines in the right panel mark the temporal boundaries of the extraction window. The waveform feature extraction 206 produces a one dimensional waveform feature vector representing a normalized mean extracellular waveform of the neuron.

Processed features 208 are computed from the spike sorted recording 204. The processed features 208 comprise an interspike interval feature and an autocorrelogram feature. A left panel of the processed features 208 depicts an interspike interval histogram in which counts are plotted along a vertical axis and inter spike interval in milliseconds is plotted along a horizontal axis. The interspike interval histogram represents a temporal distribution of intervals between successive action potentials of the neuron. A right panel of the processed features 208 depicts an autocorrelogram in which normalized counts are plotted along a vertical axis and lag in milliseconds is plotted along a horizontal axis. The autocorrelogram represents a temporal autocorrelation function computed from the action potential spike train of the neuron, capturing periodicity and burstiness in neuronal firing patterns. The interspike interval feature and the autocorrelogram feature are represented as one dimensional vectors.

The waveform feature vector produced by the waveform feature extraction 206, the interspike interval feature, and the autocorrelogram feature produced as the processed features 208 together provide a multimodal characterization of neuronal identity from the extracellular electrophysiological recordings. The waveform feature captures action potential morphology, the interspike interval feature captures temporal firing interval statistics, and the autocorrelogram feature captures firing periodicity and burst dynamics, providing complementary electrophysiological information that correlates with neuronal cell type and anatomical brain region.

FIG. 2B illustrates a neuronal classification system implementing parallel conditional variational autoencoders for generating multimodal latent representations from extracellular electrophysiological features. The neuronal classification system comprises a deep learning framework that uses parallel conditional variational autoencoder modules built from one dimensional residual network encoder and decoder modules.

Input features 210 depict three one dimensional vectors received by the neuronal classification system. A first input feature is a mean waveform (Mean WF) represented as a one dimensional vector with normalized amplitude plotted along a vertical axis and timesteps plotted along a horizontal axis. A second input feature is an interspike interval distribution (ISI) represented as a one dimensional vector with proportion plotted along a vertical axis and inter spike interval in milliseconds plotted along a horizontal axis. A third input feature is an autocorrelogram (ACG) represented as a one dimensional vector with normalized counts plotted along a vertical axis and lag in milliseconds plotted along a horizontal axis.

A covariate comprising recording technology and sample metadata is depicted at a lower left portion of FIG. 2B. The covariate functions as a recording source descriptor identifying a recording technology type, an anatomical brain region from which the recording was obtained, or an organoid line identifier identifying a pluripotent stem cell line from which an organoid source of the recording was derived. The covariate is represented as a categorical variable. Dashed lines extending from the covariate connect to the conditional variational autoencoder modules, indicating that the covariate conditions the encoding process.

A first conditional variational autoencoder module processes the mean waveform feature. The first conditional variational autoencoder module comprises a one dimensional residual network encoder configured to generate a mean μ(WF) and a standard deviation σ(WF) for the dimensions of a latent space. The encoder of the first conditional variational autoencoder module samples a waveform latent code Z(WF) from the mean μ(WF) and the standard deviation σ(WF). A decoder of the first conditional variational autoencoder module reconstructs the mean waveform feature from the waveform latent code Z(WF) to produce a Reconstructed Mean WF depicted at a right portion of FIG. 2B with normalized amplitude plotted along a vertical axis and timesteps plotted along a horizontal axis.

A second conditional variational autoencoder module processes the interspike interval feature. The second conditional variational autoencoder module comprises a one dimensional residual network encoder configured to generate a mean μ(ISI) and a standard deviation σ(ISI) for the dimensions of a latent space. The encoder of the second conditional variational autoencoder module samples a timing latent code Z(ISI) from the mean μ(ISI) and the standard deviation σ(ISI). A decoder of the second conditional variational autoencoder module reconstructs the interspike interval feature from the timing latent code Z(ISI) to produce a Reconstructed ISI depicted at the right portion of FIG. 2B with proportion plotted along a vertical axis and inter spike interval in milliseconds plotted along a horizontal axis.

A third conditional variational autoencoder module processes the autocorrelogram feature. The third conditional variational autoencoder module comprises a one dimensional residual network encoder configured to generate a mean μ(ACG) and a standard deviation σ (ACG) for the dimensions of a latent space. The encoder of the third conditional variational autoencoder module samples an autocorrelogram latent code Z (ACG) from the mean μ(ACG) and the standard deviation σ(ACG). A decoder of the third conditional variational autoencoder module reconstructs the autocorrelogram feature from the autocorrelogram latent code Z(ACG) to produce a Reconstructed ACG depicted at the right portion of FIG. 2B with normalized counts plotted along a vertical axis and lag in milliseconds plotted along a horizontal axis.

The first conditional variational autoencoder module, the second conditional variational autoencoder module, and the third conditional variational autoencoder module are trained in parallel and are conditioned on the covariate. Conditioning on the covariate causes the encoders to generate latent codes in which variation attributable to recording platform differences is reduced relative to biological neuronal variation.

A Mixture Module depicted at a center portion of FIG. 2B combines the waveform latent code Z(WF) generated by the first conditional variational autoencoder module, the timing latent code Z(ISI) generated by the second conditional variational autoencoder module, and the autocorrelogram latent code Z (ACG) generated by the third conditional variational autoencoder module to produce a multimodal latent representation in a Latent space depicted below the Mixture Module. The Mixture Module combines the latent codes by concatenation. The multimodal latent representation captures complementary electrophysiological information from the three input modalities.

The conditional variational autoencoder loss function applied to the first conditional variational autoencoder module, the second conditional variational autoencoder module, and the third conditional variational autoencoder module combines two components that work in concert to create a structured latent space. A first component is a reconstruction loss term, which measures fidelity of decoder reconstruction of the respective one dimensional input vector from the latent code. A second component is a Kullback Leibler divergence term, which acts as a regularizer by encouraging the latent space to follow a prior distribution, typically a standard normal distribution.

The combination of the reconstruction loss term and the Kullback Leibler divergence term is formalized as:

$${\text{?}}_{VAE} = {E}_{q φ ( z \vert x )} [ {log p}_{θ} ( x \vert z ) + {β D}_{KL} ( {q}_{φ} ( z \vert x ) \vert \vert p ( x ) )$$

where q_{φ}(z|x) represents the encoder network (recognition model), p_{θ}(x|z) represents the decoder network (generative model), and p(z) is the prior distribution. The hyperparameter β controls the tradeoff between reconstruction quality and latent space regularity, with β=1 recovering the standard variational autoencoder formulation.

For a Gaussian encoder, the Kullback Leibler divergence term has a closed form analytical expression:

$${D}_{KL} ( {q}_{φ} ( z \vert x ) \vert \vert p ( x ) ) = \frac{1}{2} {{\sum }^{J}}_{j = 1} ( {σ}_{j}^{2} + {μ}_{j}^{2} - log ( {σ}_{j}^{2} ) - 1 )$$

where μⱼ and σⱼ are the predicted mean and standard deviation for the j-th dimension of the latent space.

Higher values of β place greater emphasis on the regularization term, leading to a more organized latent space at the cost of reconstruction fidelity, while lower values of β prioritize reconstruction quality. The decoders of the first, second, and third conditional variational autoencoder modules enable learning of structured latent representations by minimizing the reconstruction loss term.

A Dimensionality reduction step depicted below the Latent space in FIG. 2B is applied to the multimodal latent representations to produce reduced dimensional representations suitable for classification, clustering, or visualization tasks. A two dimensional scatter plot depicted at a lower center portion of FIG. 2B shows the reduced dimensional representations distinguished by neuronal category. Five neuronal categories are depicted in the scatter plot legend: Excitatory Layer 4, Excitatory Layer 5, Pvalb positive Layer 5, Pvalb positive Layer 4, and Sst positive neurons. The separation among the neuronal categories in the two dimensional scatter plot demonstrates that the multimodal latent representations generated by the parallel conditional variational autoencoder modules conditioned on the covariate capture discriminative electrophysiological features suitable for neuronal classification. The reduced dimensional representations enable application of a K nearest neighbors classifier to classify neurons into neuronal categories based on proximity to labeled reference representations in the multimodal latent representations.

### System for Classification:

FIG. 2C illustrates a system 230 for classifying neurons from extracellular electrophysiological recordings. The system 230 provides an integrated architectural view of how extracellular neural signals captured from heterogeneous recording platforms are transformed, harmonized, and classified into biologically meaningful neuronal categories. In particular, FIG. 2C depicts how raw electrophysiological inputs, recording-source metadata, feature extraction, representation learning, harmonization, classification, and training workflows are orchestrated within a single computational framework.

At an input stage, the system 230 includes a data interface 234 that is operably connected to one or more recording devices 232. The recording devices 232 are configured to capture extracellular neuronal activity from biological sources, including in vivo animals and in vitro cultures. In example implementations, the recording devices 232 may include high-density microelectrode arrays, Neuropixels probes, silicon probes, and juxtacellular recording pipettes. Each recording device 232 generates extracellular electrophysiological recordings 236 representing voltage fluctuations produced by action potentials of a plurality of neurons in proximity to the recording electrodes.

The data interface 234 functions as an acquisition and ingestion layer that receives the extracellular electrophysiological recordings 236 from the recording devices 232. The data interface 234 may perform signal buffering, formatting, or synchronization operations to ensure that the extracellular electrophysiological recordings 236 are provided in a consistent representation suitable for downstream processing. In this manner, the data interface 234 decouples the physical recording hardware from the computational analysis pipeline implemented by the system 230.

In parallel with receiving the extracellular electrophysiological recordings 236, the system 230 also receives a recording source descriptor associated with the at least one recording device 232. The recording source descriptor captures contextual information describing the conditions under which the extracellular electrophysiological recordings 236 were obtained. As illustrated in FIG. 2C, the recording source descriptor comprises one or more of a recording technology type, a brain region identifier, and an organoid line identifier. The recording technology type identifies the class of recording device used, such as a high-density microelectrode array or a Neuropixels probe. The brain region identifier specifies an anatomical region from which the recordings were obtained in in vivo experiments. The organoid line identifier specifies a pluripotent stem cell line from which an organoid source was derived in in vitro experiments. The recording source descriptor is represented as a categorical string and is used throughout the system 230 to distinguish variation arising from experimental or technological factors from variation arising from intrinsic neuronal properties.

Following data acquisition, the extracellular electrophysiological recordings 236 are provided to a feature extraction module 238. The feature extraction module 238 is operably connected to the data interface 234 and is configured to extract electrophysiologically meaningful features from the extracellular electrophysiological recordings 236. For each neuron identified in the recordings, the feature extraction module 238 extracts a waveform feature 238-1 and an interspike interval feature 238-2.

The waveform feature 238-1 represents the shape of an extracellular action potential associated with a neuron. In particular, the waveform feature 238-1 comprises a mean extracellular waveform computed by averaging spike-triggered voltage traces across a plurality of detected action potentials of the neuron. As illustrated in FIG. 2C, the mean extracellular waveform is represented as a one-dimensional vector sampled within a time window of approximately 2.5 milliseconds at a sampling rate of at least 20 kilohertz. This representation captures morphological characteristics of the action potential waveform that are strongly associated with neuronal subtype.

The interspike interval feature 238-2 represents a temporal distribution of intervals between successive action potentials generated by the neuron. The interspike interval feature 238-2 comprises an interspike interval histogram computed from intervals between consecutive detected action potentials. In the illustrated embodiment, the interspike interval histogram is represented using one-dimensional bins at a temporal resolution of approximately 1 millisecond spanning approximately 100 milliseconds. This representation captures firing dynamics and temporal structure that correlate strongly with anatomical brain region.

The autocorrelogram descriptor 238-3 represents a temporal autocorrelation function computed from the action potential spike train of the neuron. The autocorrelogram descriptor 238-3 captures periodicity and burstiness in neuronal firing patterns that complement the waveform morphology captured by the waveform feature 238-1 and the temporal interval statistics captured by the interspike interval feature 238-2. The autocorrelogram descriptor 238-3 is represented as a one dimensional vector. The autocorrelogram descriptor 238-3 provides a third electrophysiological modality that, together with the waveform feature 238-1 and the interspike interval feature 238-2, enables a multimodal characterization of neuronal identity from the extracellular electrophysiological recordings 236.

Once extracted, the waveform feature 238-1 and the interspike interval feature 238-2 are provided to conditional variational autoencoders 240. The conditional variational autoencoders 240 form a core representation learning component of the system 230 and are configured to transform electrophysiological features into latent representations that are robust to recording-platform variability. As illustrated, the conditional variational autoencoders 240 include a first conditional variational autoencoder module configured to process the waveform feature 238-1 and a second conditional variational autoencoder module configured to process the interspike interval feature 238-2. These two conditional variational autoencoder modules are trained in parallel, allowing each modality to be encoded independently while remaining aligned within a shared latent framework.

Each conditional variational autoencoder module comprises a one-dimensional residual network encoder and a one-dimensional residual network decoder. The encoders generate latent distributions parameterized by a mean and a standard deviation for each latent dimension, and latent embeddings are sampled from these distributions. Importantly, both conditional variational autoencoder modules are conditioned on the recording source descriptor. Conditioning on the recording source descriptor enables the encoders to account explicitly for recording-technology-dependent and preparation-dependent variation, thereby reducing the influence of such variation in the learned latent embeddings relative to biologically meaningful neuronal variation.

The conditional variational autoencoders 240 generate a waveform latent code determined from the waveform feature 238-1 and a timing latent code determined from the interspike interval feature 238-2. These latent codes are then provided to a mixer module 242. The mixer module 242 is operably connected to the conditional variational autoencoders 240 and is configured to fuse the waveform latent code and the timing latent code into a multimodal latent embedding for each neuron. In the illustrated embodiment, the mixer module 242 combines the latent embeddings by concatenation, thereby forming a joint latent representation that captures complementary information from both waveform morphology and spike-timing dynamics.

The multimodal latent embeddings generated by the mixer module 242 are then provided to an analysis operations module 244. The analysis operations module 244 performs downstream analytical processing on the multimodal latent embeddings to generate analysis results characterizing the plurality of neurons. One such analysis operation illustrated in FIG. 2C is batch harmonization 246. The batch harmonization 246 applies batch-effect correction to the multimodal latent embeddings to produce harmonized latent representations 248. The harmonized latent representations 248 exhibit reduced variation attributable to differences in recording source, thereby enabling neurons recorded using different recording devices or experimental preparations to be compared within a common representational space.

Following batch harmonization, the harmonized latent representations 248 are provided to a K-nearest neighbors classifier 250. The K-nearest neighbors classifier 250 is configured to classify each neuron into a neuronal category based on proximity to labeled reference data 252 in the harmonized latent representations 248. The labeled reference data 252 comprises labeled reference representations corresponding to known neuronal categories. The K-nearest neighbors classifier 250 uses Euclidean distance to identify nearest neighbors and determines the neuronal category for each neuron by majority vote among the neighboring labeled reference representations. In addition to assigning a neuronal category, the K-nearest neighbors classifier 250 generates a confidence score for each classification. The confidence score is derived as a proportion of neighboring representations that share the assigned neuronal category, thereby providing a quantitative measure of classification reliability.

The neuronal category assigned by the K-nearest neighbors classifier 250 may comprise a neuronal subtype classification identifying a genetically defined cell type or an anatomical region classification mapping the neuron to a brain region based on electrophysiological characteristics encoded in the harmonized latent representations 248.

Classification results are communicated through an output interface 254 operably connected to the analysis operations module 244. The output interface 254 is configured to output the neuronal category and the corresponding confidence score for each classified neuron. The output interface 254 may be implemented as a display interface, a data transmission interface, or an integrated component of a larger neuronal analysis system, enabling use of the classification results in downstream scientific or neurotechnology applications.

FIG. 2C further illustrates a training architecture supporting the conditional variational autoencoders 240. The training architecture includes a plurality of electrophysiological datasets 256 and a labeled target dataset 258. The plurality of electrophysiological datasets 256 comprises electrophysiological recordings obtained across different recording devices, brain regions, and experimental preparations. The labeled target dataset 258 comprises electrophysiological recordings with known neuronal category labels.

The training architecture implements a two-phase training protocol. In a first phase, self-supervised pretraining 260 is performed using the plurality of electrophysiological datasets 256 with neuronal category labels masked. During self-supervised pretraining 260, the conditional variational autoencoders 240 learn to encode waveform features and interspike interval features into latent representations while conditioning on the recording source descriptor. The self-supervised pretraining 260 employs a leave-one-dataset-out strategy 262, in which the labeled target dataset 258 is excluded from the plurality of electrophysiological datasets 256 used during pretraining. This strategy enables evaluation of generalization performance on unseen datasets.

Training of the conditional variational autoencoders 240 is governed by a loss function 264 comprising a reconstruction loss term and a Kullback-Leibler divergence term weighted by a hyperparameter β. The reconstruction loss term measures fidelity of decoder reconstruction of the respective one-dimensional input vectors, while the Kullback-Leibler divergence term regularizes the latent embeddings toward a prior distribution. The hyperparameter β controls a tradeoff between reconstruction quality and latent space regularity.

Following self-supervised pretraining 260, supervised fine-tuning 266 is performed using the labeled target dataset 258. During supervised fine-tuning 266, neuronal category labels are provided, and training batches are sampled to include balanced class proportions. The supervised fine-tuning 266 adapts the learned latent representations to the specific classification task defined by the labeled target dataset 258 while preserving the technology-invariant structure learned during pretraining.

### Anatomical Locations Benchmarks

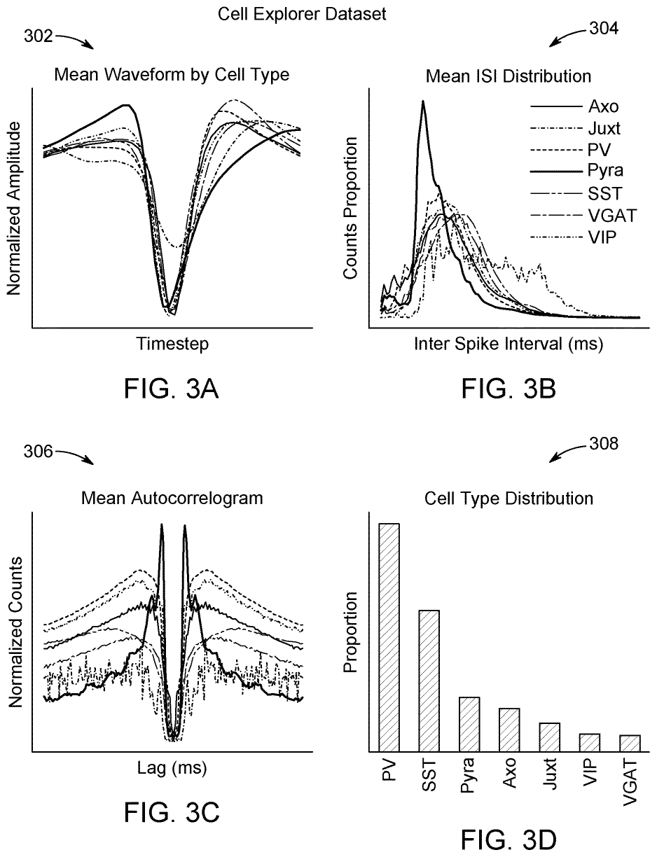

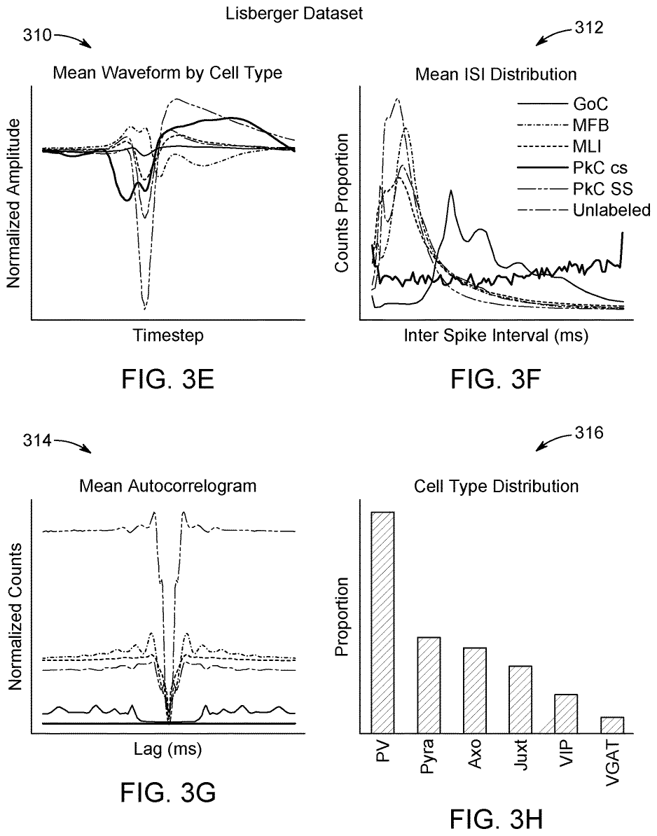

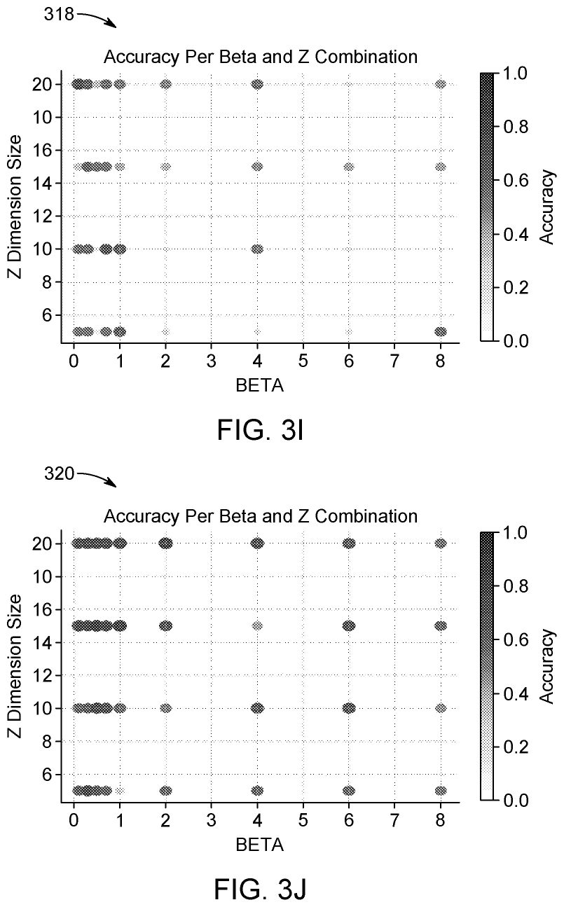

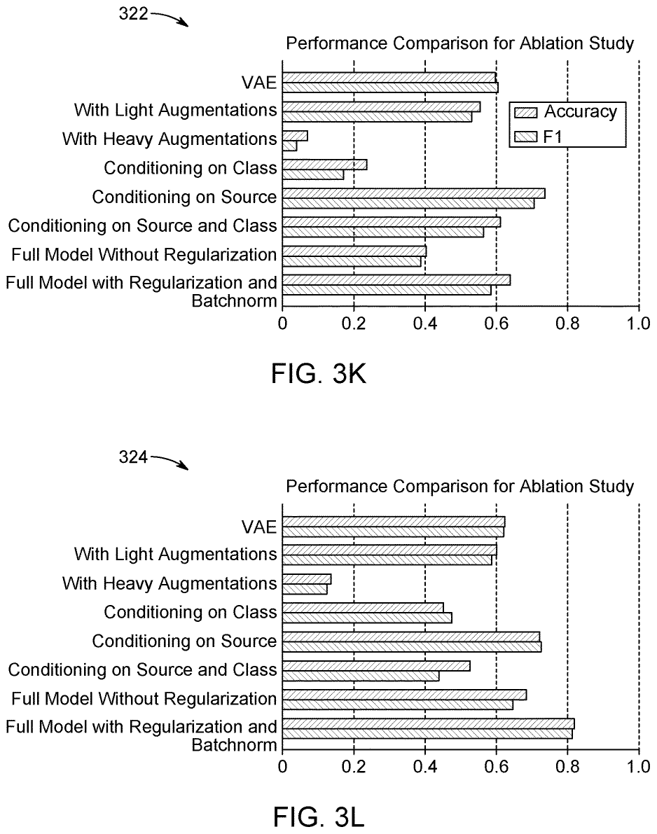

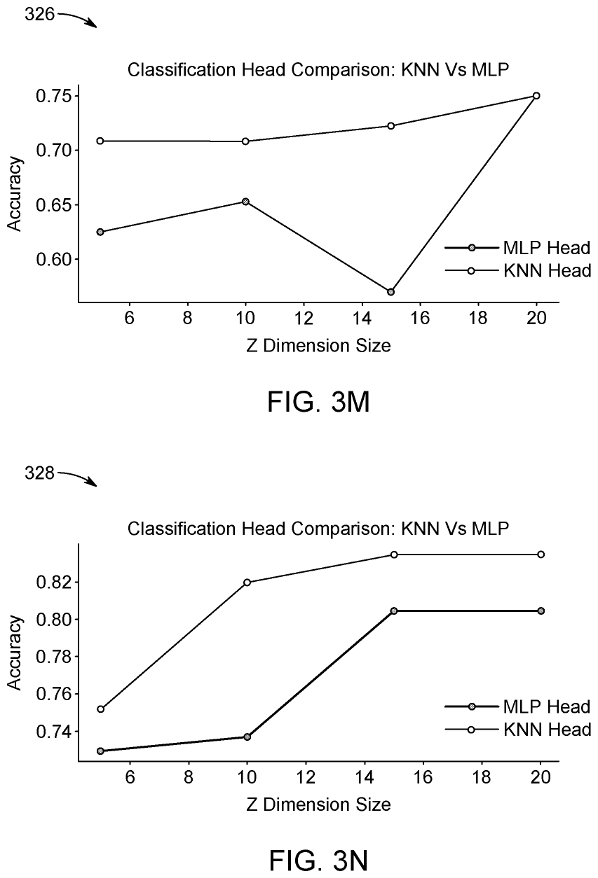

FIG. 3A illustrates average feature distributions per neuronal category and neuronal category proportions for the CellExplorer Cell Type Dataset and the Lisberger Dataset. The CellExplorer Cell Type Dataset comprises extracellular electrophysiological recordings captured by a recording device of the Neuropixels 1.0 probe recording technology type from mouse visual cortex and hippocampus. The Lisberger Dataset comprises extracellular electrophysiological recordings captured by a recording device from cerebellar brain regions representing a neuroanatomically distinct brain structure compared to the cortical and hippocampal recordings of the CellExplorer Cell Type Dataset. Each dataset is associated with at least one recording source parameter comprising at least one of a recording technology type identifying a type of recording device used to capture the electrophysiological recording, a brain region identifier identifying an anatomical region from which the recording was obtained, or an organoid line identifier identifying a pluripotent stem cell line from which an organoid source of the recording was derived. FIG. 3A establishes the electrophysiological diversity of neuronal categories within each dataset and contextualizes the hyperparameter sensitivity analyses depicted in FIG. 3B through FIG. 3D.

A left portion of FIG. 3A depicts the CellExplorer Cell Type Dataset. A mean waveform feature plot 302 displays normalized amplitude traces as a function of timestep for seven neuronal categories: axo axonic cells (Axo), juxtacellular recorded cells (Juxt), parvalbumin positive interneurons (PV), pyramidal neurons (Pyra), somatostatin positive interneurons (SST), vesicular GABA transporter positive cells (VGAT), and vasoactive intestinal peptide positive interneurons (VIP). Each waveform feature trace represents a normalized mean extracellular waveform computed by averaging spike triggered voltage traces across a plurality of detected action potentials for each neuron. Each normalized mean extracellular waveform comprises a one dimensional vector of data points sampled within a time window of approximately 2.5 milliseconds at a sampling rate of at least 20 kilohertz. Each neuronal category exhibits a distinct mean waveform feature trace, reflecting differences in extracellular action potential shape across genetically defined cell types. The waveform feature represents a shape of an extracellular action potential of the neuron.

A mean interspike interval feature distribution plot 304 displays counts proportion as a function of inter spike interval in milliseconds for the same seven neuronal categories. The interspike interval feature represents a temporal distribution of intervals between successive action potentials of each of the plurality of neurons. Each interspike interval feature distribution comprises a histogram of intervals between consecutive spikes binned at a predetermined temporal resolution of approximately 1 millisecond spanning approximately 100 milliseconds. Each interspike interval feature is represented as a one dimensional vector. The mean interspike interval feature distributions reveal distinct temporal firing patterns among the neuronal categories within the CellExplorer Cell Type Dataset.

A mean autocorrelogram feature plot 310 displays normalized counts as a function of lag in milliseconds for each neuronal category in the CellExplorer Cell Type Dataset. The autocorrelogram feature represents a temporal autocorrelation function computed from the action potential spike train of the neuron. The mean autocorrelogram feature traces further differentiate the neuronal categories by capturing rhythmic and refractory firing properties that complement the waveform feature and interspike interval feature representations. A first conditional variational autoencoder module processes the waveform feature, a second conditional variational autoencoder module processes the interspike interval feature, and a third conditional variational autoencoder module processes the autocorrelogram feature. Each of the first conditional variational autoencoder module, the second conditional variational autoencoder module, and the third conditional variational autoencoder module comprises a one dimensional residual network encoder and a one dimensional residual network decoder. A mixture module combines the latent embeddings output by the first conditional variational autoencoder module, the second conditional variational autoencoder module, and the third conditional variational autoencoder module into a joint latent representation.

A cell type distribution bar chart 312 displays the proportion of neuron units belonging to each neuronal category within the CellExplorer Cell Type Dataset. The bar chart 312 indicates that parvalbumin positive interneurons (PV) and somatostatin positive interneurons (SST) constitute the largest proportions, while axo axonic cells (Axo), juxtacellular recorded cells (Juxt), vasoactive intestinal peptide positive interneurons (VIP), and vesicular GABA transporter positive cells (VGAT) represent smaller proportions. The distribution provides context for class imbalance present in the CellExplorer Cell Type Dataset and informs interpretation of classification performance across neuronal categories.

A right portion of FIG. 3A depicts the Lisberger Dataset. A mean waveform feature plot 306 displays normalized amplitude traces as a function of timestep for six neuronal categories: Golgi cells (GoC), mossy fiber boutons (MFB), molecular layer interneurons (MLI), Purkinje cell complex spikes (PkC cs), Purkinje cell simple spikes (PkC SS), and unlabeled neurons. Each waveform feature trace represents a normalized mean extracellular waveform computed by averaging spike triggered voltage traces across a plurality of detected action potentials for each neuron. Each neuronal category exhibits a distinct mean waveform feature trace that differs substantially from the cortical waveform morphologies depicted in the CellExplorer Cell Type Dataset.

A mean interspike interval feature distribution plot 308 displays counts proportion as a function of inter spike interval in milliseconds for the six neuronal categories of the Lisberger Dataset. The interspike interval feature distributions capture cerebellar specific temporal firing dynamics, including the characteristically high firing rates of Purkinje cell simple spikes. Each interspike interval feature distribution comprises a histogram of intervals between consecutive spikes binned at a predetermined temporal resolution.

A mean autocorrelogram feature plot 314 displays normalized counts as a function of lag in milliseconds for each neuronal category in the Lisberger Dataset. The autocorrelogram feature traces represent the temporal autocorrelation function computed from the action potential spike train of each neuron and reveal cerebellar specific firing periodicity and refractory characteristics across the six neuronal categories.

A cell type distribution bar chart 316 displays the proportion of neuron units belonging to each neuronal category within the Lisberger Dataset. The bar chart 316 indicates that unlabeled neurons and Purkinje cell simple spikes (PkC SS) constitute the largest proportions, followed by Golgi cells (GoC), Purkinje cell complex spikes (PkC Cs), mossy fiber boutons (MFB), and molecular layer interneurons (MLI). The feature distributions depicted in FIG. 3A establish the electrophysiological diversity within each dataset and provide the baseline characterization against which the hyperparameter tuning results of FIG. 3B, the ablation analysis of FIG. 3C, and the classification head comparison of FIG. 3D are evaluated.

FIG. 3B illustrates grid plots for hyperparameter tuning of the hyperparameter β and the latent space dimensionality Z for the CellExplorer Cell Type Dataset and the Lisberger Dataset. A left grid plot 318 depicts the CellExplorer Cell Type Dataset, and a right grid plot 320 depicts the Lisberger Dataset.

For each dataset, the grid plot displays a two dimensional parameter space in which the vertical axis represents the latent space dimensionality Z ranging from approximately 5 to 20, and the horizontal axis represents the hyperparameter β ranging from 0 to 8. Each point in the grid plot is shaded by the classification accuracy achieved by the system for classifying neurons using conditional variational autoencoders with the corresponding combination of β and Z values. The shading scale ranges from 0.0 (lightest) to 1.0 (darkest), with darker shading indicating higher classification accuracy. The classification accuracy is assessed using a K nearest neighbors classifier with 5 fold cross validation.

The left grid plot 318 reveals that for the CellExplorer Cell Type Dataset, the system for classifying neurons achieves the highest classification accuracy at latent space dimensionalities of approximately 15 to 20 combined with moderate values of β. Lower latent space dimensionalities of approximately 5 coupled with any value of β result in substantially reduced accuracy. The right grid plot 320 reveals a similar pattern for the Lisberger Dataset, where higher latent space dimensionalities paired with low to moderate values of β produce the highest classification accuracy.

The grid plots of FIG. 3B demonstrate the sensitivity of the loss function of the conditional variational autoencoders to the tradeoff controlled by the hyperparameter β. Each of the one or more conditional variational autoencoders is trained using a loss function comprising a reconstruction loss term and a Kullback Leibler divergence term weighted by the hyperparameter β. The reconstruction loss term measures fidelity of a decoder reconstruction of the respective one dimensional vector. The Kullback Leibler divergence term regularizes the respective latent embedding toward a prior distribution. Higher values of β place more emphasis on the Kullback Leibler divergence term, leading to a more organized latent space at the cost of reconstruction fidelity. Lower values of β prioritize reconstruction quality. The results confirm that moderate values of both parameters produce optimal classification performance, and inform selection of the hyperparameter values used in the benchmark evaluations.

FIG. 3C illustrates an ablation analysis comparing classification performance of different architecture choices for the system for classifying neurons from extracellular electrophysiological recordings. A left ablation bar chart 322 depicts results for the CellExplorer Cell Type Dataset, and a right ablation bar chart 324 depicts results for the Lisberger Dataset. Each bar chart includes accuracy (dark bars) and F1 score (light bars) comparisons across architectural variants.

The architectural variants evaluated in FIG. 3C include, from bottom to top: a full model with regularization and batch normalization, a full model without regularization, conditioning on source and class, conditioning on source, conditioning on class, a model with heavy augmentations, a model with light augmentations, and a standalone variational autoencoder (VAE) without conditioning on the recording source descriptor. For each architectural variant, the ablation bar charts 322 and 324 depict the classification accuracy and F1 score obtained using a K nearest neighbors classifier.

The left ablation bar chart 322 for the CellExplorer Cell Type Dataset reveals that the full model with regularization and batch normalization achieves the highest combined accuracy and F1 score among all architectural variants. The full model without regularization achieves a slightly lower F1 score. Conditioning on source and class together produces higher performance than conditioning on source alone or conditioning on class alone. The standalone variational autoencoder without conditioning on the recording source descriptor achieves the lowest classification accuracy and F1 score, confirming that conditioning on the recording source descriptor is a critical architectural component.

The right ablation bar chart 324 for the Lisberger Dataset reveals a similar pattern. The full model with regularization and batch normalization achieves the highest classification accuracy and F1 score. Conditioning on source and class together outperforms conditioning on either variable alone. The standalone variational autoencoder produces comparatively lower performance. The ablation analysis of FIG. 3C demonstrates that conditioning the conditional variational autoencoder modules on the recording source descriptor together with Kullback Leibler divergence regularization and batch normalization are individually necessary architectural components. Removal of conditioning on the recording source descriptor results in a substantial reduction in classification performance across both datasets, confirming that the recording source descriptor enables the system for classifying neurons to factor out variation attributable to recording platform differences.

The full model evaluated in FIG. 3C incorporates a two phase training strategy. During a first phase, the one or more processors pretrain the one or more conditional variational autoencoders by self supervised learning on a plurality of electrophysiological datasets with class label embeddings masked to zero while conditioning on a recording source covariate. The labeled target dataset is excluded from the plurality of electrophysiological datasets in a leave one dataset out configuration. During a second phase, the one or more processors fine tune the conditional variational autoencoders by supervised learning on the labeled target dataset with class labels provided. During fine tuning, each mini batch of training data is sampled to contain an equal proportion of each class label, and a learning rate for fine tuning is a fraction of a learning rate used during pretraining. The ablation analysis of FIG. 3C confirms that each component of the two phase training strategy contributes to the classification performance of the full model.

FIG. 3D illustrates a comparison of K nearest neighbors classifier and multilayer perceptron classifier performance across latent space dimensionalities for the CellExplorer Cell Type Dataset and the Lisberger Dataset. A left classification head comparison chart 326 depicts the CellExplorer Cell Type Dataset, and a right classification head comparison chart 328 depicts the Lisberger Dataset. Each chart plots accuracy as a function of latent space dimensionality Z, with separate lines for the K nearest neighbors (KNN) classification head and the multilayer perceptron (MLP) classification head.

The left classification head comparison chart 326 for the CellExplorer Cell Type Dataset reveals that the K nearest neighbors classifier consistently outperforms the multilayer perceptron classifier across all latent space dimensionalities evaluated, ranging from approximately Z equals 5 to Z equals 20. The K nearest neighbors classifier achieves accuracy values between approximately 0.71 and 0.75 across latent space dimensionalities, while the multilayer perceptron classifier achieves accuracy values between approximately 0.58 and 0.75. The K nearest neighbors classifier exhibits lower variance across latent space dimensionalities compared to the multilayer perceptron classifier, indicating greater stability of local neighborhood based classification in the multimodal latent embedding generated by the conditional variational autoencoder modules.

The right classification head comparison chart 328 for the Lisberger Dataset reveals that the K nearest neighbors classifier outperforms the multilayer perceptron classifier at lower latent space dimensionalities of approximately Z equals 5 to Z equals 10. At higher latent space dimensionalities of approximately Z equals 15 to Z equals 20, the performance of the K nearest neighbors classifier and the multilayer perceptron classifier converge, with both achieving accuracy values of approximately 0.80 to 0.82.

The classification head comparison of FIG. 3D confirms that the K nearest neighbors classifier is better suited for performing one or more analysis operations on the multimodal latent representations generated by the conditional variational autoencoder modules. The one or more analysis operations comprise performing batch harmonization by applying batch effect correction to the multimodal latent embedding to produce, for each neuron unit, a harmonized latent representation with reduced variation attributable to differences in recording source. The K nearest neighbors classifier classifies each neuron unit into a neuronal category by applying K nearest neighbors classification to the harmonized latent representations based on proximity to labeled reference representations in the harmonized latent representations. The K nearest neighbors classifier uses Euclidean distance to identify nearest neighbors and generates a confidence score for each classification. The confidence score is derived as a proportion of neighboring representations in the harmonized latent representations that share the neuronal category. The superior performance of the K nearest neighbors classifier indicates that the multimodal latent embedding produced by fusing the waveform latent code and the timing latent code generates a feature space where neuron units belonging to the same neuronal category cluster tightly, allowing local distance based classification to outperform global decision boundaries learned by the multilayer perceptron classifier. The neuronal category comprises at least one of a neuronal subtype classification identifying each neuron as belonging to a genetically defined cell type, or an anatomical region classification mapping each neuron to a brain region based on electrophysiological characteristics encoded in the harmonized latent representations. The results of FIG. 3D validate the selection of the K nearest neighbors classifier as the classification head for generating an analysis result characterizing the plurality of neurons.

### Inductive and Transductive Benchmarks for Anatomical Predictions:

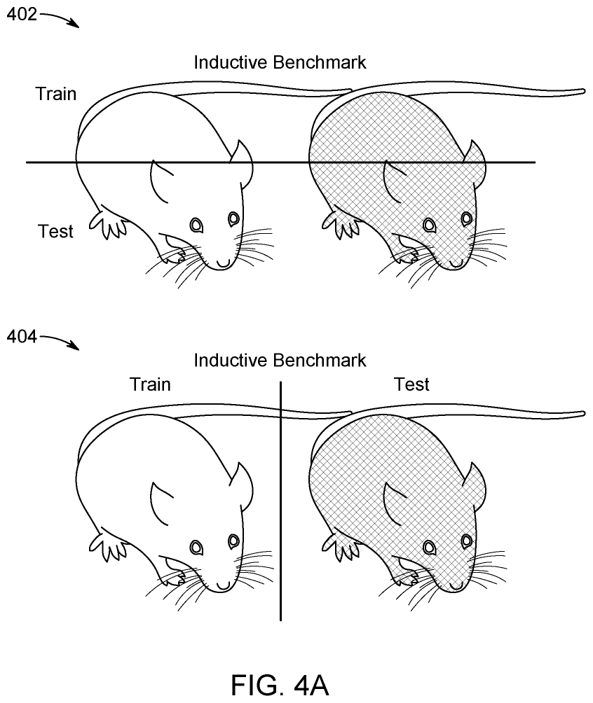

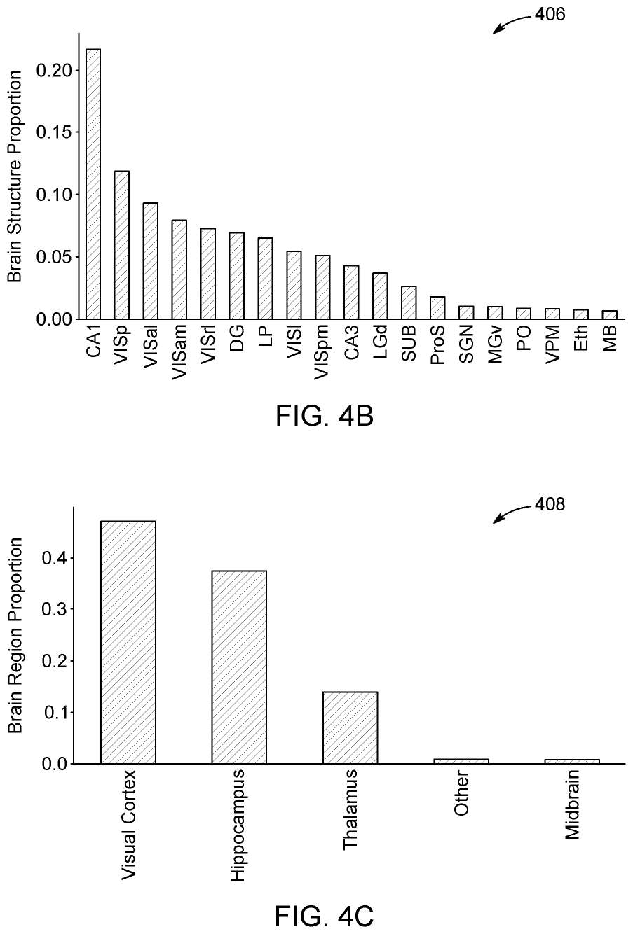

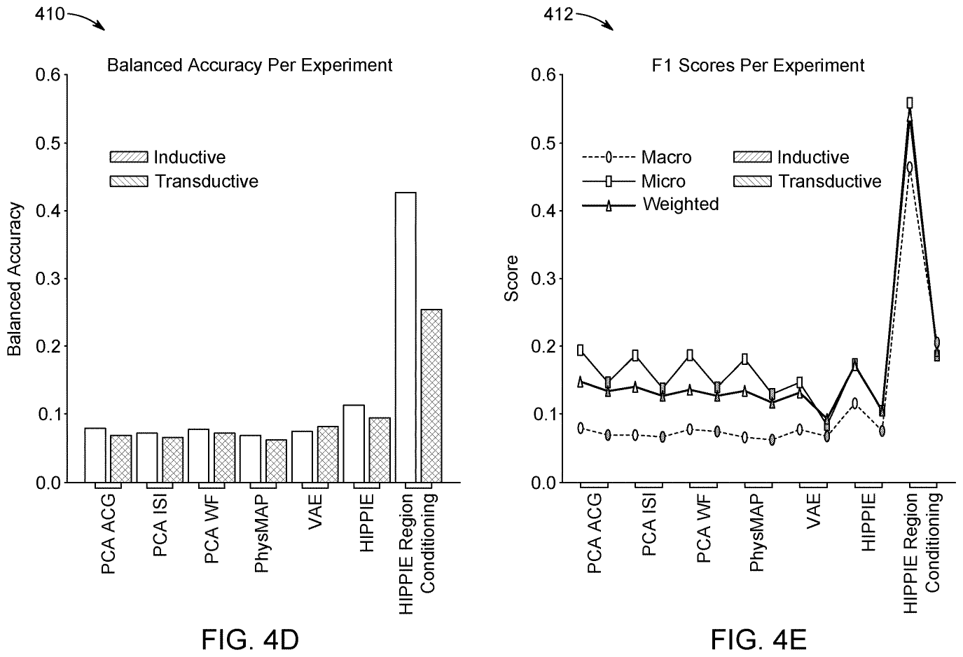

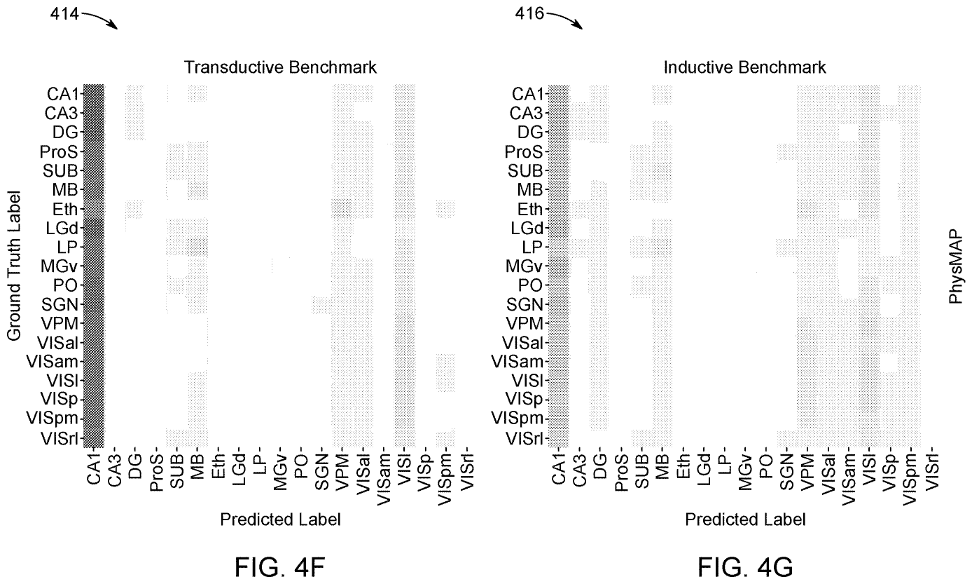

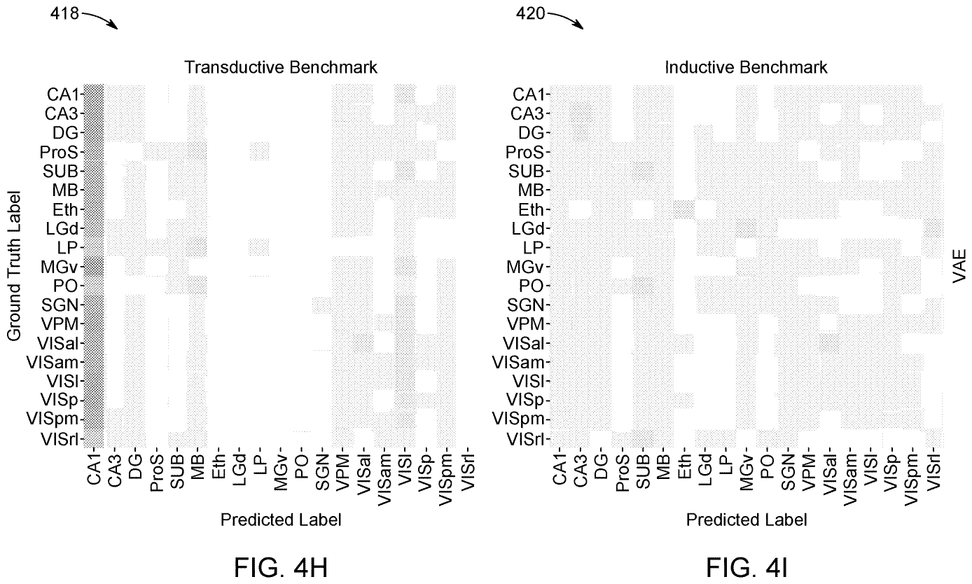

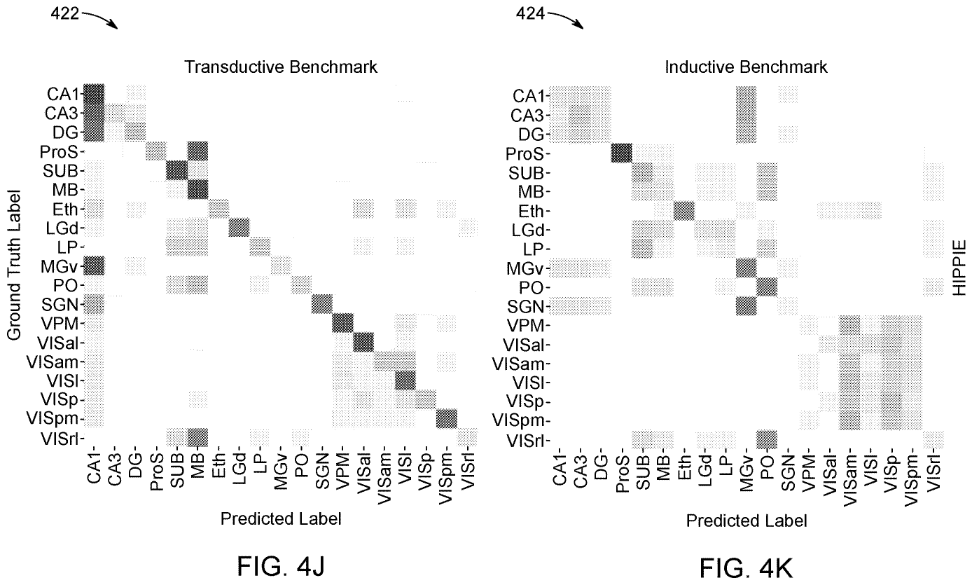

FIG. 4A illustrates a diagram comparing transductive and inductive evaluation paradigms for classifying neurons from extracellular electrophysiological recordings. Conventional classifiers in electrophysiology often employ transductive splits, where neurons from all experimental samples are pooled before partitioning into training and testing sets. While the transductive approach simplifies evaluation, the transductive approach risks inflating performance metrics by allowing models to exploit sample specific artifacts rather than biologically generalizable features. The sample specific artifacts include electrode drift and session specific noise.

A transductive benchmark diagram 402 is shown in the upper portion of FIG. 4A. In the transductive benchmark diagram 402, neurons from all experimental samples are pooled before partitioning into training and testing sets. The transductive benchmark diagram 402 pools extracellular electrophysiological recordings captured by at least one recording device from multiple animals into a combined dataset. The combined dataset is then split into a training set and a testing set. The training set and the testing set each contain neurons from all animals. A horizontal line separates the training portion above from the testing portion below, indicating that neurons from each animal appear in both the training set and the testing set.

An inductive benchmark diagram 404 is shown in the lower portion of FIG. 4A. In contrast to the transductive benchmark, the inductive benchmark diagram 404 enforces strict separation between training samples and testing samples, mimicking real world scenarios where models must generalize to entirely unseen experimental preparations. The inductive benchmark diagram 404 uses extracellular electrophysiological recordings from one set of animals for training. The inductive benchmark diagram 404 uses extracellular electrophysiological recordings from a different set of animals for testing. A vertical line separates the training animals on the left from the testing animals on the right. Inductive evaluation represents a critical benchmark for robustness in neuroscience, where variability in recording conditions remains a persistent challenge. The variability in recording conditions includes electrode placement and animal to animal differences. The inductive benchmark diagram 404 evaluates whether the system for classifying neurons using conditional variational autoencoders can disentangle invariant neuronal properties from experimental noise.

FIG. 4B illustrates the proportion of neurons per brain structure and per brain region in the Allen Brain Institute Visual Coding dataset. The Allen Brain Institute Visual Coding dataset is the largest publicly available repository of in vivo Neuropixel 1.0 recordings from the mouse brain. The Allen Brain Institute Visual Coding dataset comprises extracellular electrophysiological recordings captured by a recording device of the Neuropixels 1.0 probe recording technology type from multiple anatomically defined brain areas collected from adult mice. Each recording is associated with a recording source descriptor comprising at least one of a recording technology type identifying a type of recording device used to capture the electrophysiological recording, or a brain region identifier identifying an anatomical region from which the recording was obtained.

An upper bar chart 406 of FIG. 4B displays brain structure proportion on the vertical axis and individual brain structures on the horizontal axis. The brain structures are arranged in descending order of proportion. CA1 comprises the highest proportion at approximately 0.22. The remaining brain structures include the primary visual area (VISp), anterolateral visual area (VISal), anteromedial visual area (VISam), rostrolateral visual area (VISrl), dentate gyrus (DG), lateral posterior nucleus (LP), lateral visual area (VISI), posteromedial visual area (VISpm), CA3, dorsal lateral geniculate (LGd), subiculum (SUB), prosubiculum (ProS), suprageniculate nucleus (SGN), ventral medial geniculate (MGv), posterior complex (PO), ventral posteromedial nucleus (VPM), ethmoid nucleus (Eth), and midbrain (MB). The brain structure proportion bar chart 406 provides context for the class distribution across individual brain structures and informs interpretation of classification performance metrics.

A lower bar chart 408 of FIG. 4B displays brain region proportion on the vertical axis and aggregated brain regions on the horizontal axis. The aggregated brain regions include Visual Cortex at approximately 0.46, Hippocampus at approximately 0.38, Thalamus at approximately 0.14, Other at less than 0.02, and Midbrain at less than 0.02. The brain region proportion bar chart 408 reveals that Visual Cortex and Hippocampus together account for approximately 84 percent of the neurons in the dataset. The brain region proportion bar chart 408 contextualizes the imbalanced distribution across anatomical regions and informs interpretation of balanced accuracy and F1 score metrics in FIG. 4C.

FIG. 4C illustrates balanced accuracy and F1 scores per experiment comparing classification performance of different dimensionality reduction and classification methods under both transductive and inductive benchmark evaluations. A left balanced accuracy chart 410 displays balanced accuracy per experiment. A right F1 score chart 412 displays F1 scores per experiment. Both charts compare performance across seven methods under inductive evaluation and transductive evaluation.

The left balanced accuracy chart 410 depicts balanced accuracy on the vertical axis ranging from 0 to 0.6 and the methods evaluated on the horizontal axis. The methods evaluated include principal component analysis applied to autocorrelogram feature (PCA ACG), principal component analysis applied to interspike interval feature (PCA ISI), principal component analysis applied to waveform feature (PCA WF), PhysMAP, a standalone variational autoencoder (VAE), the system for classifying neurons using conditional variational autoencoders (HIPPIE), and the system for classifying neurons using conditional variational autoencoders with brain region conditioning (HIPPIE region conditioning). For each method, the balanced accuracy chart 410 displays an inductive bar and a transductive bar.

The balanced accuracy chart 410 reveals that the system for classifying neurons using conditional variational autoencoders with brain region conditioning achieves the highest balanced accuracy under both evaluation paradigms. Under transductive evaluation, HIPPIE region conditioning achieves a balanced accuracy of approximately 0.43. Under inductive evaluation, HIPPIE region conditioning achieves a balanced accuracy of approximately 0.25. The system for classifying neurons using conditional variational autoencoders without brain region conditioning achieves a balanced accuracy of approximately 0.12 under transductive evaluation and approximately 0.09 under inductive evaluation. All baseline methods including PCA ACG, PCA ISI, PCA WF, PhysMAP, and the standalone variational autoencoder achieve balanced accuracy values below 0.10 under both evaluation paradigms. The substantial performance gap between the system for classifying neurons using conditional variational autoencoders and all baseline methods confirms that the conditional variational autoencoder modules conditioned on the recording source descriptor effectively extract anatomically discriminative features from extracellular electrophysiological recordings.

The right F1 score chart 412 depicts F1 scores on the vertical axis ranging from 0 to 0.6 and the same methods on the horizontal axis. The F1 score chart 412 displays Macro F1, Micro F1, and Weighted F1 scores for each method under both inductive and transductive evaluation. The Macro F1 score provides a comprehensive evaluation across all neuronal categories by computing the average F1 score for each anatomical brain region. Under transductive evaluation, HIPPIE region conditioning achieves the highest Macro F1 score at approximately 0.55. Under inductive evaluation, HIPPIE region conditioning achieves the highest scores among all methods. The system for classifying neurons using conditional variational autoencoders without region conditioning achieves Macro F1 scores exceeding 0.4 under transductive evaluation. All baseline methods achieve Macro F1 scores below 0.2 under both evaluation paradigms. The F1 score chart 412 confirms that the system for classifying neurons using conditional variational autoencoders maintains balanced classification performance across all anatomical brain regions rather than achieving accuracy only on majority classes.

The HIPPIE region conditioning variant evaluated in FIG. 4C further demonstrates the benefit of conditioning the conditional variational autoencoders on the recording source descriptor. The recording source descriptor comprises at least one of a recording technology type identifying a type of recording device used to capture the electrophysiological recording, or a brain region identifier identifying an anatomical region from which the recording was obtained. The one or more processors pretrain the one or more conditional variational autoencoders by self supervised learning on a plurality of electrophysiological datasets with class label embeddings masked to zero while conditioning on a recording source covariate. The labeled target dataset is excluded from the plurality of electrophysiological datasets in a leave one dataset out configuration. The one or more processors subsequently fine tune the conditional variational autoencoders by supervised learning on the labeled target dataset with class labels provided. During fine tuning, each mini batch of training data is sampled to contain an equal proportion of each class label, and a learning rate for fine tuning is a fraction of a learning rate used during pretraining. The HIPPIE region conditioning results confirm that incorporating the brain region identifier within the recording source descriptor produces a substantial improvement in balanced accuracy compared to the system for classifying neurons without brain region conditioning.

FIG. 4D illustrates confusion matrices comparing neuronal category classification performance of PhysMAP, a standalone variational autoencoder (VAE), and the system for classifying neurons using conditional variational autoencoders (HIPPIE) under both transductive and inductive benchmark evaluations. A left column 414 of FIG. 4D depicts transductive benchmark confusion matrices. A right column 416 of FIG. 4D depicts inductive benchmark confusion matrices. For each confusion matrix, the vertical axis represents the ground truth label corresponding to the actual anatomical brain region and the horizontal axis represents the predicted label corresponding to the predicted anatomical brain region.

The brain regions listed on both axes of the confusion matrices include CA1, CA3, dentate gyrus (DG), prosubiculum (ProS), subiculum (SUB), midbrain (MB), ethmoid nucleus (Eth), dorsal lateral geniculate (LGd), lateral posterior nucleus (LP), ventral medial geniculate (MGv), posterior complex (PO), suprageniculate nucleus (SGN), ventral posteromedial nucleus (VPM), anterolateral visual area (VISal), anteromedial visual area (VISam), lateral visual area (VISI), primary visual area (VISp), posteromedial visual area (VISpm), and rostrolateral visual area (VISrl).

A top row of FIG. 4D depicts confusion matrices for PhysMAP. The transductive PhysMAP confusion matrix in the left column 414 shows values spread across the entire matrix rather than concentrated along the diagonal. The inductive PhysMAP confusion matrix in the right column 416 shows a similar pattern of values spread across the matrix. The spread values indicate poor classification performance. PhysMAP fails to correctly classify neurons into anatomical brain regions under both transductive and inductive evaluations. PhysMAP relies on dataset specific confounders and exhibits inability to extract anatomically discriminative features from extracellular electrophysiological recordings.

A middle row of FIG. 4D depicts confusion matrices for the standalone variational autoencoder (VAE). The transductive VAE confusion matrix in the left column 414 shows values spread across the matrix with no discernible diagonal pattern. The inductive VAE confusion matrix in the right column 416 shows a similar spread pattern. The standalone variational autoencoder, which is not conditioned on the recording source descriptor and does not employ the two phase training strategy of self supervised learning followed by supervised learning, fails to achieve meaningful classification performance under both evaluation paradigms. The performance of the standalone variational autoencoder confirms that conditioning the conditional variational autoencoders on the recording source descriptor is a critical architectural component, consistent with the ablation analysis depicted in FIG. 3C.

A bottom row of FIG. 4D depicts confusion matrices for the system for classifying neurons using conditional variational autoencoders (HIPPIE). The transductive HIPPIE confusion matrix in the left column 414 displays a strong diagonal pattern with high values along the diagonal and low values off the diagonal. The strong diagonal pattern indicates high classification accuracy across the anatomical brain regions. The system for classifying neurons correctly maps neurons to brain regions based on electrophysiological characteristics encoded in the harmonized latent representations. The conditional variational autoencoders conditioned on the recording source descriptor effectively extract anatomically discriminative features from the waveform feature, the interspike interval feature, and the autocorrelogram feature.

The inductive HIPPIE confusion matrix in the right column 416 displays a diagonal pattern that remains prominent even under inductive evaluation where strict separation is enforced between training animals and testing animals. The harmonized latent representations exhibit reduced variation attributable to differences in recording source. The reduced variation is produced by performing batch harmonization by applying batch effect correction to the multimodal latent embedding. The K nearest neighbors classifier classifies each neuron unit into a neuronal category by applying K nearest neighbors classification to the harmonized latent representations based on proximity to labeled reference representations. The K nearest neighbors classifier uses Euclidean distance to identify nearest neighbors and generates a confidence score for each classification derived as a proportion of neighboring representations in the harmonized latent representations that share the neuronal category.

The comparison across the three rows of FIG. 4D demonstrates that the system for classifying neurons using conditional variational autoencoders achieves robust cross sample generalization in anatomical classification. Both PhysMAP and the standalone variational autoencoder fail to produce meaningful classification under either evaluation paradigm. The system for classifying neurons produces multimodal latent representations by fusing the waveform latent code and the timing latent code to produce a multimodal latent embedding for each neuron. The one or more analysis operations performed on the multimodal latent representations generate an analysis result characterizing the plurality of neurons. The neuronal category comprises at least one of a neuronal subtype classification identifying each neuron as belonging to a genetically defined cell type, or an anatomical region classification mapping each neuron to a brain region based on electrophysiological characteristics encoded in the harmonized latent representations. The results of FIG. 4D establish that the system for classifying neurons is capable of generalizing across distinct experimental preparations while maintaining high anatomical resolution.

### Biomodal Benchmarks:

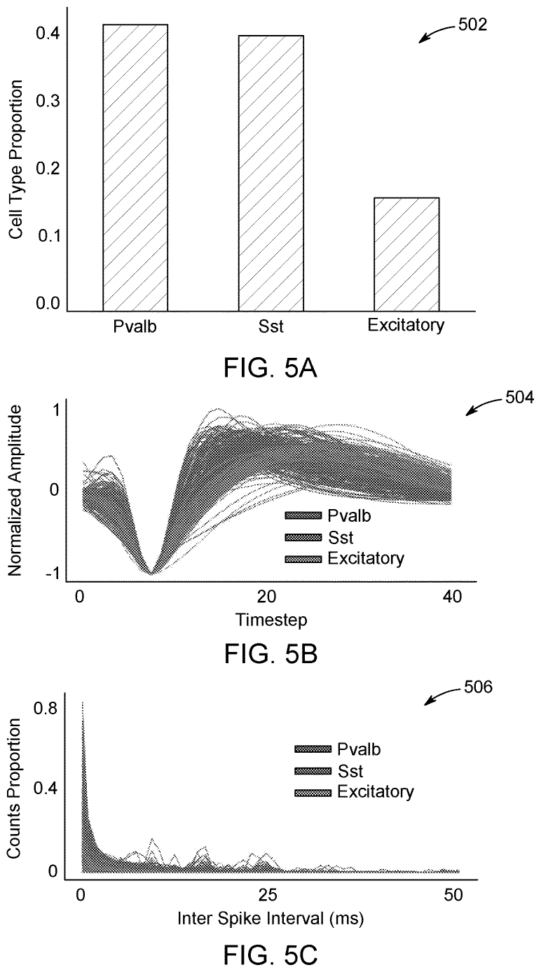

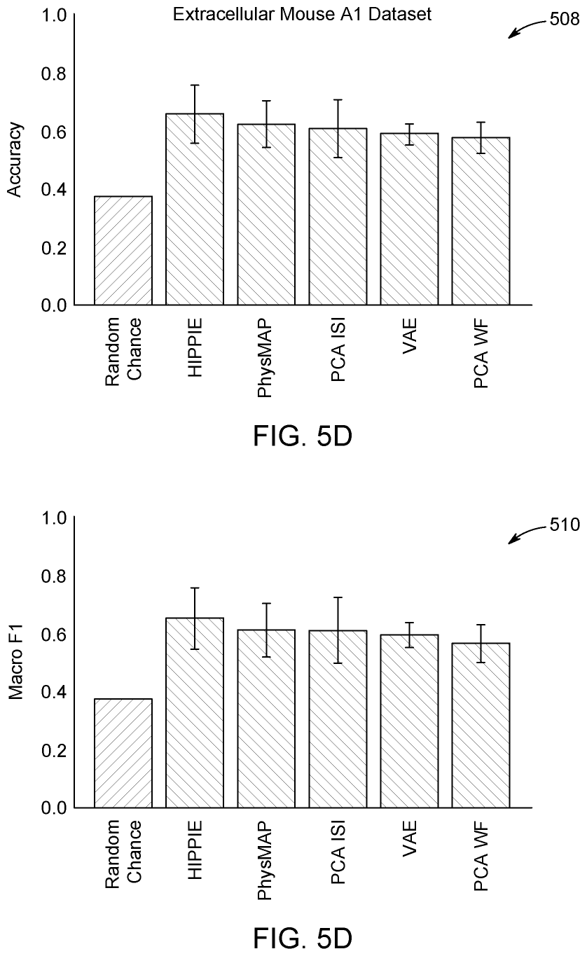

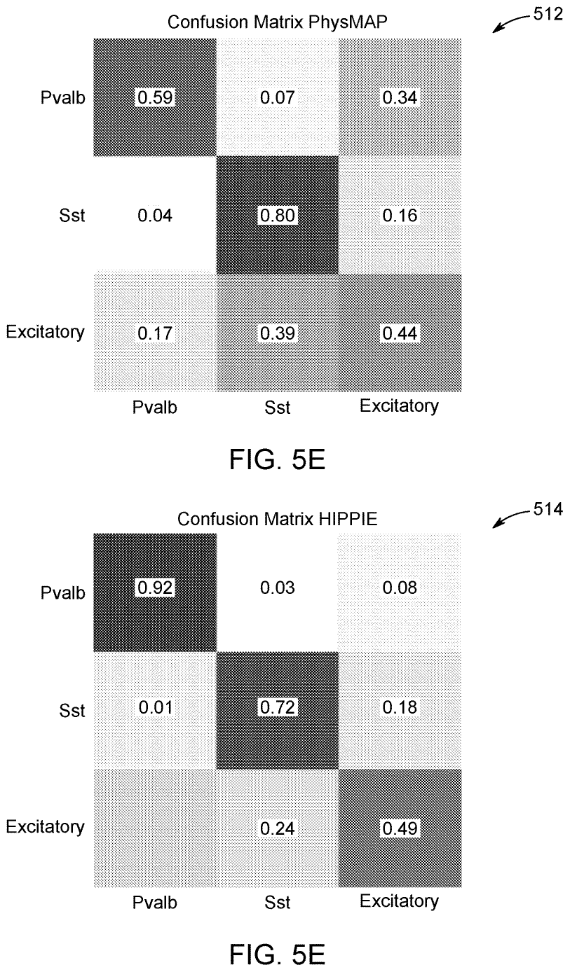

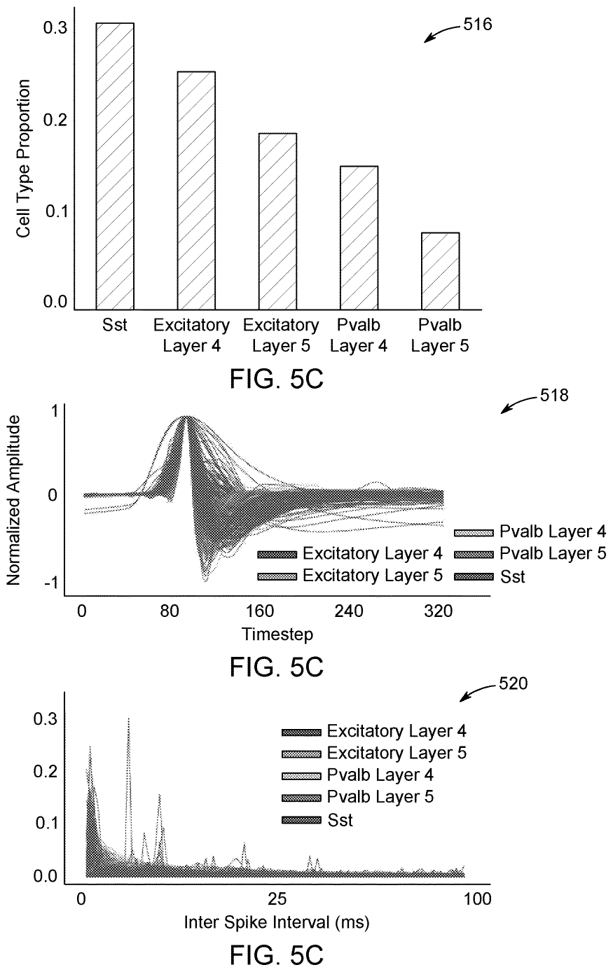

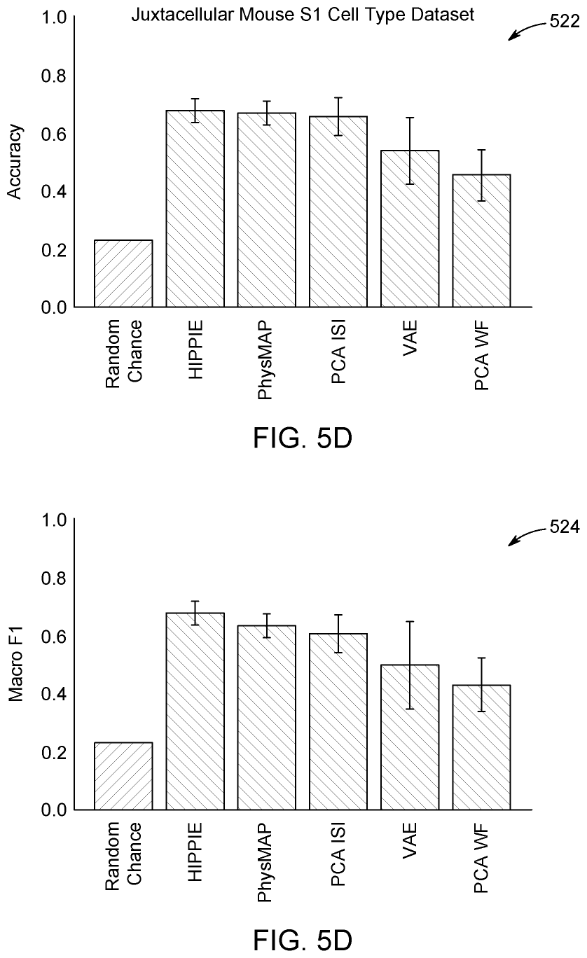

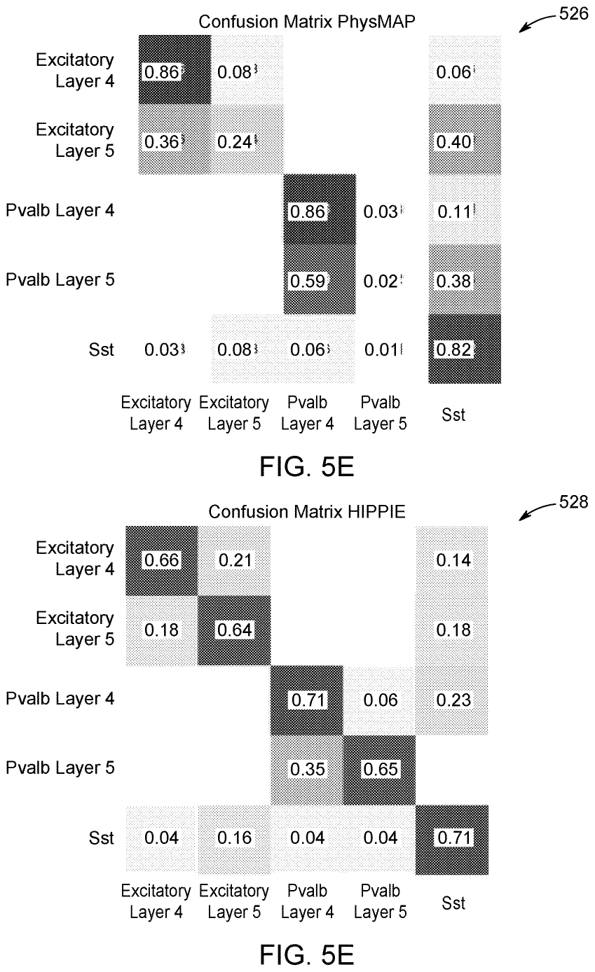

FIG. 5A illustrates feature distributions per neuronal category, neuronal category proportions, classification benchmark comparisons, and confusion matrices for the Extracellular Mouse A1 Dataset. The Extracellular Mouse A1 Dataset comprises extracellular electrophysiological recordings captured by a recording device from the auditory cortex of the mouse brain. Each recording is associated with a recording source descriptor comprising at least one of a recording technology type identifying a type of recording device used to capture the electrophysiological recording, or a brain region identifier identifying an anatomical region from which the recording was obtained. The Extracellular Mouse A1 Dataset contains three neuronal categories: parvalbumin positive interneurons (Pvalb), somatostatin positive interneurons (Sst), and excitatory neurons (Excitatory).

A cell type proportion bar chart 502 displays the proportion of neuron units belonging to each neuronal category within the Extracellular Mouse A1 Dataset. The vertical axis lists the three neuronal categories and the horizontal axis represents cell type proportion. Parvalbumin positive interneurons (Pvalb) constitute the largest proportion, followed by somatostatin positive interneurons (Sst). Excitatory neurons constitute a smaller proportion relative to the two inhibitory neuronal categories. The bar chart 502 establishes the class distribution of the Extracellular Mouse A1 Dataset and provides context for the classification benchmark results.

A mean waveform feature plot 508 displays normalized amplitude as a function of timestep for the three neuronal categories in the Extracellular Mouse A1 Dataset. Each trace represents a normalized mean extracellular waveform computed by averaging spike triggered voltage traces across a plurality of detected action potentials for each neuron. The waveform feature represents a shape of an extracellular action potential of the neuron. Each normalized mean extracellular waveform comprises a one dimensional vector of data points sampled within a time window at a sampling rate sufficient to resolve the extracellular action potential morphology. The mean waveform feature traces reveal distinct waveform shapes among the three neuronal categories. Parvalbumin positive interneurons exhibit narrow waveform morphologies, while excitatory neurons exhibit broader waveform shapes.

A mean interspike interval feature distribution plot 510 displays counts proportion as a function of inter spike interval in milliseconds for the three neuronal categories in the Extracellular Mouse A1 Dataset. The interspike interval feature represents a temporal distribution of intervals between successive action potentials of each of the plurality of neurons. Each interspike interval feature distribution comprises a histogram of intervals between consecutive spikes binned at a predetermined temporal resolution. Each interspike interval feature is represented as a one dimensional vector. The mean interspike interval feature distributions reveal distinct temporal firing dynamics among the three neuronal categories.

An accuracy benchmark bar chart 504 displays classification accuracy on the horizontal axis and the methods evaluated on the vertical axis for the Extracellular Mouse A1 Dataset. The methods evaluated include a random chance baseline, the system for classifying neurons using conditional variational autoencoders (HIPPIE), PhysMAP, a standalone variational autoencoder (VAE), principal component analysis applied to interspike interval feature (PCA ISI), and principal component analysis applied to waveform feature (PCA WF). Classification performance is assessed using a K nearest neighbors classifier. The system for classifying neurons using conditional variational autoencoders achieves the highest classification accuracy among all methods evaluated for the Extracellular Mouse A1 Dataset. The baseline methods including PhysMAP, the standalone variational autoencoder, and principal component analysis achieve lower classification accuracy compared to the system for classifying neurons.

A Macro F1 benchmark bar chart 512 displays Macro F1 score on the horizontal axis and the same methods on the vertical axis for the Extracellular Mouse A1 Dataset. The Macro F1 score provides a comprehensive evaluation across all neuronal categories by computing the average F1 score for each neuronal category. The system for classifying neurons using conditional variational autoencoders achieves the highest Macro F1 score among all methods. The high Macro F1 score demonstrates balanced classification performance across the three neuronal categories rather than achieving accuracy only on majority classes. The baseline methods achieve substantially lower Macro F1 scores.

A confusion matrix for PhysMAP 506 displays classification results for the three neuronal categories of the Extracellular Mouse A1 Dataset. The vertical axis represents the ground truth label and the horizontal axis represents the predicted label. The confusion matrix 506 for PhysMAP shows values distributed across both diagonal and off diagonal cells. PhysMAP achieves a high diagonal value of approximately 0.80 for parvalbumin positive interneurons (Pvalb) but achieves a moderate diagonal value of approximately 0.59 for excitatory neurons and a lower diagonal value of approximately 0.44 for somatostatin positive interneurons (Sst). The largest off diagonal value of approximately 0.34 appears in the cell corresponding to somatostatin positive interneurons misclassified as excitatory neurons, indicating that PhysMAP frequently confuses somatostatin positive interneurons with excitatory neurons. The confusion matrix 506 demonstrates that PhysMAP fails to achieve balanced classification across all neuronal categories in the Extracellular Mouse A1 Dataset.

A confusion matrix for the system for classifying neurons using conditional variational autoencoders (HIPPIE) 514 displays classification results for the three neuronal categories of the Extracellular Mouse A1 Dataset. The confusion matrix 514 displays stronger overall diagonal values compared to the PhysMAP confusion matrix 506, with a diagonal value of approximately 0.88 for excitatory neurons and approximately 0.65 for somatostatin positive interneurons. The system for classifying neurons achieves a substantially higher classification rate for excitatory neurons (0.88 versus 0.59) and somatostatin positive interneurons (0.65 versus 0.44) compared to PhysMAP. The diagonal value for parvalbumin positive interneurons is approximately 0.72, which is slightly lower than the 0.80 achieved by PhysMAP for parvalbumin positive interneurons. However, the higher Macro F1 score achieved by the system for classifying neurons in the Macro F1 benchmark bar chart 512 confirms that the system for classifying neurons achieves more balanced classification performance across all three neuronal categories compared to PhysMAP. The confusion matrix 514 demonstrates that the conditional variational autoencoders conditioned on the recording source descriptor effectively extract features that discriminate among the three neuronal categories. The one or more processors generate the multimodal latent embedding by fusing the waveform latent code and the timing latent code using a mixture module that combines the latent embeddings output by a first conditional variational autoencoder module, a second conditional variational autoencoder module, and a third conditional variational autoencoder module into a joint latent representation. The first conditional variational autoencoder module processes the waveform feature. The second conditional variational autoencoder module processes the interspike interval feature. The third conditional variational autoencoder module processes the autocorrelogram feature. The autocorrelogram feature represents a temporal autocorrelation function computed from the action potential spike train of the neuron. Each of the first conditional variational autoencoder module, the second conditional variational autoencoder module, and the third conditional variational autoencoder module comprises a one dimensional residual network encoder and a one dimensional residual network decoder.

FIG. 5B illustrates feature distributions per neuronal category, neuronal category proportions, classification benchmark comparisons, and confusion matrices for the Juxtacellular Mouse S1 Cell Type Dataset. The Juxtacellular Mouse S1 Cell Type Dataset comprises extracellular electrophysiological recordings captured by a recording device using juxtacellular recording technique from the primary somatosensory cortex of the mouse brain. The juxtacellular recording technique represents a different recording technology type compared to the extracellular recording technology used in the Extracellular Mouse A1 Dataset. The recording source descriptor for the Juxtacellular Mouse S1 Cell Type Dataset reflects the juxtacellular recording technology type. The Juxtacellular Mouse S1 Cell Type Dataset contains five neuronal categories: somatostatin positive interneurons (Sst), excitatory neurons in layer 4 (Excitatory Layer 4), excitatory neurons in layer 5 (Excitatory Layer 5), parvalbumin positive interneurons in layer 4 (Pvalb Layer 4), and parvalbumin positive interneurons in layer 5 (Pvalb Layer 5).

A cell type proportion bar chart 516 displays the proportion of neuron units belonging to each neuronal category within the Juxtacellular Mouse S1 Cell Type Dataset. The vertical axis lists the five neuronal categories and the horizontal axis represents cell type proportion. The bar chart 516 reveals that somatostatin positive interneurons (Sst) constitute the largest proportion at approximately 0.30, followed by excitatory neurons in layer 4 at approximately 0.25, excitatory neurons in layer 5 at approximately 0.20, parvalbumin positive interneurons in layer 4 at approximately 0.15, and parvalbumin positive interneurons in layer 5 at approximately 0.10. The bar chart 516 establishes the class distribution of the Juxtacellular Mouse S1 Cell Type Dataset and provides context for the classification benchmark results.

A mean waveform feature plot 524 displays normalized amplitude as a function of timestep for the five neuronal categories in the Juxtacellular Mouse S1 Cell Type Dataset. The timestep axis extends to approximately 320 timesteps, which is approximately eight times the timestep range of the mean waveform feature plot 508 of the Extracellular Mouse A1 Dataset, reflecting the longer temporal window captured by the juxtacellular recording technique. Each trace represents a normalized mean extracellular waveform computed by averaging spike triggered voltage traces across a plurality of detected action potentials for each neuron. The waveform feature traces captured by the juxtacellular recording technique exhibit distinct morphological characteristics compared to the extracellular waveform traces depicted in FIG. 5A. The waveform feature traces for the five neuronal categories show partial overlap in morphology, reflecting the finer grained classification task of discriminating layer specific subtypes of excitatory neurons and parvalbumin positive interneurons. The waveform feature represents a shape of an extracellular action potential of the neuron.

A mean interspike interval feature distribution plot 526 displays counts proportion as a function of inter spike interval in milliseconds for the five neuronal categories in the Juxtacellular Mouse S1 Cell Type Dataset. The inter spike interval axis extends to approximately 100 milliseconds, which is approximately twice the range of the mean interspike interval feature distribution plot 510 of the Extracellular Mouse A1 Dataset. The interspike interval feature represents a temporal distribution of intervals between successive action potentials of each of the plurality of neurons. Each interspike interval feature distribution comprises a histogram of intervals between consecutive spikes binned at a predetermined temporal resolution. The mean interspike interval feature distributions reveal temporal firing dynamics for the five neuronal categories captured by the juxtacellular recording technique.

An accuracy benchmark bar chart 518 displays classification accuracy on the horizontal axis and the methods evaluated on the vertical axis for the Juxtacellular Mouse S1 Cell Type Dataset. The methods evaluated include a random chance baseline, the system for classifying neurons using conditional variational autoencoders (HIPPIE), PhysMAP, a standalone variational autoencoder (VAE), principal component analysis applied to interspike interval feature (PCA ISI), and principal component analysis applied to waveform feature (PCA WF). The system for classifying neurons using conditional variational autoencoders achieves the highest classification accuracy among all methods evaluated for the Juxtacellular Mouse S1 Cell Type Dataset. The baseline methods achieve lower classification accuracy. The five category classification task of the Juxtacellular Mouse S1 Cell Type Dataset is more challenging than the three category task of the Extracellular Mouse A1 Dataset due to the requirement to discriminate layer specific neuronal subtypes within the same broad cell class.

A Macro F1 benchmark bar chart 528 displays Macro F1 score on the horizontal axis and the same methods on the vertical axis for the Juxtacellular Mouse S1 Cell Type Dataset. The system for classifying neurons using conditional variational autoencoders achieves the highest Macro F1 score among all methods. The high Macro F1 score confirms balanced classification performance across all five neuronal categories. The baseline methods achieve substantially lower Macro F1 scores for the Juxtacellular Mouse S1 Cell Type Dataset.

A confusion matrix for PhysMAP 520 displays classification results for the five neuronal categories of the Juxtacellular Mouse S1 Cell Type Dataset. The vertical axis represents the ground truth label and the horizontal axis represents the predicted label. The confusion matrix 520 for PhysMAP shows values spread across the entire matrix rather than concentrated along the diagonal. The diagonal values for PhysMAP range from approximately 0.01 to 0.48 across the five neuronal categories. PhysMAP fails to reliably discriminate among the five neuronal categories in the Juxtacellular Mouse S1 Cell Type Dataset. The off diagonal confusion is particularly pronounced between excitatory neurons in layer 4, excitatory neurons in layer 5, parvalbumin positive interneurons in layer 4, and parvalbumin positive interneurons in layer 5.

A confusion matrix for the system for classifying neurons using conditional variational autoencoders (HIPPIE) 530 displays classification results for the five neuronal categories of the Juxtacellular Mouse S1 Cell Type Dataset. The confusion matrix 530 displays stronger diagonal values compared to the PhysMAP confusion matrix 520, with diagonal values exceeding 0.60 for multiple neuronal categories. The system for classifying neurons achieves substantially higher classification accuracy for excitatory neurons in layer 4, excitatory neurons in layer 5, parvalbumin positive interneurons in layer 4, parvalbumin positive interneurons in layer 5, and somatostatin positive interneurons compared to PhysMAP. Moderate off diagonal confusion remains between layer 4 and layer 5 subtypes within the same broad cell class, consistent with the biological similarity of neurons differing primarily in laminar position. The confusion matrix 530 demonstrates that the conditional variational autoencoders conditioned on the recording source descriptor enable discrimination of layer specific neuronal subtypes within the Juxtacellular Mouse S1 Cell Type Dataset.

The comparison between FIG. 5A and FIG. 5B demonstrates that the system for classifying neurons using conditional variational autoencoders achieves robust classification performance across datasets captured by different recording technology types and targeting different brain regions. The system for classifying neurons produces multimodal latent representations by fusing the waveform latent code and the timing latent code to produce the multimodal latent embedding. The one or more analysis operations performed on the multimodal latent representations comprise performing batch harmonization by applying batch effect correction to the multimodal latent embedding to produce, for each neuron unit, a harmonized latent representation with reduced variation attributable to differences in recording source. The K nearest neighbors classifier classifies each neuron unit into a neuronal category by applying K nearest neighbors classification to the harmonized latent representations based on proximity to labeled reference representations. The K nearest neighbors classifier uses Euclidean distance to identify nearest neighbors and generates a confidence score for each classification derived as a proportion of neighboring representations in the harmonized latent representations that share the neuronal category. The neuronal category comprises at least one of a neuronal subtype classification identifying each neuron as belonging to a genetically defined cell type, or an anatomical region classification mapping each neuron to a brain region based on electrophysiological characteristics encoded in the harmonized latent representations. The results generate an analysis result characterizing the plurality of neurons across the two datasets.

The classification results depicted in FIG. 5A and FIG. 5B are obtained using a two phase training strategy. During a first phase, the one or more processors pretrain the one or more conditional variational autoencoders by self supervised learning on a plurality of electrophysiological datasets with class label embeddings masked to zero while conditioning on a recording source covariate. The labeled target dataset is excluded from the plurality of electrophysiological datasets in a leave one dataset out configuration. During a second phase, the one or more processors fine tune the conditional variational autoencoders by supervised learning on the labeled target dataset with class labels provided. During fine tuning, each mini batch of training data is sampled to contain an equal proportion of each class label, and a learning rate for fine tuning is a fraction of a learning rate used during pretraining. The robust performance of the system for classifying neurons across the Extracellular Mouse A1 Dataset and the Juxtacellular Mouse S1 Cell Type Dataset confirms that conditioning on the recording source descriptor enables the conditional variational autoencoders to factor out variation attributable to recording platform differences while preserving biologically discriminative features in the multimodal latent embedding.

### Trimodal Benchmark:

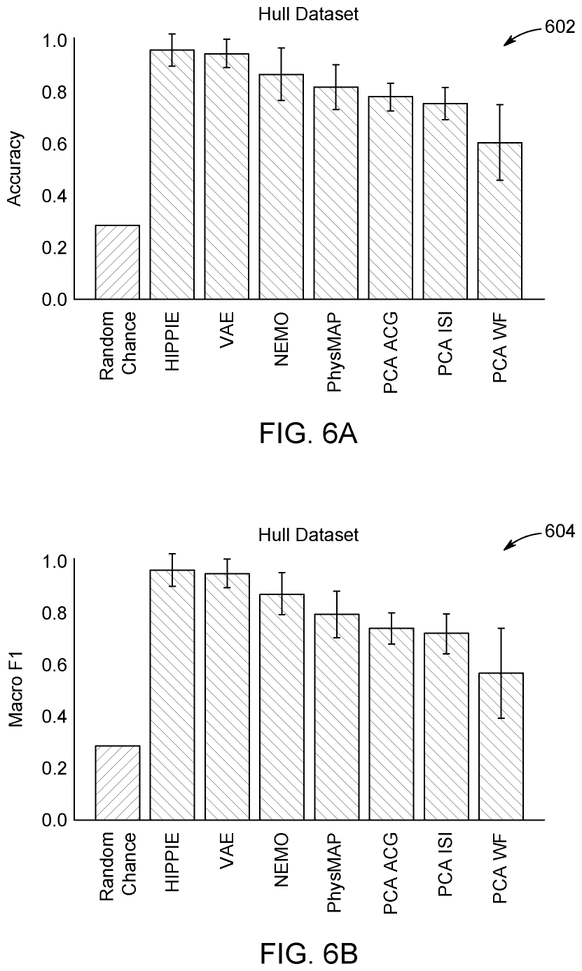

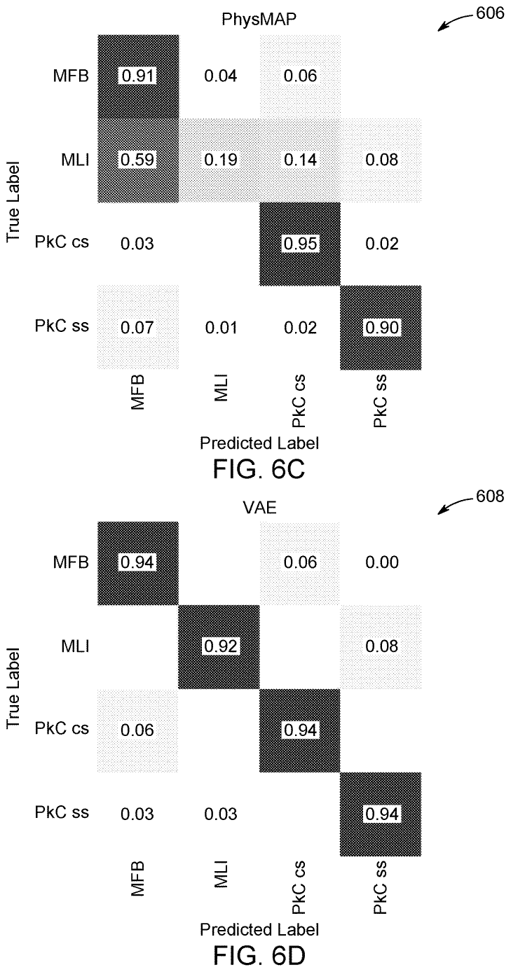

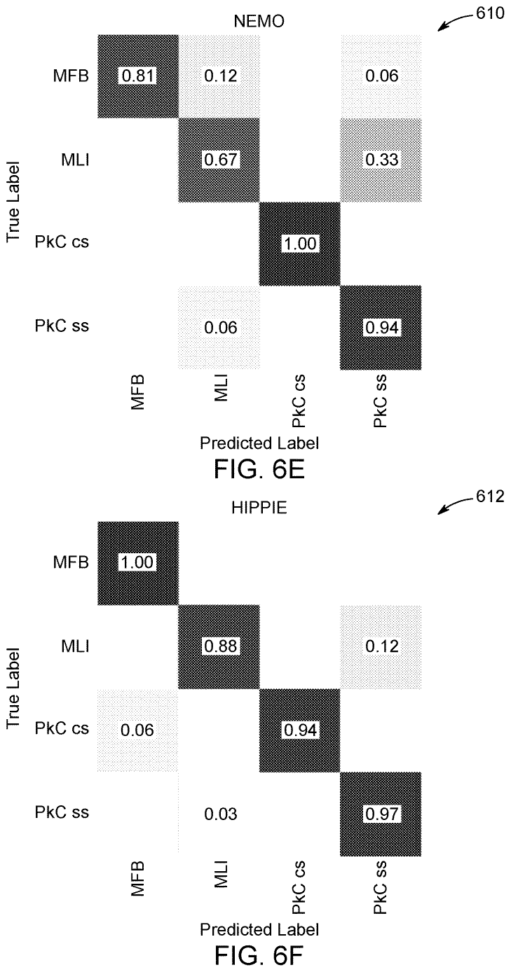

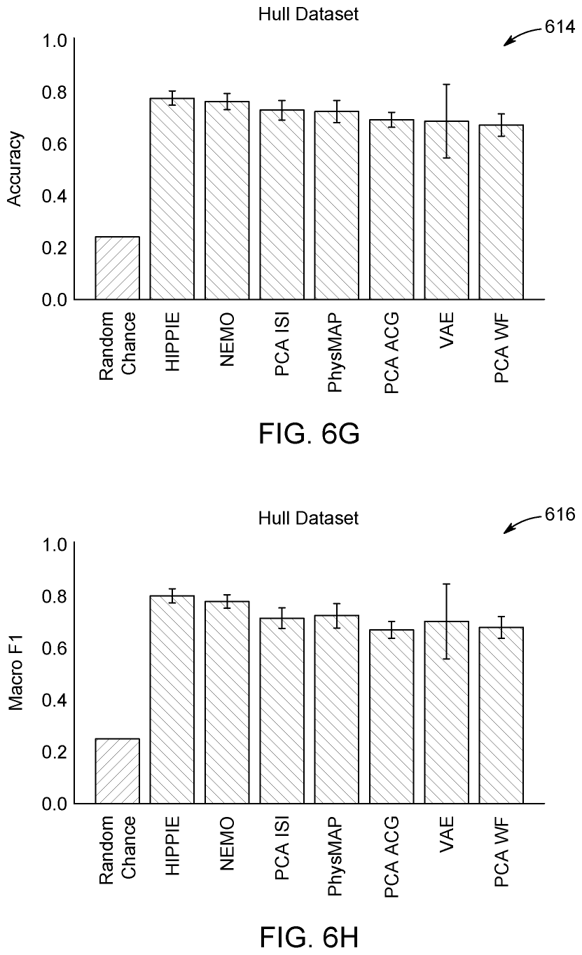

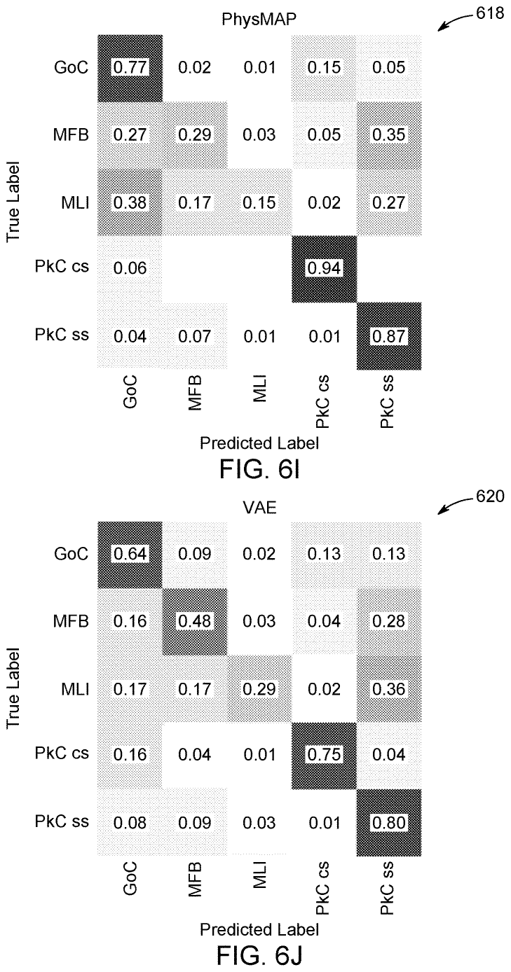

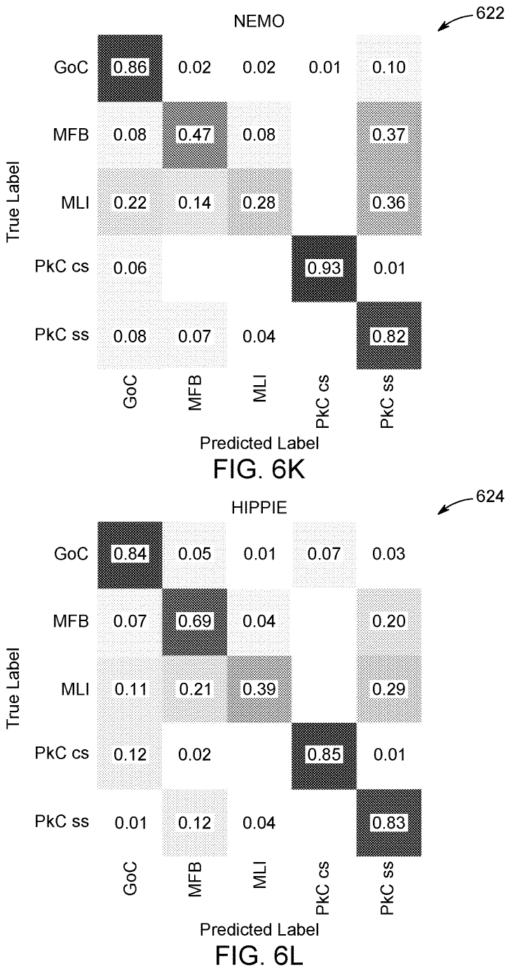

FIG. 6A through FIG. 6D illustrate trimodal benchmark results comparing classification performance of the system for classifying neurons using conditional variational autoencoders against baseline dimensionality reduction and classification methods. The trimodal benchmark evaluates the full architecture of the system for classifying neurons, in which a first conditional variational autoencoder module processes the waveform feature, a second conditional variational autoencoder module processes the interspike interval feature, and a third conditional variational autoencoder module processes the autocorrelogram feature. The autocorrelogram feature represents a temporal autocorrelation function computed from the action potential spike train of the neuron. A mixture module combines the latent embeddings output by the first conditional variational autoencoder module, the second conditional variational autoencoder module, and the third conditional variational autoencoder module into a joint latent representation. Each of the first conditional variational autoencoder module, the second conditional variational autoencoder module, and the third conditional variational autoencoder module comprises a one dimensional residual network encoder and a one dimensional residual network decoder. The trimodal benchmark is evaluated on the Hull Dataset and the Lisberger Dataset, both comprising extracellular electrophysiological recordings captured by a recording device from cerebellar brain regions.

FIG. 6A illustrates accuracy and F1 score benchmark comparisons for the Hull Dataset. An accuracy benchmark bar chart 602 displays classification accuracy on the horizontal axis ranging from 0 to 1.0 and the methods evaluated on the vertical axis. The methods evaluated include a random chance baseline, the system for classifying neurons using conditional variational autoencoders (HIPPIE), a standalone variational autoencoder (VAE), NEMO, PhysMAP, principal component analysis applied to autocorrelogram feature (PCA ACG), principal component analysis applied to interspike interval feature (PCA ISI), and principal component analysis applied to waveform feature (PCA WF). The Hull Dataset comprises extracellular electrophysiological recordings from cerebellar neurons classified into four neuronal categories: mossy fiber boutons (MFB), molecular layer interneurons (MLI), Purkinje cell complex spikes (PkC cs), and Purkinje cell simple spikes (PkC SS). Each recording is associated with a recording source descriptor comprising at least one of a recording technology type identifying a type of recording device used to capture the electrophysiological recording, or a brain region identifier identifying an anatomical region from which the recording was obtained.

The accuracy benchmark bar chart 602 reveals that the system for classifying neurons using conditional variational autoencoders achieves the highest classification accuracy among all methods evaluated for the Hull Dataset. The system for classifying neurons achieves accuracy exceeding 0.90 for the Hull Dataset. The standalone variational autoencoder (VAE) achieves high accuracy. NEMO and PhysMAP achieve moderate accuracy values. The principal component analysis methods applied to autocorrelogram feature, interspike interval feature, and waveform feature achieve lower accuracy values. All methods substantially exceed the random chance baseline, indicating that all evaluated approaches extract some discriminative information from the extracellular electrophysiological recordings of the Hull Dataset. However, the system for classifying neurons using conditional variational autoencoders achieves the highest accuracy among all methods. Classification performance is assessed using a K nearest neighbors classifier.

An F1 score benchmark bar chart 604 displays F1 score on the horizontal axis ranging from 0 to 1.0 and the same methods on the vertical axis for the Hull Dataset. The F1 score benchmark bar chart 604 reveals that the system for classifying neurons using conditional variational autoencoders achieves the highest F1 score among all methods. The high F1 score confirms balanced classification performance across all four neuronal categories of the Hull Dataset. The standalone variational autoencoder, NEMO, and PhysMAP achieve moderate F1 scores. The principal component analysis methods achieve lower F1 scores compared to the system for classifying neurons.

FIG. 6B illustrates confusion matrices comparing neuronal category classification performance of PhysMAP, the standalone variational autoencoder (VAE), NEMO, and the system for classifying neurons using conditional variational autoencoders (HIPPIE) for the Hull Dataset. The four neuronal categories are mossy fiber boutons (MFB), molecular layer interneurons (MLI), Purkinje cell complex spikes (PkC cs), and Purkinje cell simple spikes (PkC SS). For each confusion matrix, the vertical axis represents the true label corresponding to the actual neuronal category and the horizontal axis represents the predicted label corresponding to the predicted neuronal category.

A confusion matrix for PhysMAP 606 displays classification results for the four neuronal categories of the Hull Dataset. The confusion matrix 606 shows strong diagonal values of approximately 0.91 for mossy fiber boutons (MFB), approximately 0.95 for Purkinje cell complex spikes (PkC cs), and approximately 0.90 for Purkinje cell simple spikes (PkC SS). However, the confusion matrix 606 reveals a substantially lower diagonal value of approximately 0.19 for molecular layer interneurons (MLI), indicating that PhysMAP misclassifies the majority of molecular layer interneurons into other neuronal categories. PhysMAP achieves high accuracy for mossy fiber boutons, Purkinje cell complex spikes, and Purkinje cell simple spikes but fails to reliably discriminate molecular layer interneurons from the remaining cerebellar neuronal categories.

A confusion matrix for the standalone variational autoencoder (VAE) 608 displays classification results for the four neuronal categories. The confusion matrix 608 shows a strong diagonal value of approximately 0.94 for mossy fiber boutons (MFB) and strong values for Purkinje cell complex spikes (PkC cs) and Purkinje cell simple spikes (PkC SS). The standalone variational autoencoder achieves higher diagonal values for Purkinje cell simple spikes compared to PhysMAP. However, the standalone variational autoencoder exhibits off diagonal confusion for molecular layer interneurons, indicating difficulty in discriminating molecular layer interneurons from the remaining cerebellar neuronal categories.

A confusion matrix for NEMO 610 displays classification results for the four neuronal categories. The confusion matrix 610 shows a diagonal value of approximately 0.81 for mossy fiber boutons (MFB) and approximately 0.67 for molecular layer interneurons (MLI). The confusion matrix 610 shows a strong diagonal value of approximately 0.94 for Purkinje cell simple spikes (PkC SS). The diagonal value for Purkinje cell complex spikes (PkC cs) is lower, indicating that NEMO has difficulty discriminating Purkinje cell complex spikes from other neuronal categories. NEMO achieves moderate overall classification performance, with off diagonal confusion distributed among multiple neuronal categories. The off diagonal value of approximately 0.12 for mossy fiber boutons misclassified as molecular layer interneurons indicates partial overlap in the feature representations generated by NEMO for these two neuronal categories.

A confusion matrix for the system for classifying neurons using conditional variational autoencoders (HIPPIE) 612 displays classification results for the four neuronal categories. The confusion matrix 612 displays strong diagonal values across all four neuronal categories, with a diagonal value of approximately 1.00 for mossy fiber boutons (MFB), approximately 0.88 for molecular layer interneurons (MLI), approximately 0.94 for Purkinje cell complex spikes (PkC cs), and approximately 0.87 for Purkinje cell simple spikes (PkC SS). The confusion matrix 612 demonstrates that the system for classifying neurons achieves the most balanced classification performance across all four neuronal categories of the Hull Dataset compared to PhysMAP, the standalone variational autoencoder, and NEMO. The system for classifying neurons achieves the highest diagonal value for molecular layer interneurons (0.88) among all four methods, resolving the primary source of confusion observed in the confusion matrices 606, 608, and 610. The conditional variational autoencoders conditioned on the recording source descriptor effectively extract discriminative features from the waveform feature, the interspike interval feature, and the autocorrelogram feature for all four cerebellar neuronal categories.

FIG. 6C illustrates accuracy and F1 score benchmark comparisons for the Lisberger Dataset. An accuracy benchmark bar chart 614 displays classification accuracy on the horizontal axis ranging from 0 to 1.0 and the methods evaluated on the vertical axis. The methods evaluated include the same set of methods as FIG. 6A: a random chance baseline, the system for classifying neurons using conditional variational autoencoders (HIPPIE), NEMO, principal component analysis applied to interspike interval feature (PCA ISI), PhysMAP, principal component analysis applied to autocorrelogram feature (PCA ACG), the standalone variational autoencoder (VAE), and principal component analysis applied to waveform feature (PCA WF). The Lisberger Dataset comprises extracellular electrophysiological recordings from cerebellar neurons classified into five neuronal categories: Golgi cells (GoC), mossy fiber boutons (MFB), molecular layer interneurons (MLI), Purkinje cell complex spikes (PkC cs), and Purkinje cell simple spikes (PkC SS). The Lisberger Dataset contains one additional neuronal category compared to the Hull Dataset, representing a more challenging classification task.

The accuracy benchmark bar chart 614 reveals that the system for classifying neurons using conditional variational autoencoders achieves the highest classification accuracy among all methods evaluated for the Lisberger Dataset. NEMO and PCA ISI also achieve relatively high accuracy values for the Lisberger Dataset. PhysMAP, PCA ACG, and PCA WF achieve moderate accuracy values. The standalone variational autoencoder (VAE) exhibits wider variance in accuracy as indicated by a longer error bar. All methods substantially exceed the random chance baseline.

An F1 score benchmark bar chart 616 displays F1 score on the horizontal axis ranging from 0 to 1.0 and the same methods on the vertical axis for the Lisberger Dataset. The F1 score benchmark bar chart 616 reveals that the system for classifying neurons using conditional variational autoencoders achieves the highest F1 score among all methods. The high F1 score demonstrates balanced classification performance across all five neuronal categories of the Lisberger Dataset. NEMO achieves a moderate F1 score. The standalone variational autoencoder (VAE) exhibits wider variance as indicated by a longer error bar. The principal component analysis methods and PhysMAP achieve moderate F1 scores for the Lisberger Dataset.

FIG. 6D illustrates confusion matrices comparing neuronal category classification performance of PhysMAP, the standalone variational autoencoder (VAE), NEMO, and the system for classifying neurons using conditional variational autoencoders (HIPPIE) for the Lisberger Dataset. The five neuronal categories are Golgi cells (GoC), mossy fiber boutons (MFB), molecular layer interneurons (MLI), Purkinje cell complex spikes (PkC cs), and Purkinje cell simple spikes (PkC SS). For each confusion matrix, the vertical axis represents the true label corresponding to the actual neuronal category and the horizontal axis represents the predicted label corresponding to the predicted neuronal category.

A confusion matrix for PhysMAP 618 displays classification results for the five neuronal categories of the Lisberger Dataset. The confusion matrix 618 shows strong diagonal values of approximately 0.77 for Golgi cells (GoC) and approximately 0.84 for Purkinje cell complex spikes (PkC cs). Purkinje cell simple spikes (PkC SS) achieve a moderate diagonal value of approximately 0.67. However, the confusion matrix 618 reveals low diagonal values of approximately 0.29 for mossy fiber boutons (MFB) and approximately 0.15 for molecular layer interneurons (MLI). PhysMAP distributes misclassifications for mossy fiber boutons and molecular layer interneurons across multiple neuronal categories, particularly confusing mossy fiber boutons with Golgi cells and molecular layer interneurons with multiple other neuronal categories.

A confusion matrix for the standalone variational autoencoder (VAE) 620 displays classification results for the five neuronal categories. The confusion matrix 620 shows a diagonal value of approximately 0.64 for Golgi cells (GoC) and moderate to high diagonal values for Purkinje cell complex spikes (PkC cs) and Purkinje cell simple spikes (PkC SS). However, the standalone variational autoencoder achieves low diagonal values for mossy fiber boutons (MFB) and molecular layer interneurons (MLI). The standalone variational autoencoder exhibits off diagonal confusion across multiple neuronal categories, particularly between mossy fiber boutons and molecular layer interneurons. The overall classification performance of the standalone variational autoencoder for the Lisberger Dataset is lower than for the Hull Dataset, reflecting the additional complexity introduced by the fifth neuronal category.

A confusion matrix for NEMO 622 displays classification results for the five neuronal categories. The confusion matrix 622 shows strong diagonal values of approximately 0.88 for Golgi cells (GoC) and approximately 0.93 for Purkinje cell complex spikes (PkC cs). NEMO achieves a moderate diagonal value of approximately 0.47 for mossy fiber boutons (MFB) and approximately 0.14 for molecular layer interneurons (MLI). The confusion matrix 622 reveals that NEMO achieves strong classification for Golgi cells and Purkinje cell complex spikes but has difficulty discriminating mossy fiber boutons and molecular layer interneurons in the Lisberger Dataset.

A confusion matrix for the system for classifying neurons using conditional variational autoencoders (HIPPIE) 624 displays classification results for the five neuronal categories. The confusion matrix 624 displays strong diagonal values of approximately 0.84 for Golgi cells (GoC), approximately 0.39 for molecular layer interneurons (MLI), and approximately 0.83 for Purkinje cell simple spikes (PkC SS). However, the confusion matrix 624 reveals lower diagonal values of approximately 0.09 for mossy fiber boutons (MFB) and approximately 0.05 for Purkinje cell complex spikes (PkC cs), indicating that the system for classifying neurons has difficulty discriminating mossy fiber boutons and Purkinje cell complex spikes from other cerebellar neuronal categories within the Lisberger Dataset. Despite the lower per class accuracy for mossy fiber boutons and Purkinje cell complex spikes, the system for classifying neurons achieves the highest overall Macro F1 score among all methods as shown in the F1 score benchmark bar chart 616. The highest Macro F1 score indicates that the system for classifying neurons achieves superior aggregate classification performance across the five neuronal categories of the Lisberger Dataset compared to PhysMAP, the standalone variational autoencoder, and NEMO.

The trimodal benchmark results of FIG. 6A through FIG. 6D confirm that the system for classifying neurons using conditional variational autoencoders achieves the highest classification accuracy and F1 scores across both the Hull Dataset and the Lisberger Dataset when using the full trimodal architecture. The waveform feature represents a shape of an extracellular action potential of the neuron. Each waveform feature comprises a normalized mean extracellular waveform computed by averaging spike triggered voltage traces across a plurality of detected action potentials for each neuron. Each normalized mean extracellular waveform comprises a one dimensional vector of data points sampled within a time window at a sampling rate of at least 20 kilohertz. The interspike interval feature represents a temporal distribution of intervals between successive action potentials of the neuron. Each interspike interval feature comprises a histogram of intervals between consecutive spikes binned at a predetermined temporal resolution. The system for classifying neurons produces multimodal latent representations by fusing the waveform latent code and the timing latent code to produce a multimodal latent embedding for each neuron.

The one or more analysis operations performed on the multimodal latent representations comprise performing batch harmonization by applying batch effect correction to the multimodal latent embedding to produce, for each neuron unit, a harmonized latent representation with reduced variation attributable to differences in recording source. The K nearest neighbors classifier classifies each neuron unit into a neuronal category by applying K nearest neighbors classification to the harmonized latent representations based on proximity to labeled reference representations. The K nearest neighbors classifier uses Euclidean distance to identify nearest neighbors and generates a confidence score for each classification derived as a proportion of neighboring representations in the harmonized latent representations that share the neuronal category. The neuronal category comprises at least one of a neuronal subtype classification identifying each neuron as belonging to a genetically defined cell type, or an anatomical region classification mapping each neuron to a brain region based on electrophysiological characteristics encoded in the harmonized latent representations. The results generate an analysis result characterizing the plurality of neurons.

The classification results depicted in FIG. 6A through FIG. 6D are obtained using a two phase training strategy. During a first phase, the one or more processors pretrain the one or more conditional variational autoencoders by self supervised learning on a plurality of electrophysiological datasets with class label embeddings masked to zero while conditioning on a recording source covariate. The labeled target dataset is excluded from the plurality of electrophysiological datasets in a leave one dataset out configuration. During a second phase, the one or more processors fine tune the conditional variational autoencoders by supervised learning on the labeled target dataset with class labels provided. During fine tuning, each mini batch of training data is sampled to contain an equal proportion of each class label, and a learning rate for fine tuning is a fraction of a learning rate used during pretraining. The trimodal benchmark results establish that the full architecture of the system for classifying neurons, incorporating all three conditional variational autoencoder modules processing the waveform feature, the interspike interval feature, and the autocorrelogram feature, produces superior classification performance on cerebellar neuronal categories compared to all evaluated baseline methods.

### Cross Species Comparison Benchmark:

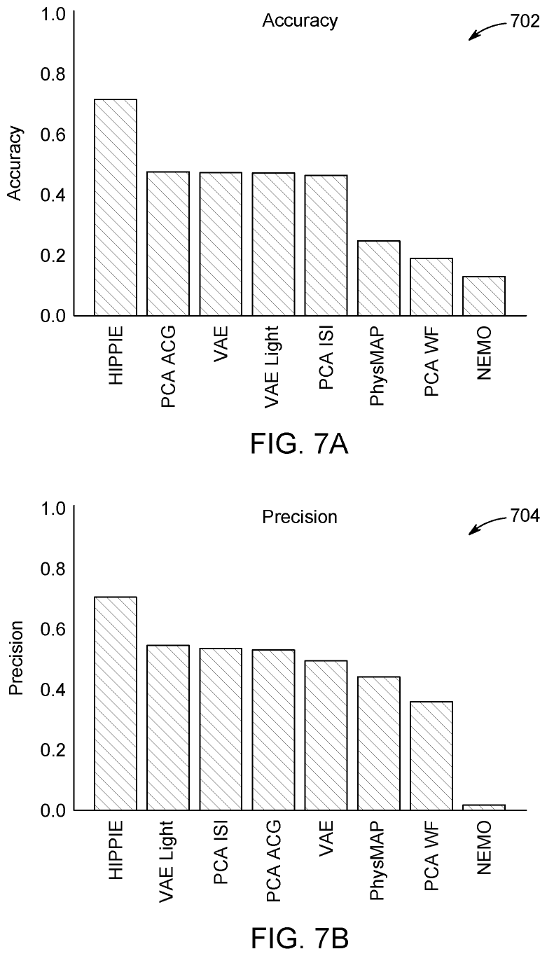

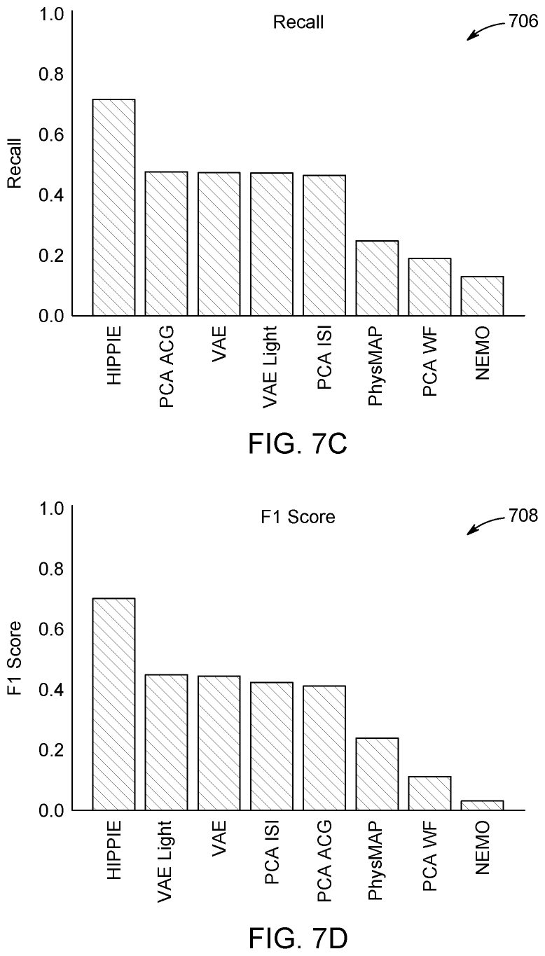

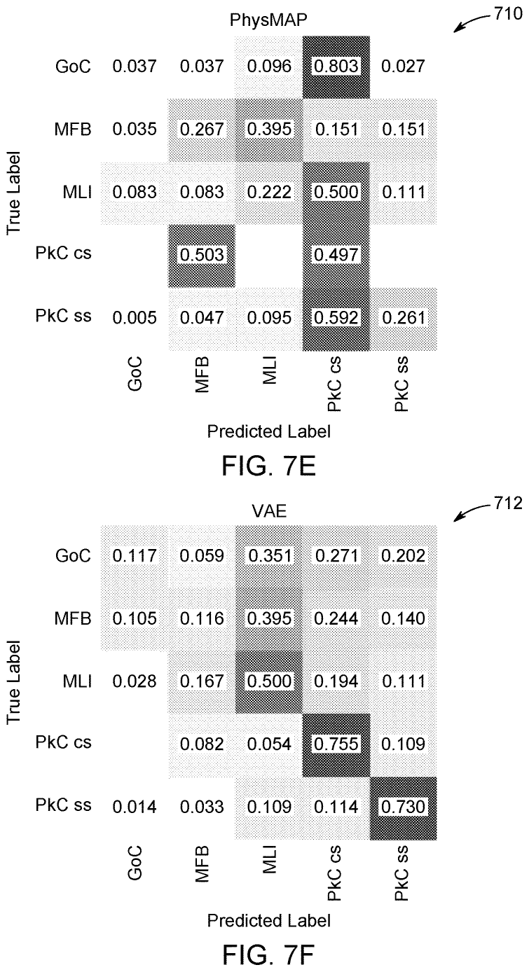

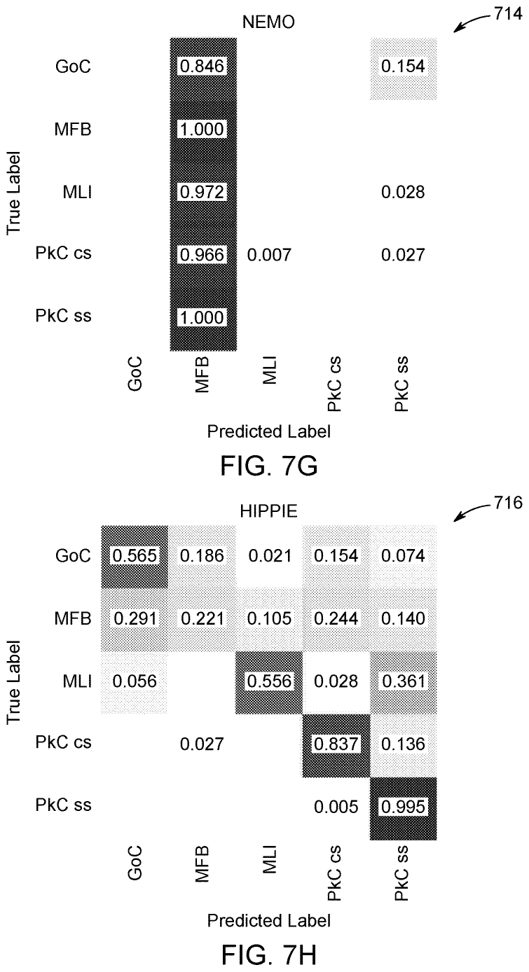

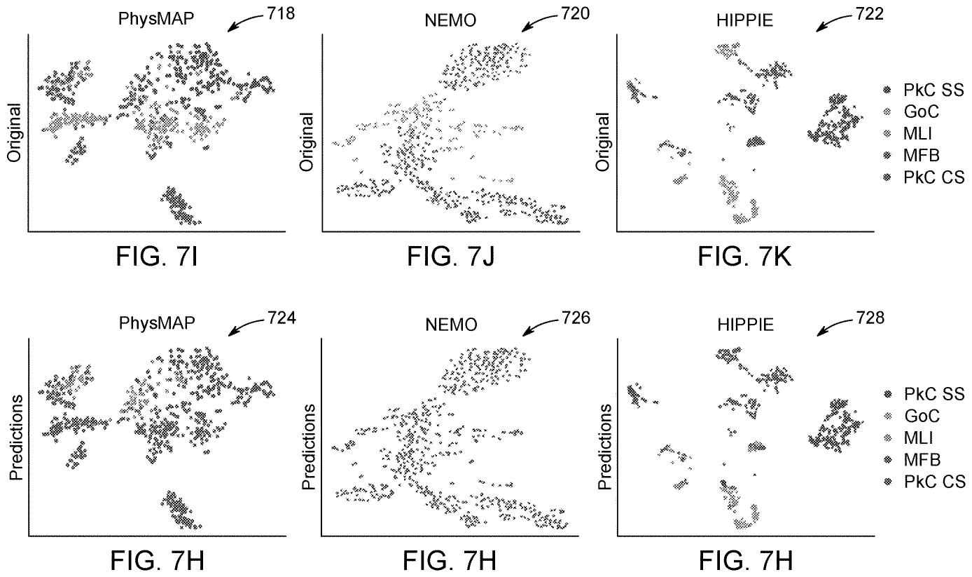

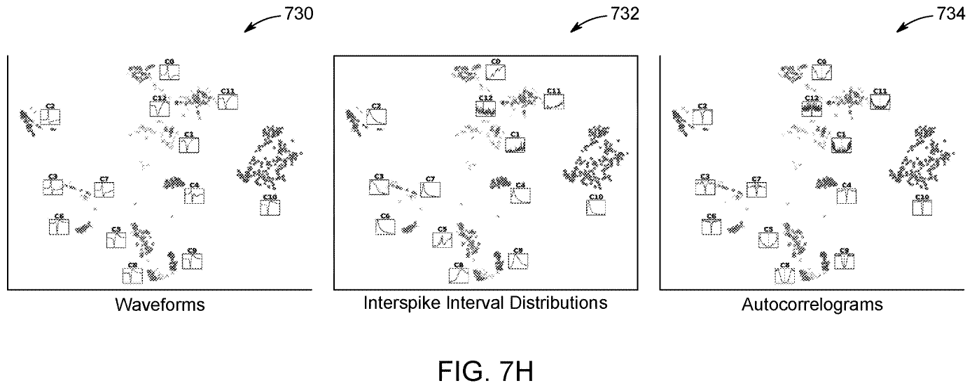

FIG. 7A through FIG. 7D illustrate cross species comparison benchmark results evaluating the ability of the system for classifying neurons using conditional variational autoencoders to generalize neuronal category classification across species boundaries. The cross species comparison benchmark trains the system for classifying neurons on extracellular electrophysiological recordings captured by a recording device from one species and evaluates classification performance on extracellular electrophysiological recordings from a different species. Each recording is associated with a recording source descriptor comprising at least one of a recording technology type identifying a type of recording device used to capture the electrophysiological recording, or a brain region identifier identifying an anatomical region from which the recording was obtained. The cross species benchmark evaluates five cerebellar neuronal categories: Golgi cells (GoC), mossy fiber boutons (MFB), molecular layer interneurons (MLI), Purkinje cell complex spikes (PkC cs), and Purkinje cell simple spikes (PkC ss). The cross species benchmark is a substantially more challenging evaluation compared to within species benchmarks because neuronal electrophysiological properties can vary across species due to differences in cell morphology, ion channel expression, and circuit organization.

FIG. 7A illustrates accuracy, precision, recall, and F1 score benchmark comparisons for the cross species comparison benchmark. An accuracy bar chart 702 displays classification accuracy on the vertical axis ranging from 0 to 1.0 and the methods evaluated on the horizontal axis. The methods evaluated include the system for classifying neurons using conditional variational autoencoders (HIPPIE), principal component analysis applied to autocorrelogram feature (PCA ACG), a lightweight variational autoencoder (VAE Light), a standalone variational autoencoder (VAE), principal component analysis applied to interspike interval feature (PCA ISI), PhysMAP, principal component analysis applied to waveform feature (PCA WF), and NEMO. The accuracy bar chart 702 reveals that the system for classifying neurons using conditional variational autoencoders achieves the highest classification accuracy of approximately 0.65 among all methods. PCA ACG, VAE Light, VAE, and PCA ISI achieve moderate accuracy values ranging from approximately 0.42 to 0.48. PhysMAP achieves an accuracy of approximately 0.40. PCA WF and NEMO achieve the lowest accuracy values of approximately 0.22 and 0.20 respectively. Classification performance is assessed using a K nearest neighbors classifier.

A precision bar chart 704 displays precision on the vertical axis ranging from 0 to 1.0 and the same methods on the horizontal axis. The precision bar chart 704 reveals that the system for classifying neurons using conditional variational autoencoders achieves the highest precision of approximately 0.65 among all methods. VAE Light and PCA ISI achieve moderate precision values. PCA ACG and VAE achieve lower precision values. PhysMAP achieves a precision of approximately 0.32. NEMO achieves a very low precision value, indicating that the predictions generated by NEMO for the cross species benchmark are largely incorrect.

A recall bar chart 706 displays recall on the vertical axis ranging from 0 to 1.0 and the same methods on the horizontal axis. The recall bar chart 706 reveals that the system for classifying neurons using conditional variational autoencoders achieves the highest recall of approximately 0.72 among all methods. PCA ACG achieves a recall of approximately 0.50. VAE Light and VAE achieve moderate recall values. PhysMAP achieves a recall of approximately 0.35. NEMO achieves a recall near zero, indicating that NEMO fails to recover the majority of true positive classifications across the neuronal categories in the cross species benchmark.

An F1 score bar chart 708 displays F1 score on the vertical axis ranging from 0 to 1.0 and the same methods on the horizontal axis. The F1 score bar chart 708 reveals that the system for classifying neurons using conditional variational autoencoders achieves the highest F1 score of approximately 0.65 among all methods. PCA ACG achieves an F1 score of approximately 0.42. VAE Light and PCA ISI achieve F1 scores of approximately 0.38. PhysMAP achieves a lower F1 score of approximately 0.28. NEMO achieves an F1 score near zero. The high F1 score achieved by the system for classifying neurons confirms balanced performance across all five neuronal categories despite the cross species generalization challenge.

FIG. 7B illustrates confusion matrices comparing neuronal category classification performance of PhysMAP, the standalone variational autoencoder (VAE), NEMO, and the system for classifying neurons using conditional variational autoencoders (HIPPIE) for the cross species comparison benchmark. The five neuronal categories are Golgi cells (GoC), mossy fiber boutons (MFB), molecular layer interneurons (MLI), Purkinje cell complex spikes (PkC cs), and Purkinje cell simple spikes (PkC ss). For each confusion matrix, the vertical axis represents the true label corresponding to the actual neuronal category and the horizontal axis represents the predicted label corresponding to the predicted neuronal category.

A confusion matrix for PhysMAP 710 displays classification results for the five neuronal categories of the cross species benchmark. The confusion matrix 710 shows low diagonal values across all neuronal categories. Golgi cells (GoC) achieve a diagonal value of approximately 0.037, indicating that PhysMAP correctly classifies fewer than 4 percent of Golgi cells. Mossy fiber boutons (MFB) achieve a diagonal value of approximately 0.267. Molecular layer interneurons (MLI) achieve a diagonal value of approximately 0.222. Purkinje cell complex spikes (PkC cs) achieve a diagonal value of approximately 0.497. Purkinje cell simple spikes (PkC ss) achieve a diagonal value of approximately 0.261. The confusion matrix 710 reveals that PhysMAP predominantly misclassifies neurons into the Purkinje cell complex spikes category, with the GoC row showing that approximately 0.803 of Golgi cells are misclassified as Purkinje cell complex spikes. PhysMAP fails to generalize neuronal category classification across species boundaries.

A confusion matrix for the standalone variational autoencoder (VAE) 712 displays classification results for the five neuronal categories. The confusion matrix 712 shows that the standalone variational autoencoder achieves high diagonal values for Purkinje cell complex spikes (PkC cs) at approximately 0.755 and Purkinje cell simple spikes (PkC ss) at approximately 0.730. Molecular layer interneurons (MLI) achieve a diagonal value of approximately 0.500. However, the standalone variational autoencoder achieves low diagonal values for Golgi cells (GoC) at approximately 0.117 and mossy fiber boutons (MFB) at approximately 0.116. The confusion matrix 712 reveals substantial off diagonal confusion, particularly in the Golgi cell row where approximately 0.351 of Golgi cells are misclassified as molecular layer interneurons. The standalone variational autoencoder partially resolves the Purkinje cell classification task across species but fails to reliably discriminate Golgi cells and mossy fiber boutons.

A confusion matrix for NEMO 714 displays classification results for the five neuronal categories. The confusion matrix 714 reveals a severe classification bias in which NEMO assigns the majority of neurons to the mossy fiber bouton (MFB) category regardless of the true neuronal category. Golgi cells (GoC) achieve a diagonal value of approximately 0.846. Mossy fiber boutons (MFB) achieve a diagonal value of 1.000. However, the high mossy fiber bouton diagonal value results from the classification bias rather than from meaningful discrimination, as NEMO assigns nearly all neurons to the mossy fiber bouton category regardless of the true label. However, NEMO classifies approximately 0.972 of molecular layer interneurons (MLI), approximately 0.966 of Purkinje cell complex spikes (PkC cs), and 1.000 of Purkinje cell simple spikes (PkC ss) as mossy fiber boutons. The confusion matrix 714 demonstrates that NEMO fails to generalize across species boundaries, collapsing nearly all neuronal categories into a single predicted class. The severe classification bias explains the near zero precision, recall, and F1 scores observed for NEMO in the bar charts 702, 704, 706, and 708.

A confusion matrix for the system for classifying neurons using conditional variational autoencoders (HIPPIE) 716 displays classification results for the five neuronal categories. The confusion matrix 716 displays substantially stronger diagonal values compared to the PhysMAP confusion matrix 710, the standalone variational autoencoder confusion matrix 712, and the NEMO confusion matrix 714. Purkinje cell simple spikes (PkC ss) achieve a diagonal value of approximately 0.995, representing near perfect classification accuracy. Purkinje cell complex spikes (PkC cs) achieve a diagonal value of approximately 0.837. Golgi cells (GoC) achieve a diagonal value of approximately 0.564 and molecular layer interneurons (MLI) achieve a diagonal value of approximately 0.556. Mossy fiber boutons (MFB) achieve a lower diagonal value of approximately 0.221, with off diagonal confusion distributed across multiple neuronal categories. The confusion matrix 716 demonstrates that the system for classifying neurons achieves the highest classification accuracy among methods that produce meaningful per class discrimination for three of the five neuronal categories in the cross species benchmark, including molecular layer interneurons, Purkinje cell complex spikes, and Purkinje cell simple spikes. Although NEMO achieves higher diagonal values for Golgi cells and mossy fiber boutons as shown in the confusion matrix 714, the NEMO diagonal values result from the severe classification bias toward the mossy fiber bouton category rather than from meaningful discrimination among neuronal categories. The conditional variational autoencoders conditioned on the recording source descriptor effectively extract species invariant features from the waveform feature, the interspike interval feature, and the autocorrelogram feature, enabling cross species generalization.

FIG. 7C illustrates t distributed stochastic neighbor embedding (t SNE) representations of the latent embeddings generated by PhysMAP, NEMO, and the system for classifying neurons using conditional variational autoencoders (HIPPIE) for the cross species comparison benchmark. The t SNE visualizations are arranged in a grid with three columns corresponding to the three methods and two rows corresponding to original author assigned labels and tool predicted labels. The five neuronal categories are distinguished by different symbols: Purkinje cell simple spikes (PkC ss), Golgi cells (GoC), molecular layer interneurons (MLI), mossy fiber boutons (MFB), and Purkinje cell complex spikes (PkC cs).

A t SNE representation of the PhysMAP embeddings labeled with original author assigned labels 718 displays the spatial distribution of neurons in the PhysMAP latent space. The t SNE representation 718 shows partial separation of some neuronal categories with substantial intermixing of labels across the embedding space. A t SNE representation of the PhysMAP embeddings labeled with tool predicted labels 724 displays the classification predictions generated by PhysMAP. The t SNE representation 724 reveals widespread misclassification, with large regions of the embedding space assigned to the Purkinje cell complex spikes category consistent with the classification bias toward Purkinje cell complex spikes observed in the confusion matrix 710. The comparison between the original labels in the t SNE representation 718 and the predicted labels in the t SNE representation 724 confirms the confusion observed in the confusion matrix 710, demonstrating that the PhysMAP latent space does not adequately separate the five cerebellar neuronal categories across species boundaries.

A t SNE representation of the NEMO embeddings labeled with original author assigned labels 720 displays the spatial distribution of neurons in the NEMO latent space. The t SNE representation 720 shows limited separation of neuronal categories, with substantial overlap and intermixing among the five categories. A t SNE representation of the NEMO embeddings labeled with tool predicted labels 726 displays the classification predictions generated by NEMO. The t SNE representation 726 reveals that NEMO assigns the vast majority of neurons to a single neuronal category, consistent with the classification bias toward mossy fiber boutons observed in the confusion matrix 714. The NEMO latent space fails to resolve species invariant features that distinguish the five cerebellar neuronal categories.

A t SNE representation of the embeddings generated by the system for classifying neurons using conditional variational autoencoders labeled with original author assigned labels 722 displays the spatial distribution of neurons in the multimodal latent embedding. The t SNE representation 722 shows distinct, well separated clusters corresponding to the five neuronal categories. The clusters in the t SNE representation 722 exhibit tighter grouping and clearer boundaries compared to the PhysMAP t SNE representation 718 and the NEMO t SNE representation 720. A t SNE representation labeled with tool predicted labels 728 displays the classification predictions generated by the system for classifying neurons. The t SNE representation 728 shows close correspondence between the predicted labels and the original author assigned labels in the t SNE representation 722, confirming that the system for classifying neurons correctly assigns neurons to their respective neuronal categories. The well separated clusters in the multimodal latent embedding demonstrate that the conditional variational autoencoders conditioned on the recording source descriptor produce multimodal latent representations that capture species invariant neuronal identity.

FIG. 7D illustrates the t SNE representation of the multimodal latent embedding generated by the system for classifying neurons using conditional variational autoencoders, distinguished by HDBSCAN clusters, with mean feature representations plotted alongside each cluster. HDBSCAN is a density based clustering algorithm applied to the harmonized latent representations to identify natural groupings in the embedding space without relying on the supervised neuronal category labels. FIG. 7D presents three panels corresponding to the three electrophysiological features processed by the conditional variational autoencoders.

A waveform feature t SNE representation 730 displays the multimodal latent embedding distinguished by HDBSCAN clusters, with mean waveform feature insets plotted adjacent to each cluster. Each inset displays the normalized mean extracellular waveform computed by averaging spike triggered voltage traces across a plurality of detected action potentials for neurons assigned to the corresponding cluster. The waveform feature represents a shape of an extracellular action potential of the neuron. Each normalized mean extracellular waveform comprises a one dimensional vector of data points sampled within a time window at a sampling rate sufficient to resolve the extracellular action potential morphology. The waveform feature t SNE representation 730 reveals that the HDBSCAN clusters correspond to neurons with distinct waveform morphologies, confirming that the multimodal latent embedding encodes waveform shape information in a biologically meaningful manner. Clusters containing Purkinje cell simple spikes exhibit characteristic broad waveform morphologies, while clusters containing mossy fiber boutons and molecular layer interneurons exhibit narrower waveform shapes.

An interspike interval feature t SNE representation 732 displays the multimodal latent embedding distinguished by HDBSCAN clusters, with mean interspike interval feature distribution insets plotted adjacent to each cluster. Each inset displays the mean interspike interval feature distribution for neurons assigned to the corresponding cluster. The interspike interval feature represents a temporal distribution of intervals between successive action potentials of each of the plurality of neurons. Each interspike interval feature distribution comprises a histogram of intervals between consecutive spikes binned at a predetermined temporal resolution. The interspike interval feature t SNE representation 732 reveals that the HDBSCAN clusters correspond to neurons with distinct temporal firing dynamics, confirming that the multimodal latent embedding preserves interspike interval structure.

An autocorrelogram feature t SNE representation 734 displays the multimodal latent embedding distinguished by HDBSCAN clusters, with mean autocorrelogram feature insets plotted adjacent to each cluster. Each inset displays the mean autocorrelogram feature for neurons assigned to the corresponding cluster. The autocorrelogram feature represents a temporal autocorrelation function computed from the action potential spike train of the neuron. The autocorrelogram feature t SNE representation 734 reveals that the HDBSCAN clusters correspond to neurons with distinct temporal autocorrelation signatures. The correspondence between HDBSCAN clusters and biologically distinct feature representations across the waveform feature t SNE representation 730, the interspike interval feature t SNE representation 732, and the autocorrelogram feature t SNE representation 734 confirms that the multimodal latent embedding generated by the system for classifying neurons captures biologically meaningful structure in the extracellular electrophysiological recordings.

The cross species comparison benchmark results of FIG. 7A through FIG. 7D demonstrate that the system for classifying neurons using conditional variational autoencoders generalizes neuronal category classification across species boundaries. The one or more processors generate the multimodal latent embedding by fusing the waveform latent code and the timing latent code using a mixture module that combines the latent embeddings output by a first conditional variational autoencoder module, a second conditional variational autoencoder module, and a third conditional variational autoencoder module into a joint latent representation. Each of the first conditional variational autoencoder module, the second conditional variational autoencoder module, and the third conditional variational autoencoder module comprises a one dimensional residual network encoder and a one dimensional residual network decoder. The one or more analysis operations performed on the multimodal latent representations comprise performing batch harmonization by applying batch effect correction to the multimodal latent embedding to produce, for each neuron unit, a harmonized latent representation with reduced variation attributable to differences in recording source. The K nearest neighbors classifier classifies each neuron unit into a neuronal category by applying K nearest neighbors classification to the harmonized latent representations based on proximity to labeled reference representations. The K nearest neighbors classifier uses Euclidean distance to identify nearest neighbors and generates a confidence score for each classification derived as a proportion of neighboring representations in the harmonized latent representations that share the neuronal category. The neuronal category comprises at least one of a neuronal subtype classification identifying each neuron as belonging to a genetically defined cell type, or an anatomical region classification mapping each neuron to a brain region based on electrophysiological characteristics encoded in the harmonized latent representations. The results generate an analysis result characterizing the plurality of neurons across species.

The classification results depicted in FIG. 7A through FIG. 7D are obtained using a two phase training strategy. During a first phase, the one or more processors pretrain the one or more conditional variational autoencoders by self supervised learning on a plurality of electrophysiological datasets with class label embeddings masked to zero while conditioning on a recording source covariate. The labeled target dataset is excluded from the plurality of electrophysiological datasets in a leave one dataset out configuration. During a second phase, the one or more processors fine tune the conditional variational autoencoders by supervised learning on the labeled target dataset with class labels provided. During fine tuning, each mini batch of training data is sampled to contain an equal proportion of each class label, and a learning rate for fine tuning is a fraction of a learning rate used during pretraining. The cross species comparison benchmark results establish that the batch harmonization performed by the system for classifying neurons effectively removes species specific variation from the multimodal latent embedding while preserving neuronal category specific features, enabling robust classification of neurons in a target species using labeled reference representations from a different species.

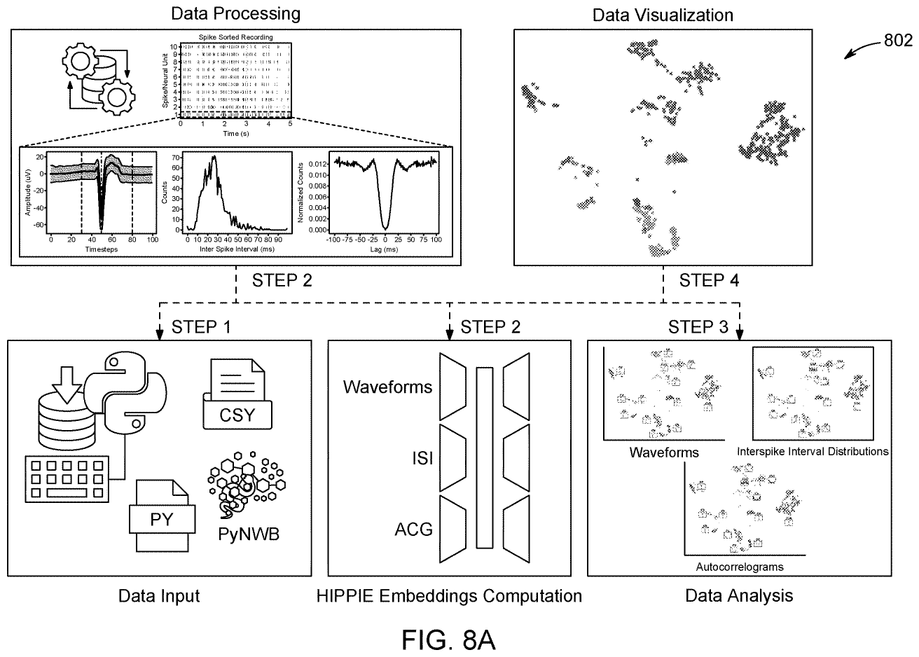

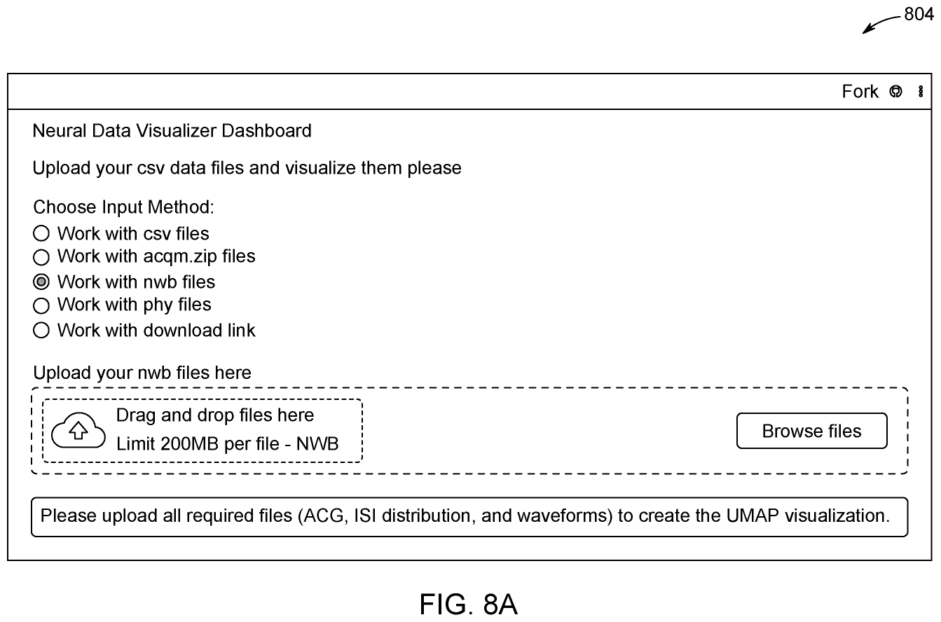

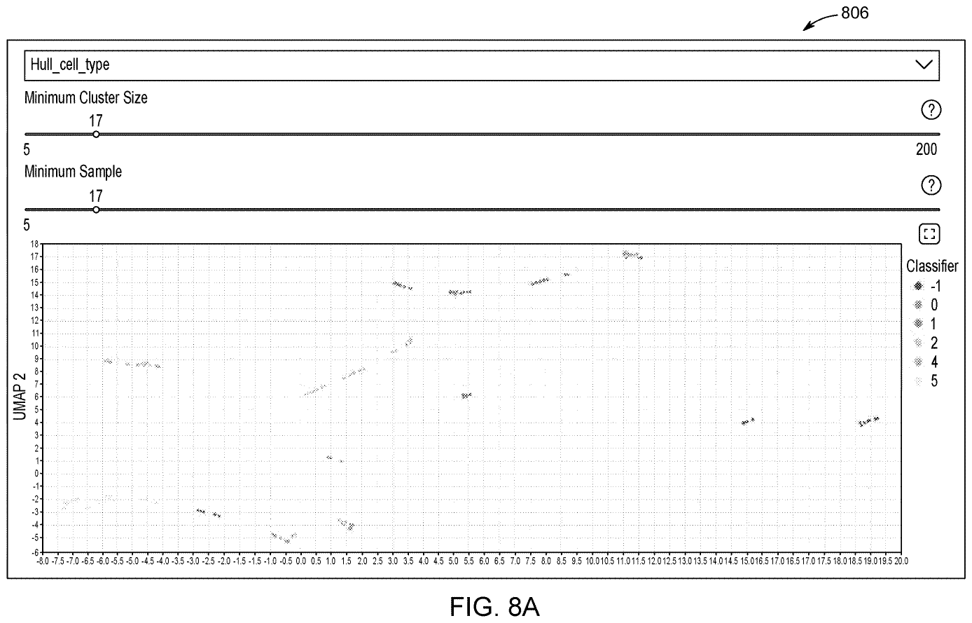

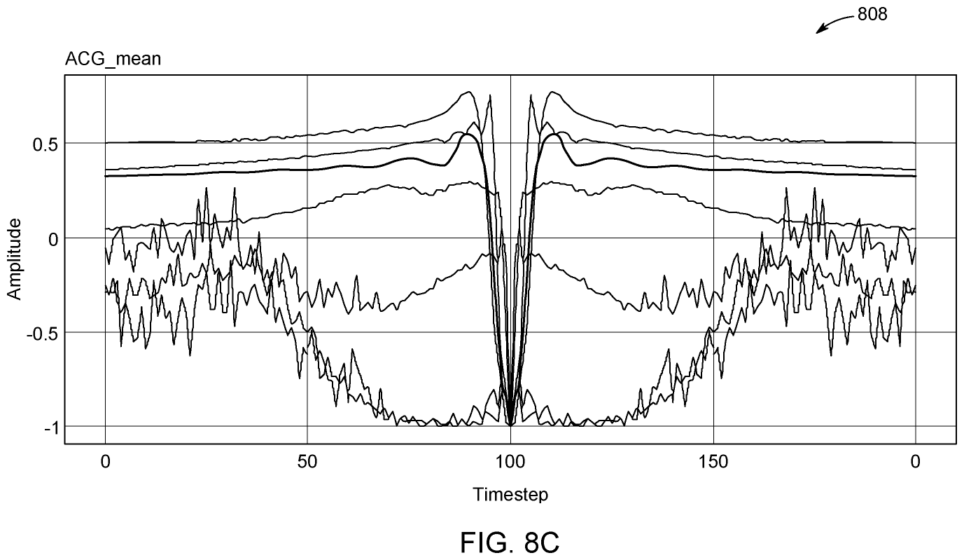

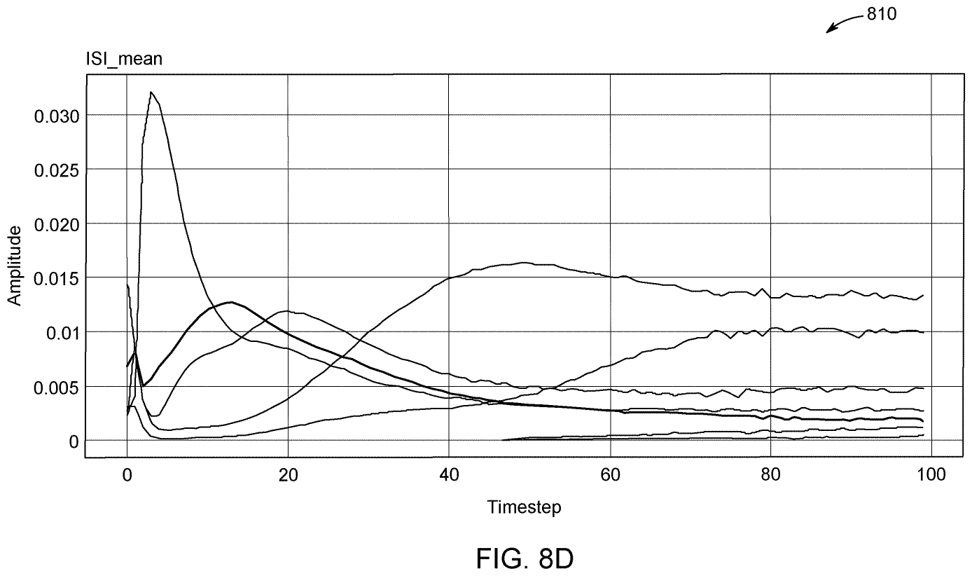

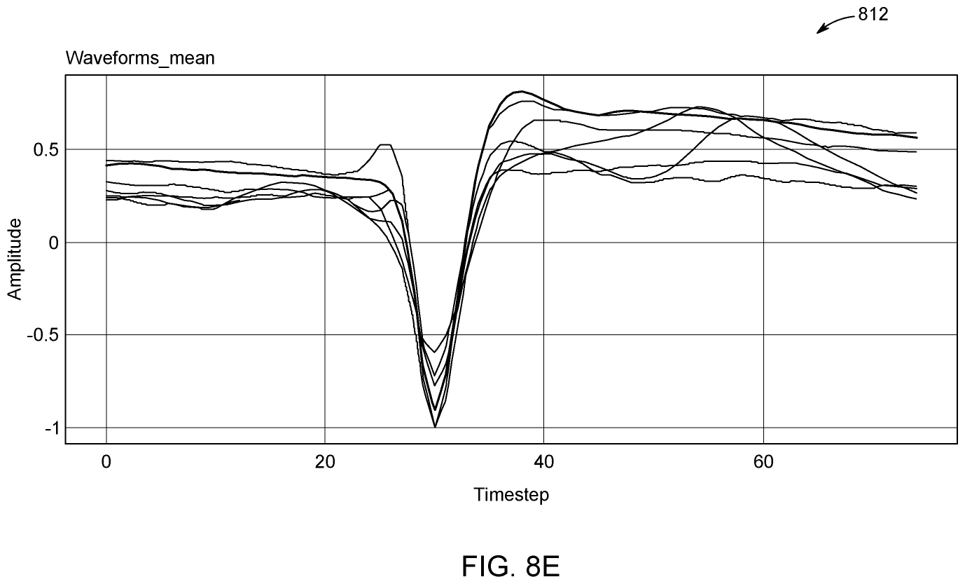

FIG. 8A and FIG. 8B illustrate a web application implementing the system for classifying neurons using conditional variational autoencoders. The web application provides a graphical user interface that enables a user to upload extracellular electrophysiological recordings captured by a recording device, compute multimodal latent representations using the conditional variational autoencoders, and interactively explore classification results and electrophysiological feature visualizations. Each recording is associated with a recording source descriptor comprising at least one of a recording technology type identifying a type of recording device used to capture the electrophysiological recording, or a brain region identifier identifying an anatomical region from which the recording was obtained.

FIG. 8A illustrates a pipeline diagram 802 depicting the sequential steps executed by the web application during runtime. The pipeline diagram 802 comprises five steps arranged in a sequential workflow. Step 1 is a data input step in which the user provides extracellular electrophysiological recordings to the web application. The data input step accepts multiple input data formats including comma separated value (CSV) files, Python based data files, and Neurodata Without Borders (NWB) files. The data input step displays icons representing a database, a CSV file, a Python (PY) file, and a PyNWB library, indicating that the web application supports ingestion of electrophysiological data from multiple standardized neuroscience data formats.

Step 2 of the pipeline diagram 802 is a data processing step in which the one or more processors extract the electrophysiological features from the uploaded recordings. The data processing step displays a spike sorted recording panel showing a raster plot of spike neural units over time. The data processing step further displays extracted electrophysiological features including a waveform feature panel showing the shape of extracellular action potentials and an interspike interval feature panel. The waveform feature represents a shape of an extracellular action potential of the neuron. Each waveform feature comprises a normalized mean extracellular waveform computed by averaging spike triggered voltage traces across a plurality of detected action potentials for each neuron. The interspike interval feature represents a temporal distribution of intervals between successive action potentials of each of the plurality of neurons. Each interspike interval feature comprises a histogram of intervals between consecutive spikes binned at a predetermined temporal resolution.

Step 3 of the pipeline diagram 802 is an embeddings computation step in which the one or more processors compute multimodal latent representations using the system for classifying neurons using conditional variational autoencoders. The embeddings computation step displays a schematic of the conditional variational autoencoder architecture with three input channels corresponding to the waveform feature, the interspike interval feature (ISI), and the autocorrelogram feature (ACG). The autocorrelogram feature represents a temporal autocorrelation function computed from the action potential spike train of the neuron. The three input channels pass through a first conditional variational autoencoder module, a second conditional variational autoencoder module, and a third conditional variational autoencoder module respectively. A mixture module combines the latent embeddings output by the first conditional variational autoencoder module, the second conditional variational autoencoder module, and the third conditional variational autoencoder module into a joint latent representation. Each of the first conditional variational autoencoder module, the second conditional variational autoencoder module, and the third conditional variational autoencoder module comprises a one dimensional residual network encoder and a one dimensional residual network decoder. The one or more processors produce a multimodal latent embedding for each neuron by fusing the waveform latent code and the timing latent code.

Step 4 of the pipeline diagram 802 is a data visualization step in which the web application displays the multimodal latent representations as a two dimensional embedding visualization. The data visualization step displays a scatter plot in which each point represents a neuron and the points are distinguished by neuronal category. The scatter plot reveals distinct clusters corresponding to different neuronal categories, demonstrating that the multimodal latent representations computed by the system for classifying neurons effectively separate neurons into biologically meaningful groupings in the latent space.

Step 5 of the pipeline diagram 802 is a data analysis step in which the web application provides interactive exploration of the electrophysiological features associated with each cluster in the embedding visualization. The data analysis step displays three panels showing mean waveform feature representations, mean interspike interval feature distributions, and mean autocorrelogram feature representations for individual clusters identified in the embedding. The data analysis step enables the user to examine the electrophysiological properties of each identified cluster by displaying the mean feature representations alongside the corresponding cluster in the two dimensional embedding. The one or more analysis operations performed on the multimodal latent representations generate an analysis result characterizing the plurality of neurons.

FIG. 8B illustrates screenshots of the web application graphical user interface implementing the pipeline described in the pipeline diagram 802 of FIG. 8A. A web application interface panel 804 displays the landing page of the web application titled Neural data visualizer. The web application interface panel 804 includes an input format selection region and a file upload region. The input format selection region provides radio button controls allowing the user to select from multiple input data formats including CSV files, acg phy files, NWB files, phy files, and a download link option. The file upload region displays a drag and drop area and a Browse files button for uploading the electrophysiological recording data files. The web application interface panel 804 further displays an instructional message indicating that the user should upload all required files including autocorrelogram features, interspike interval feature distributions, and waveform features to create the embedding visualization.

A UMAP embedding visualization panel 806 displays a two dimensional Uniform Manifold Approximation and Projection (UMAP) representation of the multimodal latent representations computed by the system for classifying neurons using conditional variational autoencoders. The UMAP embedding visualization panel 806 shows a scatter plot in which each point represents a neuron and the points are distinguished by neuronal category label. The UMAP embedding visualization panel 806 includes a legend displaying the neuronal category labels and corresponding symbols. The UMAP embedding visualization panel 806 further includes parameter controls for adjusting HDBSCAN density based clustering parameters to identify natural groupings in the harmonized latent representations. The one or more analysis operations performed on the multimodal latent representations comprise performing batch harmonization by applying batch effect correction to the multimodal latent embedding to produce, for each neuron unit, a harmonized latent representation with reduced variation attributable to differences in recording source.

A mean autocorrelogram visualization panel 808 displays the mean autocorrelogram feature for a selected cluster in the UMAP embedding visualization panel 806. The mean autocorrelogram visualization panel 808 shows a plot with multiple overlaid traces representing the temporal autocorrelation function of the neurons assigned to the selected cluster. The autocorrelogram feature represents a temporal autocorrelation function computed from the action potential spike train of each neuron. The mean autocorrelogram visualization panel 808 enables the user to examine the temporal firing patterns of the neurons within the selected cluster.

A mean interspike interval distribution visualization panel 810 displays the mean interspike interval feature distribution for the selected cluster in the UMAP embedding visualization panel 806. The mean interspike interval distribution visualization panel 810 shows a plot with multiple overlaid traces representing the interspike interval feature distributions of the neurons assigned to the selected cluster. The interspike interval feature represents a temporal distribution of intervals between successive action potentials of the neuron. The mean interspike interval distribution visualization panel 810 enables the user to examine the temporal spacing between action potentials for the neurons within the selected cluster.

A mean waveform visualization panel 812 displays the mean waveform feature for the selected cluster in the UMAP embedding visualization panel 806. The mean waveform visualization panel 812 shows a plot with multiple overlaid traces representing the normalized mean extracellular waveform of the neurons assigned to the selected cluster. Each normalized mean extracellular waveform comprises a one dimensional vector of data points sampled within a time window at a sampling rate of at least 20 kilohertz. The mean waveform visualization panel 812 enables the user to examine the action potential waveform morphology of the neurons within the selected cluster.

The web application illustrated in FIG. 8A and FIG. 8B implements the complete pipeline of the system for classifying neurons using conditional variational autoencoders, from data input through feature extraction, embedding computation, visualization, and interactive analysis. The K nearest neighbors classifier classifies each neuron unit into a neuronal category by applying K nearest neighbors classification to the harmonized latent representations based on proximity to labeled reference representations. The K nearest neighbors classifier uses Euclidean distance to identify nearest neighbors and generates a confidence score for each classification derived as a proportion of neighboring representations in the harmonized latent representations that share the neuronal category. The neuronal category comprises at least one of a neuronal subtype classification identifying each neuron as belonging to a genetically defined cell type, or an anatomical region classification mapping each neuron to a brain region based on electrophysiological characteristics encoded in the harmonized latent representations.

The classification results and embedding visualizations presented by the web application are obtained using a two phase training strategy. During a first phase, the one or more processors pretrain the one or more conditional variational autoencoders by self supervised learning on a plurality of electrophysiological datasets with class label embeddings masked to zero while conditioning on a recording source covariate. The labeled target dataset is excluded from the plurality of electrophysiological datasets in a leave one dataset out configuration. During a second phase, the one or more processors fine tune the conditional variational autoencoders by supervised learning on the labeled target dataset with class labels provided. During fine tuning, each mini batch of training data is sampled to contain an equal proportion of each class label, and a learning rate for fine tuning is a fraction of a learning rate used during pretraining.

### IMPLEMENTATION

The system 230 for classifying neurons from extracellular electrophysiological recordings, as validated through the experimental benchmarks depicted in FIG. 1 through FIG. 8B, is implementable on one or more processors coupled to a memory storing instructions that, when executed by the one or more processors, cause the one or more processors to perform the operations of extracting waveform features and interspike interval features, generating latent codes using conditional variational autoencoder modules conditioned on a recording source descriptor, fusing the latent codes to produce a multimodal latent embedding, and performing analysis operations on the multimodal latent representations to generate an analysis result characterizing a plurality of neurons. The one or more processors may be implemented using general purpose central processing units, graphics processing units, tensor processing units, field programmable gate arrays, or combinations thereof. The memory may comprise volatile memory, non-volatile memory, or a combination of volatile and non-volatile memory.

The following figures describe the general purpose computing environment and the method steps through which the system 230 may be implemented. The following figures further illustrate the data flow, processing stages, and hardware configurations that support the training and inference operations of the system 230, including the self supervised pretraining using a leave one dataset out strategy, the supervised fine tuning on a labeled target dataset, and the classification of neurons into neuronal categories using the K nearest neighbors classifier on harmonized latent representations.

### Computer Architecture

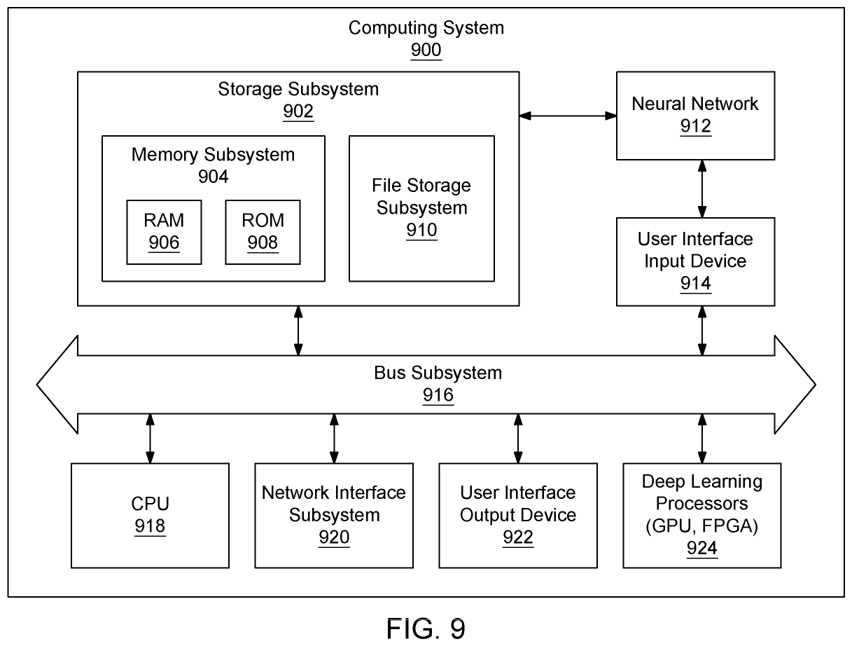

FIG. 9 illustrates a computing system 900 for implementing one or more computational aspects of the present disclosure, including, for example, execution of instructions for characterizing a biological neural network, operating a simulated task environment in closed loop, evaluating task performance, and adaptively selecting and delivering training electrical stimulation patterns. The computing system 900 is provided as one non-limiting example of a suitable computing platform and is not intended to suggest any limitation as to the scope of use or functionality. Regardless of the particular configuration, the computing system 900 is capable of implementing any of the functionality described herein.

The computing system 900 may be implemented using any of a variety of general-purpose or special-purpose computing environments or configurations. Examples of suitable computing systems, environments, and configurations include, without limitation, personal computers, server computer systems, thin clients, thick clients, handheld or laptop devices, multiprocessor systems, microprocessor-based systems, set-top boxes, programmable consumer electronics, network PCs, minicomputer systems, mainframe computer systems, and distributed computing environments that include any of the foregoing systems or devices.

The computing system 900 may be described in the general context of computer system-executable instructions, such as program modules, being executed by one or more processors. Program modules may include routines, programs, objects, components, logic, data structures, and the like that perform particular tasks or implement particular abstract data types. The computing system 900 may be practiced in distributed computing environments where tasks are performed by remote processing devices that are linked through a communications network. In a distributed computing environment, program modules may be located in both local and remote computer system storage media including memory storage devices.

As depicted in FIG. 9, the computing system 900 includes a storage subsystem 902, a bus subsystem 916, a central processing unit (CPU) 918, a network interface subsystem 920, and a user interface output device 922. The storage subsystem 902 further includes a memory subsystem 904 and a file storage subsystem 910. The memory subsystem 904 includes random access memory (RAM) 906 and read-only memory (ROM) 908, which together provide system memory for storing program instructions and data that are immediately accessible to the CPU 918 during operation.

The bus subsystem 916 couples the CPU 918, the storage subsystem 902, the network interface subsystem 920, the user interface output device 922, and a user interface input device 914. The bus subsystem 916 represents one or more of any of several types of bus structures, including a memory bus or memory controller, a peripheral bus, an accelerated graphics port, and a processor or local bus using any of a variety of bus architectures. By way of example and not limitation, such architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Peripheral Component Interconnect Express (PCIe) bus, and an Advanced Microcontroller Bus Architecture (AMBA) bus.

The computing system 900 typically includes a variety of computer system readable media. Such media may be any available media that is accessible by the computing system 900 and may include both volatile and non-volatile media, and removable and non-removable media. System memory provided by the memory subsystem 904 can include computer system readable media in the form of volatile memory, such as RAM 906 and/or cache memory. The computing system 900 may further include other removable or non-removable, volatile or non-volatile computer system storage media within the file storage subsystem 910. By way of example only, the file storage subsystem 910 may include one or more non-removable, non-volatile storage devices such as magnetic hard drives, solid-state drives, or other mass-storage devices. In other implementations, the file storage subsystem 910 may also support removable storage, such as magnetic disks, optical disks (for example, CD-ROM or DVD-ROM media), or other removable non-volatile media, connected to the bus subsystem 916 through one or more data media interfaces.

The memory subsystem 904 may store at least one program product having a set of program modules configured to carry out the functions described herein, including the operations for characterizing putative neural units, computing connectivity information, operating the simulated dynamical task environment, decoding control signals, evaluating task performance, and adaptively selecting and delivering training electrical stimulation patterns. A program/utility having one or more program modules may be stored in the memory subsystem 904, together with an operating system, one or more application programs, other program modules, and program data. Each of the operating system, application programs, other program modules, and program data, or some combination thereof, may implement a networking environment and the closed-loop control functionality associated with the present disclosure. The program modules generally carry out the functions and methodologies of the embodiments described herein.

Computer readable program instructions for carrying out operations of the present disclosure may be assembler instructions, instruction-set-architecture (ISA) instructions, machine instructions, machine-dependent instructions, microcode, firmware instructions, state-setting data, or either source code or object code written in any combination of one or more programming languages, including object-oriented programming languages such as Smalltalk or C++, and conventional procedural programming languages such as the C programming language or similar languages. The computer readable program instructions may execute entirely on the computing system 900, partly on the computing system 900 and partly on a remote computer, or entirely on a remote computer or server. In the latter scenario, the remote computer may be connected to the computing system 900 through any type of network, including a local area network (LAN) or a wide area network (WAN), or through an external network such as the Internet using an Internet service provider. In some implementations, electronic circuitry such as programmable logic circuitry, field-programmable gate arrays (FPGA), or programmable logic arrays (PLA) may execute the computer readable program instructions by utilizing state information of the instructions to personalize the electronic circuitry to perform aspects of the present disclosure.

Aspects of the present disclosure may be described with reference to flowchart illustrations and/or block diagrams of methods, systems, and computer program products. It will be understood that each block of such flowcharts and/or block diagrams, and combinations of blocks, can be implemented by computer readable program instructions. These computer readable program instructions may be provided to the CPU 918 or to another processor of a general-purpose or special-purpose computing device to produce a machine, such that the instructions executed by the processor implement the functions specified in the flowchart or block diagram blocks.

The computer readable program instructions may also be stored in a computer readable storage medium of the storage subsystem 902 that can direct the computing system 900 or another programmable apparatus to function in a particular manner, such that the storage medium having instructions stored therein comprises an article of manufacture including instructions which implement aspects of the functions described herein. The instructions may also be loaded onto the computing system 900 or another device to cause a series of operational steps to be performed so as to implement processes such as the real-time read, environment-update, and conditional training phases of the closed-loop system.

The user interface input device 914 may include one or more devices such as a keyboard, mouse, touch screen, pointing device, or other human-machine interface configured to receive user commands, configuration parameters, or experimental control inputs relevant to operation of the system described in this specification. The user interface output device 922 may include a display, monitor, graphical user interface, speakers, or other output peripherals configured to present task-performance metrics, connectivity visualizations, or real-time status information to an operator. The network interface subsystem 920 enables the computing system 900 to communicate with external systems, databases, remote servers, or laboratory information systems over wired or wireless communication links, thereby supporting remote data storage, collaborative analysis, or distributed experiment control.

Accordingly, the computing system 900 provides a flexible and scalable platform for implementing the computational operations associated with inducing adaptive learning in biological neural networks cultured in vitro, while remaining compatible with a broad range of hardware and software environments.

### AI Implementation:

The system 230 for classifying neurons from extracellular electrophysiological recordings is an artificial intelligence system that employs deep learning to transform raw electrophysiological signals into technology invariant multimodal latent embeddings for neuronal classification. The artificial intelligence foundation of the system 230 resides in the conditional variational autoencoders 240, each of which comprises a one dimensional residual network encoder and a one dimensional residual network decoder that together form a deep generative neural network. The one dimensional residual network encoders automatically learn hierarchical feature representations from the waveform feature 238-1 and the interspike interval feature 238-2 without reliance on hand crafted features or fixed mathematical transformations, discovering discriminative patterns that correlate with neuronal subtypes and anatomical brain regions through data driven optimization of a loss function 264 comprising a reconstruction loss term and a Kullback Leibler divergence term weighted by a hyperparameter β. The conditional variational autoencoders 240 are conditioned on the recording source descriptor, which is an artificial intelligence conditioning technique that enables the one dimensional residual network encoders to explicitly model and factor out variation attributable to recording platform differences so that the learned latent embeddings reflect biological neuronal variation rather than technical variation arising from differences among recording devices 232.

The training architecture of the system 230 implements artificial intelligence learning paradigms at two stages. At a first stage, self supervised pretraining 260 trains the conditional variational autoencoders 240 on the plurality of electrophysiological datasets 256 with neuronal category labels masked, enabling the one dimensional residual network encoders and one dimensional residual network decoders to learn general purpose latent representations from unlabeled data across heterogeneous recording devices and experimental preparations. The leave one dataset out strategy 262 employed during self supervised pretraining 260 mirrors transfer learning paradigms in artificial intelligence in which a model acquires broad representational capacity before adaptation to a specific downstream task. At a second stage, supervised fine tuning 266 adapts the learned latent representations to the specific classification task defined by the labeled target dataset 258 while preserving the technology invariant structure acquired during self supervised pretraining 260. The two stage training protocol enables the conditional variational autoencoders 240 to generalize to entirely unseen experimental preparations and recording technology types, as demonstrated by the inductive benchmark results in which the system 230 achieves 91.8 percent accuracy for the waveform feature and 91.7 percent accuracy for the interspike interval feature across 40 anatomically defined brain areas while all baseline methods including principal component analysis and PhysMAP remain at or below 14.2 percent accuracy.

The artificial intelligence architecture of the system 230 further comprises multimodal deep learning through the mixer module 242, which fuses the waveform latent code and the timing latent code into a multimodal latent embedding that captures complementary electrophysiological information from the waveform feature modality and the interspike interval feature modality. The independence between waveform feature representations and interspike interval feature representations, establishes that the two input modalities contribute non redundant discriminative information to the multimodal latent embedding. The batch harmonization 246 applied by the analysis operations module 244 further reduces variation in the multimodal latent embeddings attributable to differences in recording source, producing harmonized latent representations 248 within a common representational space. The K nearest neighbors classifier 250 then operates as a machine learning classification algorithm on the harmonized latent representations 248 to assign each neuron to a neuronal category based on proximity to the labeled reference data 252, generating a confidence score derived as a proportion of neighboring representations that share the assigned neuronal category. The integration of deep generative modeling through the conditional variational autoencoders 240, conditional generation through the recording source descriptor, multimodal fusion through the mixer module 242, batch harmonization through the analysis operations module 244, and machine learning classification through the K nearest neighbors classifier 250 constitutes an end to end artificial intelligence pipeline in which every stage from feature encoding to neuronal category assignment is driven by learned representations rather than predetermined analytical transformations.

### Machine Learning Techniques

Some implementations of the technology disclosed relate to using a Transformer model to provide an AI system. In particular, the technology disclosed proposes an AI management system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically only have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLaMA versions, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, VITB/16-FRCNN, VIT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bidirectional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

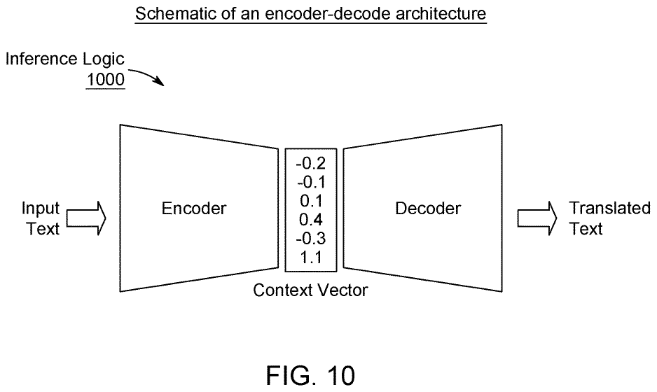

FIG. 10 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

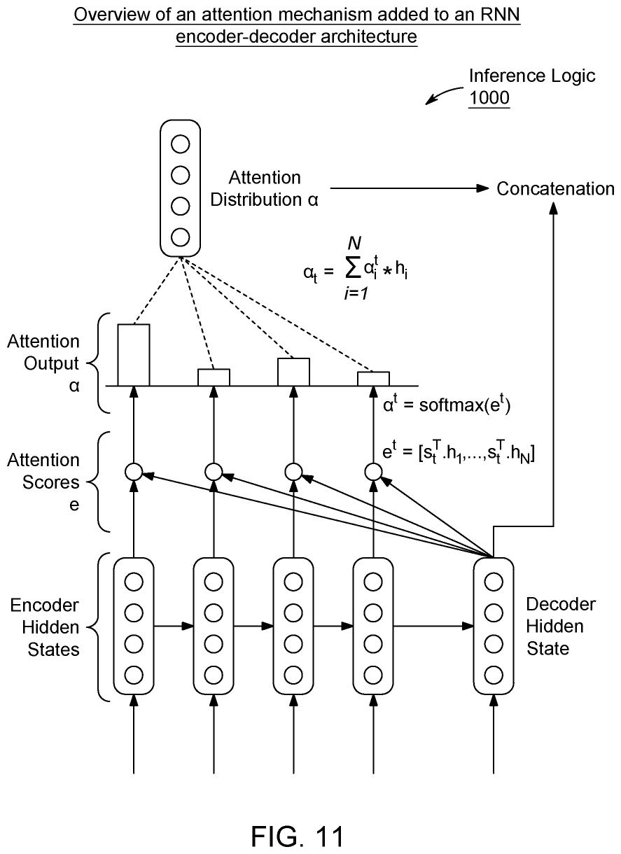

Attention mechanisms distinguish Transformers from other machine learning models. The attention mechanism provides a solution for the vanishing gradient problem. FIG. 11 shows an overview of an attention mechanism added to an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

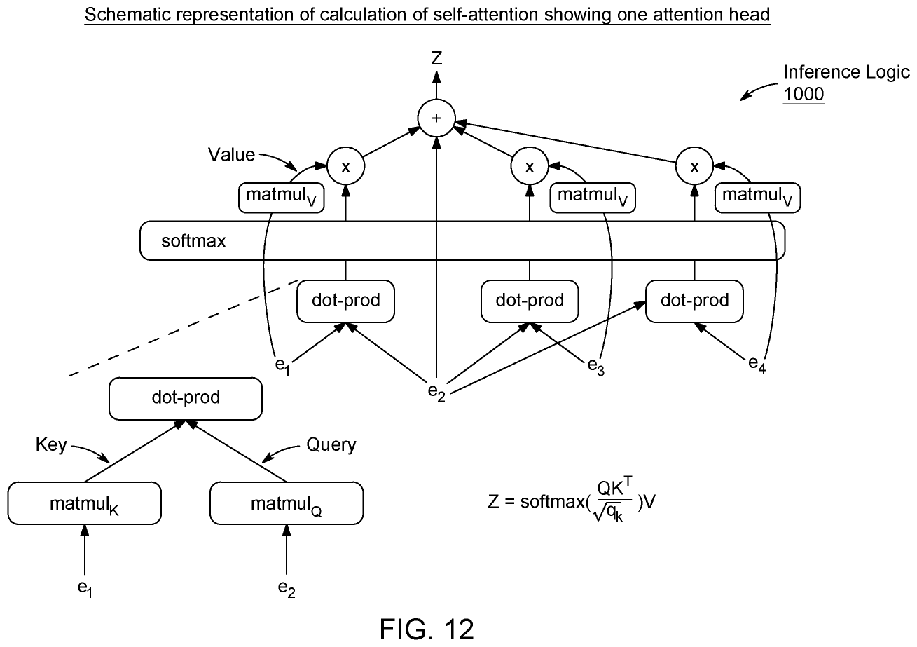

Multi-headed attention is executed in the Transformer. FIG. 12 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

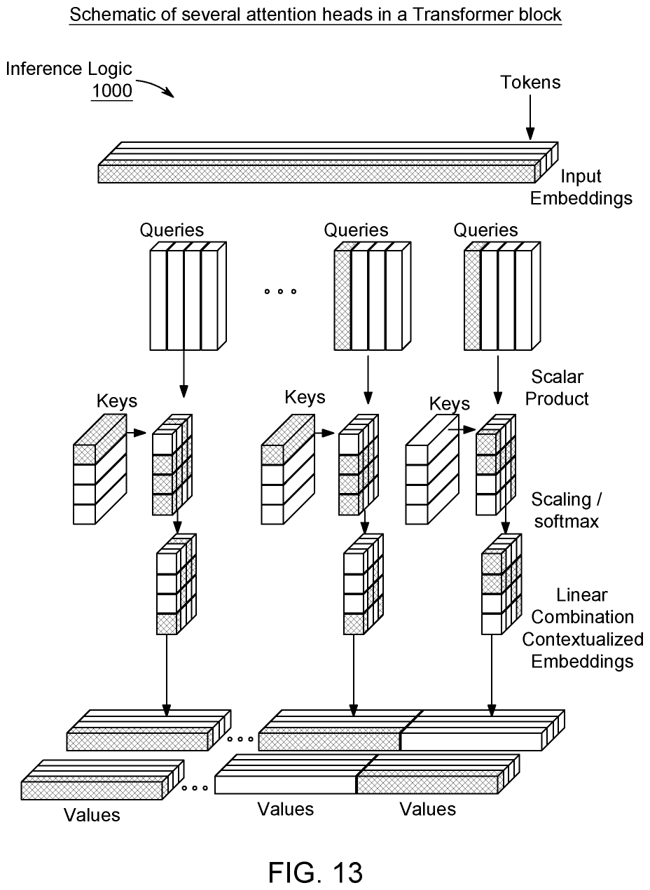

FIG. 13 depicts several attention heads in a Transformer block. We can see that the outputs of queries and keys dot products in different attention heads are visually distinguished. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and d is the hidden representation of each element (also called the hidden vector). Attention is then computed as:

$$Attention ( Q , K , V ) = SoftMax ( \frac{{QK}^{T}}{\sqrt{dk}} ) V$$

where Q, K, V are computed as:

$$X \cdot {W}_{Q} , X \cdot {W}_{K} , X \cdot {W}_{V}$$

X is the input matrix and W_{Q}, W_{K}, W_{V} are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

$$MultiHeadAttention ( Q , K , V ) = [ {head}_{1} , … , {head}_{h} ] {W}_{0}$$

$$where {head}_{i} = Attention$$

$$( {QW}_{i}^{Q} , {KW}_{i}^{K} , {VW}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

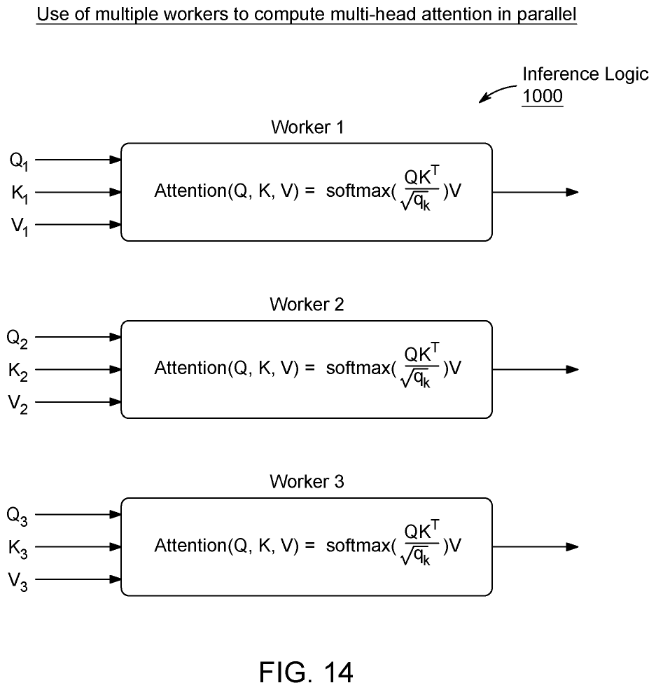

As shown in FIG. 14, one can use multiple workers to compute the multi-head attention in parallel, as the respective heads compute their outputs independently of one another. Parallel processing is one of the advantages of Transformers over RNNs

Assuming the naive matrix multiplication algorithm which has a complexity of:

$$a \cdot b \cdot c$$

For matrices of shape (a, b) and (c, d), to obtain values Q, K, V, we need to compute the operations:

$$X . {W}_{Q} , X . {W}_{K} , X . WV$$

The matrix X is of shape (n, d) where n is the number of patches and d is the hidden vector dimension. The weights W_{Q}, W_{K}, W_{V} are all of shape (d, d). Omitting the constant factor 3, the resulting complexity is:

$$n \cdot {d}^{2}$$

We can proceed to the estimation of the complexity of the attention function itself, i.e., of

$$SoftMax ( \frac{{QK}^{T}}{\sqrt{dk}} ) V .$$

The matrices Q and K are both of shape (n, d). The transposition operation does not influence the asymptotic complexity of computing the dot product of matrices of shapes (n, d). (d, n), therefore its complexity is:

$${n}^{2} . d$$

Scaling by a constant factor of \sqrt{dk}, where dk is the dimension of the keys vector, as well as applying the SoftMax function, both have the complexity of a. b for a matrix of shape (a, b), hence they do not influence the asymptotic complexity. Lastly the dot product

$$SoftMax ( \frac{{QK}^{T}}{\sqrt{dk}} ) \cdot V$$

is between matrices of shapes (n, n) and (n, d) and so its complexity is:

$${n}^{2} . d$$

The final asymptotic complexity of scaled dot-product attention is obtained by summing the complexities of computing Q, K, V, and of the following attention function:

$$n . {d}^{2} + {n}^{2} . d .$$

The asymptotic complexity of multi-head attention is the same since the original input matrix X is projected into h matrices of shapes

$$( n , \frac{d}{h} ) ,$$

where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

FIG. 15 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

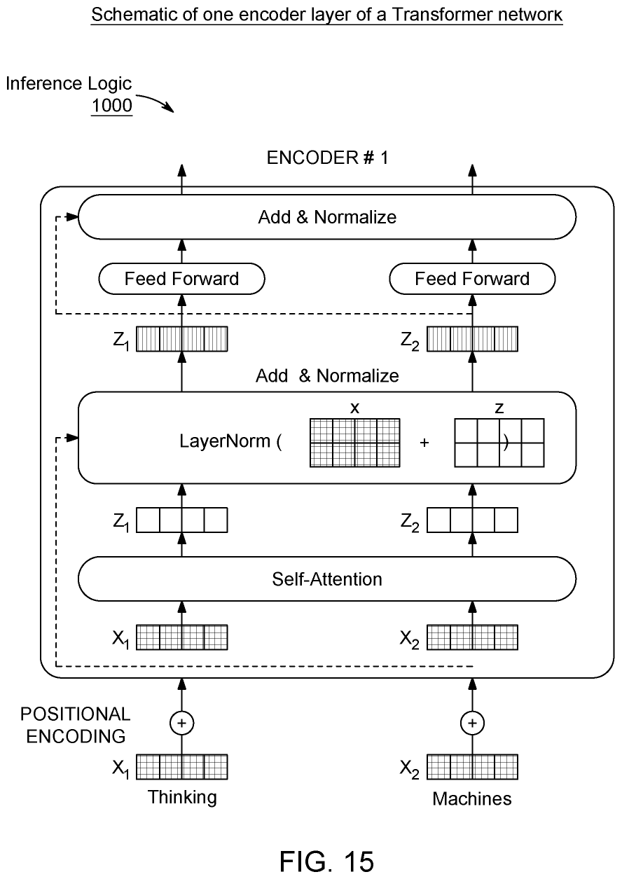

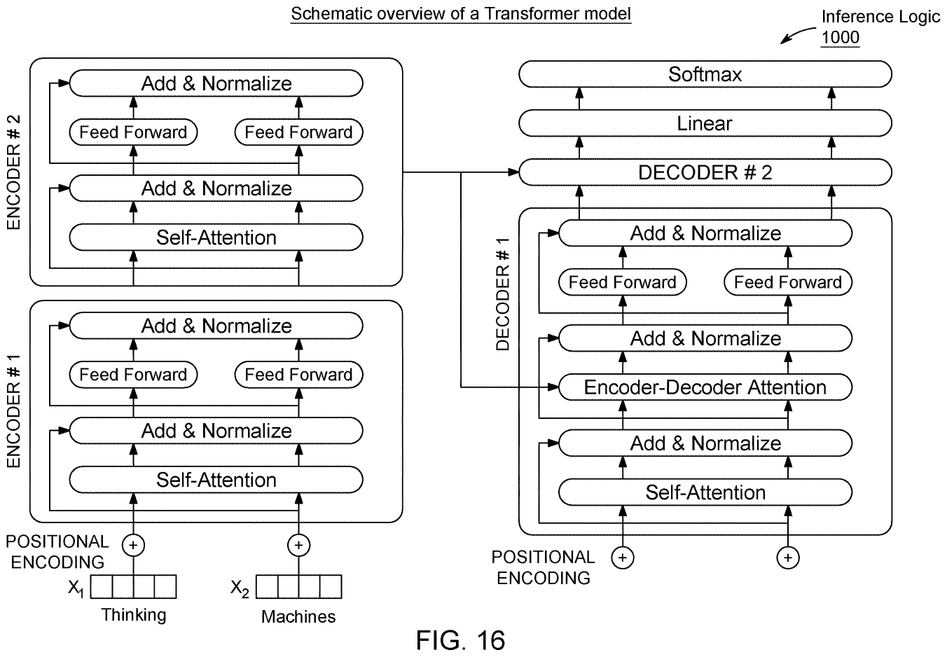

FIG. 16 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

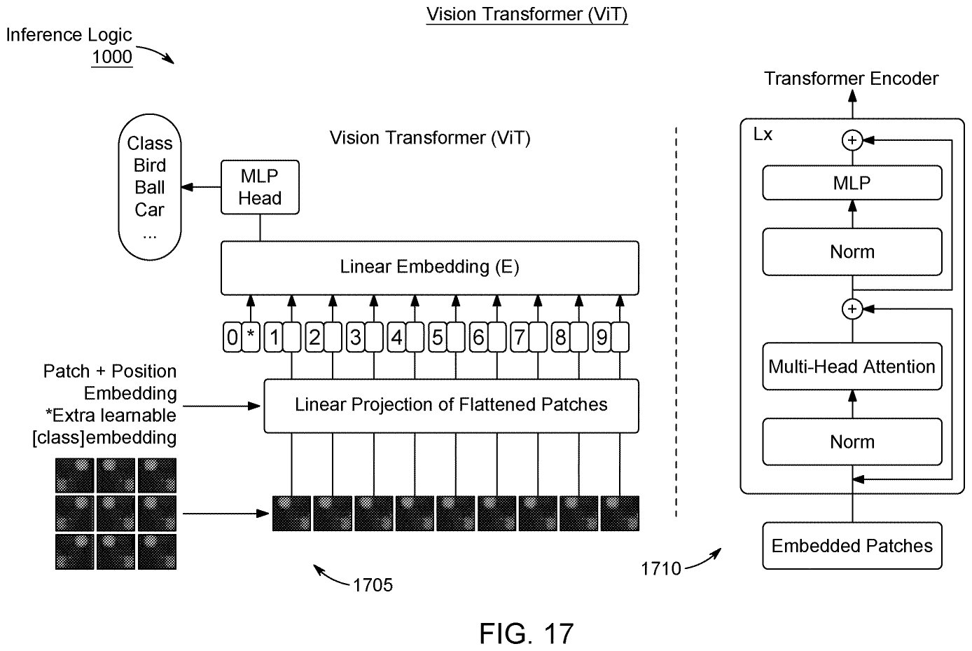

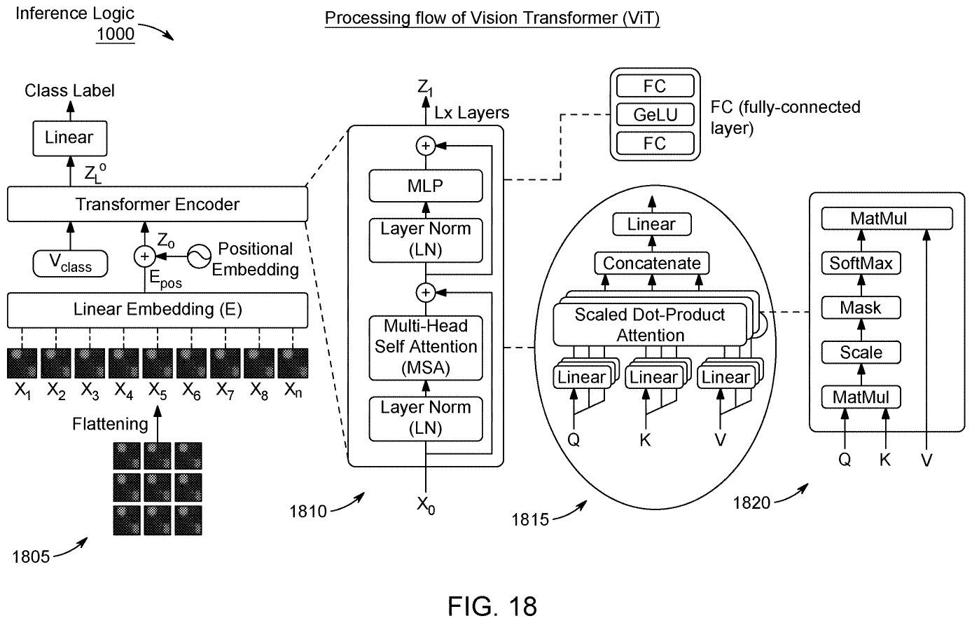

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIGS. 17 (1705 and 1710) and FIGS. 18 (1805, 1810, 1815 and 1820). Unfortunately, important positional information is lost because image sets are position-invariant. This problem is solved by adding a learned positional encoding into the image patches.

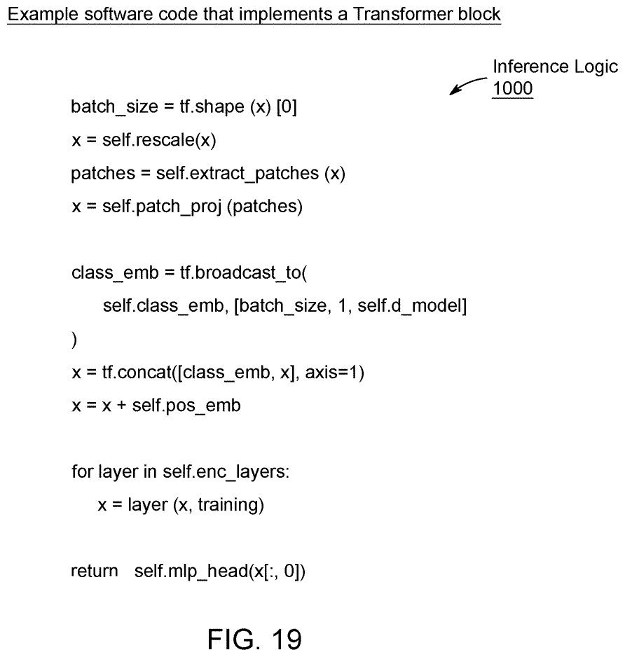

The computations of the ViT architecture can be summarized as follows. The first layer of a ViT extracts a fixed number of patches from an input image (1805 in FIG. 18). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 19.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

### CLAUSES

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses:
1. A system for neuronal classification from extracellular electrophysiological recordings, comprising:
   a data interface configured to receive a plurality of extracellular electrophysiological recordings from one or more recording devices, each recording representing extracellular neuronal activity of one or more neurons;
   one or more processors coupled to a memory storing instructions that, when executed by the one or more processors, cause the one or more processors to:
      extract, from at least one electrophysiological recording, a waveform feature representing a shape of an extracellular action potential for each of the one or more neurons, and an interspike-interval feature representing a temporal distribution of intervals between successive action potentials for each of the one or more neurons;
      process the waveform feature and the interspike-interval feature through at least one conditional variational autoencoder to generate a latent representation for each neuron, wherein the at least one conditional variational autoencoder is conditioned on at least one recording-source parameter associated with the electrophysiological recording;
      harmonize the latent representation across latent representations generated from electrophysiological recordings obtained using different experimental setups by applying a batch-effect correction in a latent space of the at least one conditional variational autoencoder; and
      classify each neuron into a neuronal category based on the harmonized latent representation using a K-nearest-neighbors classifier that determines the neuronal category based on proximity to labeled reference representations in the harmonized latent representation; and
   an output interface configured to output the neuronal category for each classified neuron.
2. The system according to clause 1, wherein the waveform feature comprises a mean extracellular waveform computed by averaging spike-triggered voltage traces across a plurality of detected spikes for each neuron, and the interspike-interval feature comprises a histogram of intervals between consecutive spikes binned at a predetermined temporal resolution.
3. The system according to clause 2, wherein the mean extracellular waveform spans a temporal window of approximately 2.5 milliseconds sampled at approximately 20 kHz, and the histogram of intervals uses bins of approximately 1 millisecond spanning a total duration of approximately 100 milliseconds.
4. The system according to clause 1, wherein the at least one conditional variational autoencoder comprises a first conditional variational autoencoder module dedicated to processing the waveform feature and a second conditional variational autoencoder module dedicated to processing the interspike-interval feature, the first and second conditional variational autoencoder modules trained in parallel, and further comprising a mixture module configured to combine latent embeddings output by the first and second conditional variational autoencoder modules into a joint latent representation.
5. The system according to clause 4, wherein the mixture module combines the latent embeddings by concatenation of the latent embeddings from the first conditional variational autoencoder module and the latent embeddings from the second conditional variational autoencoder module.
6. The system according to clause 4, wherein the first conditional variational autoencoder module comprises a one-dimensional residual network encoder and a one-dimensional residual network decoder, and the second conditional variational autoencoder module comprises a one-dimensional residual network encoder and a one-dimensional residual network decoder.
7. The system according to clause 1, wherein the at least one recording-source parameter comprises at least one of: a recording technology type identifying a type of recording device used to capture the electrophysiological recording, a brain region identifier identifying an anatomical region from which the recording was obtained, or an organoid line identifier identifying a cell line from which an organoid was derived.
8. The system according to clause 7, wherein the recording technology type identifies at least one of: a high-density microelectrode array, a Neuropixels probe, a juxtacellular electrode, or a silicon probe.
9. The system according to clause 1, wherein the one or more processors are further configured to pretrain the at least one conditional variational autoencoder using self-supervised learning on a plurality of unlabeled electrophysiological datasets with neuronal category labels masked to zero, while conditioning on the at least one recording-source parameter, and subsequently fine-tune the at least one conditional variational autoencoder using supervised learning on a labeled target electrophysiological dataset.
10. The system according to clause 9, wherein the pretraining employs a leave-one-dataset-out strategy in which the labeled target electrophysiological dataset is excluded from the plurality of unlabeled electrophysiological datasets during the pretraining.
11. The system according to clause 9, wherein the fine-tuning employs balanced mini-batch sampling in which each mini-batch of training data contains an approximately equal proportion of each neuronal category label.
12. The system according to clause 9, wherein the fine-tuning uses a learning rate that is a predetermined fraction of a learning rate used during the pretraining.
13. The system according to clause 1, wherein the at least one conditional variational autoencoder is trained using a loss function comprising a reconstruction loss term and a Kullback-Leibler divergence term, the Kullback-Leibler divergence term weighted by a hyperparameter β that controls a trade-off between reconstruction fidelity and latent space regularity.
14. The system according to clause 13, wherein the at least one conditional variational autoencoder uses a Gaussian encoder, and the Kullback-Leibler divergence term has an analytical form computed from a predicted mean and a predicted standard deviation for each dimension of the latent space.
15. The system according to clause 1, wherein the neuronal category comprises a neuronal subtype classification identifying a neuron as belonging to at least one of: an excitatory neuron class, a parvalbumin-positive interneuron class, a somatostatin-positive interneuron class, or a vasoactive-intestinal-peptide-positive interneuron class.
16. The system according to clause 1, wherein the neuronal category comprises an anatomical region classification mapping each neuron to a brain region based on electrophysiological characteristics encoded in the harmonized latent representation.
17. The system according to clause 1, wherein the K-nearest-neighbors classifier generates a confidence score for each classification, the confidence score derived as a proportion of neighboring representations in the harmonized latent representation that share the assigned neuronal category.
18. The system according to clause 1, wherein the K-nearest-neighbors classifier uses Euclidean distance to identify nearest neighbors in the harmonized latent representation.
19. The system according to clause 1, wherein the one or more processors are further configured to apply dimensionality reduction to the latent representation prior to classification by the K-nearest-neighbors classifier.
20. A system for technology-invariant neuronal classification across heterogeneous electrophysiological recording platforms, comprising:
   a data interface configured to receive extracellular electrophysiological recordings from a plurality of recording platforms, each recording platform employing a different recording technology;
   one or more processors coupled to a memory storing instructions that, when executed by the one or more processors, cause the one or more processors to:
      extract, for each neuron represented in the recordings, a waveform feature and an interspike-interval feature from the extracellular electrophysiological recordings;
      process the waveform feature through a first conditional variational autoencoder module comprising a first encoder and a first decoder, and process the interspike-interval feature through a second conditional variational autoencoder module comprising a second encoder and a second decoder, each of the first and second conditional variational autoencoder modules conditioned on a recording technology parameter identifying the recording technology of the respective recording platform; combine latent embeddings from the first conditional variational autoencoder module and the second conditional variational autoencoder module through a mixture module to produce a joint latent representation for each neuron;
      pretrain the first and second conditional variational autoencoder modules using self-supervised learning across a plurality of electrophysiological datasets with neuronal category labels masked, and subsequently fine-tune the first and second conditional variational autoencoder modules using supervised learning on a target dataset with neuronal category labels; and
      classify each neuron into a neuronal category using a K-nearest-neighbors classifier operating on the joint latent representation; and
   an output interface configured to output the neuronal category.
21. The system according to clause 20, wherein the first encoder and the first decoder each comprise a one-dimensional residual network, and the second encoder and the second decoder each comprise a one-dimensional residual network.
22. The system according to clause 20, wherein the pretraining excludes the target dataset from the plurality of electrophysiological datasets in a leave-one-dataset-out configuration.
23. The system according to clause 20, wherein the plurality of recording platforms comprises at least two of: a high-density microelectrode array platform, a Neuropixels probe platform, a juxtacellular recording platform, or a silicon probe platform.
24. The system according to clause 20, wherein the K-nearest-neighbors classifier is selected based on a determination that distance-based classification in the joint latent representation yields higher classification accuracy than parametric classification by a multilayer perceptron for the electrophysiological recordings.
25. A system for assessing electrophysiological reproducibility across engineered neuronal systems, comprising:
   a data interface configured to receive extracellular electrophysiological recordings from a plurality of organoids derived from a plurality of independent pluripotent stem cell lines, the recordings captured using a high-density microelectrode array;
   one or more processors coupled to a memory storing instructions that, when executed by the one or more processors, cause the one or more processors to:
      extract, for each neuron in each organoid, a waveform feature and an interspike-interval feature;
      process the waveform feature and the interspike-interval feature through respective conditional variational autoencoder modules, each conditioned on an organoid line identifier identifying the pluripotent stem cell line from which the respective organoid was derived, to generate latent embeddings for each neuron;
      combine the latent embeddings into a joint latent representation using a mixture module;
      apply unsupervised clustering to the joint latent representation to identify a plurality of electrophysiological clusters; and
      evaluate cross-line reproducibility by determining whether each of the plurality of electrophysiological clusters exhibits balanced representation across the plurality of independent pluripotent stem cell lines; and
   an output interface configured to output a reproducibility assessment indicating a degree of cross-line cluster balance.
26. The system according to clause 25, wherein the one or more processors are further configured to quantify cross-modality independence between waveform-based clusters and interspike-interval-based clusters by computing at least one of an Adjusted Rand Index or an Adjusted Mutual Information between cluster assignments derived from each modality.
27. The system according to clause 25, wherein the unsupervised clustering comprises K-means clustering with a number of clusters determined by at least one of silhouette analysis or an elbow method.
28. A computer-implemented method for neuronal classification from extracellular electrophysiological recordings, the method comprising:
   receiving, by one or more processors, a plurality of extracellular electrophysiological recordings captured by one or more recording devices, each recording representing extracellular neuronal activity;
   extracting, by the one or more processors, from at least one electrophysiological recording, a waveform feature representing a shape of an extracellular action potential for each neuron represented in the recording, and an interspike-interval feature representing a temporal distribution of intervals between successive action potentials for each neuron;
   generating, by the one or more processors, a latent representation for each neuron by processing the waveform feature and the interspike-interval feature through at least one conditional variational autoencoder conditioned on at least one recording-source parameter associated with the electrophysiological recording;
   harmonizing, by the one or more processors, the latent representations across recordings obtained from different experimental setups by applying a batch-effect correction in a latent space of the at least one conditional variational autoencoder to produce harmonized latent representations;
   classifying, by the one or more processors, each neuron into a neuronal category by applying a K-nearest-neighbors classifier to the harmonized latent representations; and
   outputting the neuronal category for each classified neuron.
29. The method according to clause 28, wherein extracting the waveform feature comprises computing a mean extracellular waveform by averaging spike-triggered voltage traces across a plurality of detected spikes for each neuron, and extracting the interspike-interval feature comprises computing a histogram of intervals between consecutive spikes binned at a predetermined temporal resolution.
30. The method according to clause 29, wherein the mean extracellular waveform is computed using up to a predetermined maximum number of raw spikes per neuron, and the mean extracellular waveform is centered at a peak amplitude of the extracellular action potential.
31. The method according to clause 28, wherein generating the latent representation comprises: processing the waveform feature through a first conditional variational autoencoder module to produce a first latent embedding; processing the interspike-interval feature through a second conditional variational autoencoder module to produce a second latent embedding; and combining the first latent embedding and the second latent embedding through a mixture module to produce a joint latent representation.
32. The method according to clause 31, wherein each of the first and second conditional variational autoencoder modules comprises a one-dimensional residual network encoder and a one-dimensional residual network decoder.
33. The method according to clause 28, further comprising, prior to classifying: pretraining the at least one conditional variational autoencoder on a plurality of electrophysiological datasets using self-supervised learning with neuronal category labels masked to zero while incorporating the at least one recording-source parameter as a conditioning variable; and fine-tuning the at least one conditional variational autoencoder on a labeled target dataset using supervised learning.
34. The method according to clause 33, wherein the pretraining excludes the labeled target dataset from the plurality of electrophysiological datasets in a leave-one-dataset-out configuration.
35. The method according to clause 33, wherein the fine-tuning employs an inductive evaluation split in which a labeled target dataset is partitioned at a level of experimental subjects, and neurons from training subjects and neurons from testing subjects are derived from entirely different experimental subjects.
36. The method according to clause 28, wherein the at least one recording-source parameter comprises a recording technology type, and wherein the harmonizing produces latent representations that are invariant to the recording technology type while preserving discriminative power for distinguishing neuronal categories.
37. The method according to clause 28, wherein classifying each neuron comprises classifying into at least one of: a neuronal subtype classification identifying the neuron as excitatory or inhibitory, or an anatomical region classification mapping the neuron to a brain region.
38. The method according to clause 28, wherein the K-nearest-neighbors classifier uses Euclidean distance to identify nearest neighbors and generates a confidence score for each classification based on a proportion of nearest neighbors sharing the assigned neuronal category.
39. The method according to clause 28, wherein the interspike-interval feature carries greater discriminative power for anatomical region classification than the waveform feature, and the waveform feature carries greater discriminative power for neuronal subtype classification than the interspike-interval feature.
40. A computer-implemented method for training a neuronal classification model from heterogeneous electrophysiological data, the method comprising:
   receiving a plurality of electrophysiological datasets, each dataset comprising extracellular neuronal recordings obtained using a respective recording technology, at least a subset of the datasets including neuronal category labels;
   for each dataset, extracting a waveform feature and an interspike-interval feature for each neuron represented in the dataset;
   pretraining a pair of conditional variational autoencoders in a self-supervised manner by:
      processing the waveform features through a first conditional variational autoencoder and the interspike-interval features through a second conditional variational autoencoder, each conditioned on a recording technology identifier associated with the respective dataset,
      masking neuronal category labels during the pretraining, and
      excluding a target dataset from the pretraining according to a leave-one-dataset-out protocol;
   fine-tuning the pair of conditional variational autoencoders on the target dataset using supervised learning with the neuronal category labels to produce a fine-tuned model; and
   deploying the fine-tuned model to classify neurons in previously unseen electrophysiological recordings by applying a K-nearest-neighbors classifier to latent representations generated by the fine-tuned model.
41. The method according to clause 40, wherein the fine-tuning uses a learning rate that is a predetermined fraction of a learning rate used during the pretraining.
42. The method according to clause 40, wherein the fine-tuning employs balanced mini-batch sampling in which each mini-batch contains an approximately equal proportion of each neuronal category label.
43. The method according to clause 40, wherein the plurality of electrophysiological datasets comprises recordings from at least two of: in vivo animal recordings, in vitro brain slice recordings, or in vitro organoid recordings.
44. The method according to clause 40, wherein the K-nearest-neighbors classifier is fitted to training embeddings generated by the fine-tuned model and evaluated against test embeddings using stratified cross-validation.
45. A non-transitory computer-readable storage medium storing instructions that, when executed by one or more processors, cause the one or more processors to perform operations comprising:
   receiving extracellular electrophysiological recordings from one or more recording devices, each recording representing extracellular neuronal activity of one or more neurons;
   extracting, for each neuron represented in the recordings, a waveform feature representing an extracellular action potential shape and an interspike-interval feature representing a temporal distribution of intervals between successive action potentials;
   generating a latent representation for each neuron by processing the waveform feature and the interspike-interval feature through at least one conditional variational autoencoder conditioned on at least one recording-source parameter;
   harmonizing the latent representations across recordings obtained from different experimental setups by applying a batch-effect correction in a latent space of the at least one conditional variational autoencoder;
   classifying each neuron into a neuronal category using a K-nearest-neighbors classifier operating on the harmonized latent representations; and
   outputting the neuronal category for each classified neuron.
46. The non-transitory computer-readable storage medium according to clause 45, wherein the at least one conditional variational autoencoder comprises a first module for processing the waveform feature and a second module for processing the interspike-interval feature, each module comprising a one-dimensional residual network encoder and a one-dimensional residual network decoder, and a mixture module for combining latent embeddings from the first and second modules into a joint latent representation.
47. The non-transitory computer-readable storage medium according to clause 45, wherein the
operations further comprise pretraining the at least one conditional variational autoencoder using
self-supervised learning across a plurality of electrophysiological datasets with neuronal category
labels masked, and fine-tuning the at least one conditional variational autoencoder using
supervised learning on a target dataset.
48. The non-transitory computer-readable storage medium according to clause 45, wherein the at
least one recording-source parameter comprises at least one of: a recording technology type, a
brain region identifier, or an organoid line identifier.
49. A brain-computer interface system comprising:
   a neural recording device configured to capture extracellular electrophysiological recordings from a subject;
   one or more processors coupled to a memory storing instructions that, when executed by the one or more processors, cause the one or more processors to:
      extract a waveform feature and an interspike-interval feature from the recordings for each detected neuron;
      generate a latent representation for each neuron by processing the waveform feature and the interspike-interval feature through at least one conditional variational autoencoder conditioned on a recording device parameter identifying the neural recording device; and
      classify each neuron into an anatomical region category using a K-nearest-neighbors classifier on the latent representation to determine a recording location estimate for the neural recording device; and
   an output interface configured to output the recording location estimate to guide positioning of the neural recording device.
50. The brain-computer interface system according to clause 49, wherein the recording location estimate identifies a target brain region and the output interface provides an indication of whether the neural recording device is positioned within the target brain region.
51. The brain-computer interface system according to clause 49, wherein the at least one conditional variational autoencoder has been pretrained across a plurality of electrophysiological datasets from a plurality of brain regions using self-supervised learning with neuronal category labels masked, and fine-tuned using supervised learning with anatomical region labels.
52. A computer-implemented method for quality assessment of engineered neuronal systems, the method comprising:
   receiving extracellular electrophysiological recordings from a plurality of organoids derived from at least two independent cell lines, the recordings captured using a high-density microelectrode array;
   extracting, for each neuron in each organoid, a waveform feature and an interspike-interval feature;
   generating latent representations by processing the waveform feature and the interspike-interval feature through at least one conditional variational autoencoder conditioned on a cell line identifier;
   clustering the latent representations to identify a plurality of electrophysiological clusters;
   evaluating cross-line reproducibility by determining a balance of representation of each cell line within each cluster; and
   outputting a reproducibility assessment based on the cross-line cluster balance.
53. The method according to clause 52, further comprising computing a cross-modality independence metric between waveform-based cluster assignments and interspike-interval-based cluster assignments to determine a degree of complementarity between the two modalities for the engineered neuronal systems.
54. The method according to clause 52, wherein the clustering comprises waveform-based clustering and interspike-interval-based clustering performed independently, and the cross-line reproducibility is evaluated separately for waveform-based clusters and interspike-interval-based clusters.
55. The method according to clause 52, wherein the at least two independent cell lines comprise at least two independent pluripotent stem cell lines, and the organoids comprise cortical organoids.

1. A system for classifying neurons from extracellular electrophysiological recordings, the system comprising:
a data interface configured to receive a plurality of extracellular electrophysiological recordings captured by at least one recording device, each recording representing extracellular neuronal activity of a plurality of neurons; and
one or more processors coupled to a memory storing instructions that, when executed by the one or more processors, cause the one or more processors to:
extract, from at least one electrophysiological recording, for each of a plurality of neurons, (i) a waveform feature representing a shape of an extracellular action potential of the neuron, and (ii) an interspike-interval feature representing a temporal distribution of intervals between successive action potentials of each of the plurality of neurons;
generate, using one or more conditional variational autoencoders conditioned on an recording source descriptor associated with the at least one recording device, (i) a waveform latent code determined from a waveform feature vector and (ii) a timing latent code determined from a spike-timing distribution feature vector;
fuse the waveform latent code and the timing latent code to produce a multimodal latent embedding for a neuron unit; and
perform one or more analysis operations on a multimodal latent representations to generate an analysis result characterizing the plurality of neurons.

2. The system of claim 1, wherein extracting the waveform feature comprises computing a mean extracellular waveform by averaging spike-triggered voltage traces across a plurality of detected spikes for each neuron, and wherein extracting the interspike-interval feature comprises computing a histogram of intervals between consecutive spikes binned at a predetermined temporal resolution.

3. The system of claim 1, wherein the conditional variational autoencoder comprises:
a first conditional variational autoencoder module configured to process the waveform feature, a second conditional variational autoencoder module configured to process the interspike-interval feature, and a third conditional variational autoencoder module configured to process an autocorrelogram feature representing a temporal autocorrelation function computed from the action potential spike train of the neuron, and wherein the first conditional variational autoencoder module and the second conditional variational autoencoder module being trained in parallel, and further comprising a mixture module configured to combine a first latent embedding output by the first conditional variational autoencoder module and a second latent embedding output by the second conditional variational autoencoder module into a joint latent representation, and wherein the mixture module is further configured to combine a third latent embedding output by the third conditional variational autoencoder module with the first latent embedding and the second latent embedding into the joint latent representation.

4. The system of claim 3, wherein each of the first conditional variational autoencoder module and the second conditional variational autoencoder module comprises a one-dimensional residual network encoder and a one-dimensional residual network decoder.

5. The system of claim 1, further comprises at least one recording-source parameter comprising at least one of: a recording technology type identifying a type of recording device used to capture the electrophysiological recording, a brain region identifier identifying an anatomical region from which the recording was obtained, or an organoid line identifier identifying a pluripotent stem cell line from which an organoid source of the recording was derived.

6. The system of claim 1, wherein the one or more processors are further configured to: pretrain the conditional variational autoencoder using self-supervised learning on a plurality of electrophysiological datasets with neuronal category labels masked while conditioning on the at least one recording-source parameter; and subsequently fine-tune the conditional variational autoencoder using supervised learning on a labeled target dataset with neuronal category labels.

7. The system of claim 6, wherein the pretraining employs a leave-one-dataset-out strategy in which the labeled target dataset is excluded from the plurality of electrophysiological datasets used during the pretraining.

8. The system of claim 1, wherein the waveform feature comprises a normalized mean extracellular waveform computed by averaging spike-triggered voltage traces across a plurality of detected action potentials of the neuron, and an interspike-interval signal feature comprises an interspike-interval histogram computed from intervals between consecutive detected action potentials of the neuron.

9. The system of claim 8, wherein the normalized mean extracellular waveform comprises a one-dimensional vector of data points sampled within a time window of approximately 2.5 milliseconds at a sampling rate of at least 20 kilohertz, and the interspike-interval histogram comprises one-dimensional bins at a temporal resolution of approximately 1 millisecond spanning approximately 100 milliseconds.

10. The system of claim 1, wherein each of the one or more conditional variational autoencoders is trained using a loss function comprising a reconstruction loss term and a Kullback-Leibler divergence term weighted by a hyperparameter β, the reconstruction loss term measuring fidelity of a decoder reconstruction of respective one-dimensional vector, and the Kullback-Leibler divergence term regularizing the respective latent embedding toward a prior distribution.

11. The system of claim 1, wherein the one or more processors are further configured to: pretrain the one or more conditional variational autoencoders by self-supervised learning on a plurality of electrophysiological datasets with class label embeddings masked to zero while conditioning on a recording-source covariate; and subsequently fine-tune the first and second conditional variational autoencoder modules by supervised learning on a labeled target dataset with class labels provided.

12. The system of claim 11, wherein during the pretraining, the labeled target dataset is excluded from the plurality of electrophysiological datasets in a leave-one-dataset-out configuration.

13. The system of claim 11, wherein during the fine-tuning, each mini-batch of training data is sampled to contain an equal proportion of each class label, and a learning rate for the fine-tuning is a fraction of a learning rate used during the pretraining.

14. The system of claim 1, wherein the one or more analysis operation comprises:
perform batch harmonization by applying batch effect correction to the multimodal latent embedding to produce, for each neuron unit, a harmonized latent representation, with reduced variation attributable to differences in recording source;
classify each neuron unit into a neuronal category by applying a K-nearest-neighbors classifier to the harmonized latent representations, the K-nearest-neighbors classifier determining the neuronal category for each neuron based on proximity to labeled reference representations in the harmonized latent representations; and
outputting the neuronal category for each classified neuron through an output interface.

15. The system of claim 14, wherein the K-nearest-neighbors classifier uses Euclidean distance to identify nearest neighbors and generates a confidence score for each classification, the confidence score derived as a proportion of neighboring representations in the harmonized latent representations that share the neuronal category.

16. The system of claim 15, wherein the neuronal category comprises at least one of: a neuronal subtype classification identifying each neuron as belonging to a genetically defined cell type, or an anatomical region classification mapping each neuron to a brain region based on electrophysiological characteristics encoded in the harmonized latent representations.

17. A computer-implemented method for classifying neurons from extracellular electrophysiological recordings, comprising:
(a) receiving a plurality of extracellular electrophysiological recordings captured by at least one recording device, each recording representing extracellular neuronal activity of a plurality of neurons; (b) extracting, from at least one of the extracellular electrophysiological recordings, for each of a plurality of neurons, (i) a waveform feature representing a shape of an extracellular action potential of the neuron, and (ii) an interspike-interval feature representing a temporal distribution of intervals between successive action potentials of the neuron; (c) generating, using one or more conditional variational autoencoders conditioned on a recording source descriptor associated with the at least one recording device, (i) a waveform latent code determined from the waveform feature and (ii) a timing latent code determined from the interspike-interval feature; (d) fusing the waveform latent code and the timing latent code to produce a multimodal latent embedding for each neuron; and (e) performing one or more analysis operations on the multimodal latent embeddings to generate an analysis result characterizing the plurality of neurons.

18. The method of claim 17, wherein extracting the waveform feature comprises computing a mean extracellular waveform by averaging spike-triggered voltage traces across a plurality of detected spikes for each neuron, and wherein extracting the interspike-interval feature comprises computing a histogram of intervals between consecutive spikes binned at a predetermined temporal resolution.

19. The method of claim 17, wherein generating comprises:
(a) processing the waveform feature using a first conditional variational autoencoder module to produce a first latent embedding;
(b) processing the interspike-interval feature using a second conditional variational autoencoder module to produce a second latent embedding, the first and second conditional variational autoencoder modules being trained in parallel; and
(c) combining the first latent embedding and the second latent embedding using a mixture module to form a joint latent representation from which the waveform latent code and the timing latent code are obtained.

20. The method of claim 17, wherein the one or more analysis operations comprise:
(a) performing batch harmonization by applying batch-effect correction to the multimodal latent embedding to produce, for each neuron, a harmonized latent representation having reduced variation attributable to differences in recording source;
(b) classifying each neuron into a neuronal category by applying a k-nearest-neighbors classifier to the harmonized latent representations based on proximity to labeled reference representations in the harmonized latent representations; and
(c) outputting the neuronal category for each classified neuron.
